(19) United States
(12) Patent Application Publication
(10) Pub. No.: US 2020/0275099 A1
(43) Pub. Date: Aug. 27, 2020

(54) IMAGE ENCODING METHOD AND DEVICE, AND IMAGE DECODING METHOD AND DEVICE

(71) Applicant: SAMSUNG ELECTRONICS CO., LTD., Suwon-si (KR)

(72) Inventors: Min-soo PARK, Seoul (KR); Min-woo PARK, Yongin-si (KR)

(73) Assignee: SAMSUNG ELECTRONICS CO., LTD., Suwon-si (KR)

(21) Appl. No.: 16/648,463

(22) PCT Filed: Mar. 30, 2018
(86) PCT No.: PCT/KR2018/003823

§ 371 Date: Mar. 18, 2020

Related U.S. Application Data
(60) Provisional application No. 62/560,292, filed on Sep. 19, 2017.

(51) Int. Cl. H04N 19/119; H04N 19/157; H04N 19/176

(52) U.S. Cl. CPC H04N 19/119; H04N 19/176; H04N 19/157

(57) ABSTRACT

An image decoding method includes determining allowable split shape modes from among a plurality of split shape modes, based on at least one of a size and a shape of a current block and an allowable size of a block, obtaining information about a split shape mode of the current block from a bitstream, generating a bin string for the split shape mode of the current block including at least one bin by binary arithmetic decoding the information about the split shape mode of the current block, obtaining the split shape mode of the current block by performing inverse-binarization on the bin string for the split shape mode of the current block, based on the allowable split shape modes, and determining whether the current block is to be split, based on the obtained split shape mode of the current block. The information about the split shape mode may include information about whether the block is split, a split direction of the block, and a split type of the block, and the allowable size of the block may be determined based on a minimum size and a maximum size of the block allowable for decoding.

### TECHNICAL FIELD

A method and apparatus according to an embodiment may encode or decode an image by using coding units of various shapes included in the image. A method and apparatus according to an embodiment includes an adaptive binarization method and apparatus and an adaptive inverse-binarization method and apparatus.

### BACKGROUND ART

With the development and spread of hardware capable of reproducing and storing high-resolution or high-definition image content, the need for a codec that effectively encodes or decodes high-resolution or high-definition image content is increasing. Encoded image content may be reproduced by being decoded. Recently, methods for effectively compressing such high-resolution or high-definition image content have been performed. For example, an efficient image compressing method is performed through a process of processing an image to be encoded via an arbitrary method.

To compress an image, various data units may be used, and an inclusion relationship may exist between the data units. To determine the sizes of data units that are used for image compression, data units may be split by using various methods, and optimized data units may be determined according to the characteristics of images so that encoding or decoding of the images may be performed.

### DESCRIPTION OF EMBODIMENTS

### Solution to Problem

An image decoding method according to an embodiment includes: determining allowable split shape modes from among a plurality of split shape modes based on at least one of a size and a shape of a current block and an allowable size of a block; obtaining information about a split shape mode of the current block from a bitstream; generating a bin string for the split shape mode of the current block including at least one bin by binary arithmetic decoding the information about the split shape mode of the current block; obtaining the split shape mode of the current block by performing inverse-binarization on the bin string for the split shape mode of the current block based on the allowable split shape modes; and determining whether the current block is to be split based on the obtained split shape mode of the current block,

wherein the information about the split shape mode includes information about whether the block is split, a split direction of the block, and a split type of the block, wherein the allowable size of the block is determined based on a minimum size and a maximum size of a block allowable for decoding.

The information about the split type may indicate at least one of binary splitting, tri-splitting, and quad splitting.

The obtaining of the split shape mode of the current block by performing the inverse-binarization on the bin string for the split shape mode of the current block based on the allowable split shape modes may include:

determining a bin string corresponding to the allowable split shape modes; and obtaining the split shape mode of the current block by performing inverse-binarization on the bin string for the split shape mode of the current block based on the bin string corresponding to the allowable split shape modes.

The determining of the bin string corresponding to the allowable split shape modes may include determining the bin string corresponding to the allowable split shape modes from one of tables indicating a correspondence relationship between the bin string and the allowable split shape modes.

The determining of the bin string corresponding to the allowable split shape modes may include determining the bin string corresponding to the allowable split shape modes, based on a predetermined binarization method, wherein the predetermined binarization method is a unary binarization method, wherein the bin string corresponding to the allowable split shape modes is determined according to a maximum number of the allowable split shape modes and a priority of the allowable split shape modes.

The at least one bin included in the bin string may include one of at least one bin indicating whether the block is split, at least one bin indicating the split direction of the block, and at least one bin indicating the split type of the block.

When at least one remaining second split shape mode that is different, in one of a split direction of a block and a split type of the block, from a first split shape mode from among the allowable split shape modes is not an allowable split shape mode, it may be determined that a part of at least one bin for one of the split direction of the block and the split type of the block is not included in the bin string.

The determining of the bin string corresponding to the allowable split shape modes may include determining a bin string allocated to the allowable split shape modes, based on a maximum number of the allowable split shape modes and types of the allowable split shape modes.

The image decoding method may further include, when it is determined that the current block is split, splitting the current block into a plurality of blocks, based on the information about the split direction and the split type of the block;

determining an allowable first split shape mode from among the plurality of split shape modes, based on at least one of a size and a shape of one block from among the plurality of blocks and an allowable size of the block;

obtaining information about a split shape mode of the one block from among the plurality of blocks from the bitstream;

generating a bin string for the split shape mode of the one block from among the plurality of blocks including at least one bin by binary arithmetic decoding the information about the split shape mode of the one block from among the plurality of blocks;

obtaining the split shape mode of the one block from among the plurality of blocks by performing inverse-binarization on the bin string for the one block from among the plurality of blocks, based on the allowable first split shape mode; and

determining whether the one block from among the plurality of blocks is split, based on the obtained split shape mode of the one block from among the plurality of blocks.

The determining of whether the current block is to be split, based on the obtained split shape mode of the current block may include, when it is determined that the current block is not split, based on the obtained split shape mode of the current block, performing decoding based on the current block.

An image decoding apparatus according to an embodiment includes: a binary arithmetic decoder configured to obtain information about a split shape mode of a current block from a bitstream, and generate a bin string for the split shape mode of the current block including at least one bin by binary arithmetic decoding the information about the split shape mode of the current block;

an inverse-binarizer configured to determine allowable split shape modes from among a plurality of split shape modes based on at least one of a size and a shape of the current block and an allowable size of a block, generate the bin strong for the split shape mode of the current block including at least one bin by binary arithmetic decoding the information about the split shape mode of the current block, and obtain the split shape mode of the current block by performing inverse-binarization on the bin string for the split shape mode of the current block, based on the allowable split shape modes; and

a decoder configured to determine whether the current block is to be split, based on the obtained split shape mode of the current block,

wherein the information about the split shape mode includes information about whether the block is split, a split direction of the block, and a split type of the block,

wherein the allowable size of the size is determined based on a minimum size and a maximum size of a block allowable for decoding.

An image encoding method according to an embodiment includes: determining allowable split shape modes from among a plurality of split shape modes, based on at least one of a size and a shape of a current block and an allowable size of a block;

determining the split shape mode of the current block;

generating a bin string for the split shape mode of the current block by performing binarization on the split shape mode of the current block, based on the allowable split shape modes;

generating information about the split shape mode of the current block by binary arithmetic encoding the bin string for the split shape mode of the current block; and

generating a bitstream including the information about the split shape mode of the current block,

wherein the information about the split shape mode includes information about whether the block is split, a split direction of the block, and a split type of the block,

wherein the allowable size of the block is determined based on a minimum size and a maximum size of a block allowable for encoding.

the generating of the bin string for the split shape mode of the current block by performing binarization on the split shape mode of the current block, based on the allowable split shape modes includes:

determining a bin string corresponding to the allowable split shape modes according to a predetermined binarization method; and

generating the bin string for the information about the split shape mode of the current block based on the bin string corresponding to the allowable split shape modes,

wherein the binarization method is a unary binarization method,

wherein the bin string corresponding to the allowable split shape modes is determined according to a maximum number of the allowable split shape modes and a priority of the allowable split shape modes.

At least one bin in the bin string may be one of at least one bin indicating whether the block is split, at least one bin indicating the split direction of the block, and at least one bin indicating the split type of the block.

A computer-readable recording medium according to an embodiment of the present disclosure has embodied thereon a program for performing the image decoding method.

### BRIEF DESCRIPTION OF DRAWINGS

FIG. 1A is a block diagram of an image decoding apparatus according to various embodiments.

FIG. 1B is a flowchart of an image decoding method according to various embodiments.

FIG. 1C is a block diagram of an image decoder according to various embodiments.

FIG. 2A is a block diagram of an image encoding apparatus according to various embodiments.

FIG. 2B is a flowchart of an image encoding method according to various embodiments.

FIG. 2C is a block diagram of an image encoder according to various embodiments.

FIG. 3 illustrates a process, performed by the image decoding apparatus, of determining at least one coding unit by splitting a current coding unit, according to an embodiment.

FIG. 4 illustrates a process, performed by the image decoding apparatus, of determining at least one coding unit by splitting a non-square coding unit, according to an embodiment.

FIG. 5 illustrates a process, performed by the image decoding apparatus, of splitting a coding unit based on at least one of block shape information and information about a split shape mode, according to an embodiment.

FIG. 6 illustrates a method, performed by the image decoding apparatus, of determining a predetermined coding unit from among an odd number of coding units, according to an embodiment.

FIG. 7 illustrates an order of processing a plurality of coding units when the image decoding apparatus determines the plurality of coding units by splitting a current coding unit, according to an embodiment.

FIG. 8 illustrates a process, performed by the image decoding apparatus, of determining that a current coding unit is to be split into an odd number of coding units, when the coding units are not processable in a predetermined order, according to an embodiment.

FIG. 9 illustrates a process, performed by the image decoding apparatus, of determining at least one coding unit by splitting a first coding unit, according to an embodiment.

FIG. 10 illustrates that a shape into which a second coding unit is splittable by the image decoding apparatus is restricted when the second coding unit having a non-square shape, which is determined by splitting a first coding unit, satisfies a predetermined condition, according to an embodiment.

FIG. 11 illustrates a process, performed by the image decoding apparatus, of splitting a square coding unit when information about a split shape mode indicates that the square coding unit is not to be split into four square coding units, according to an embodiment.

FIG. 12 illustrates that a processing order between a plurality of coding units may be changed depending on a process of splitting a coding unit, according to an embodiment.

FIG. 13 illustrates a process of determining a depth of a coding unit as a shape and a size of the coding unit change, when the coding unit is recursively split such that a plurality of coding units are determined, according to an embodiment.

FIG. 14 illustrates depths that are determinable based on shapes and sizes of coding units, and part indexes (PIDs) that are for distinguishing the coding units, according to an embodiment.

FIG. 15 illustrates that a plurality of coding units are determined based on a plurality of predetermined data units included in a picture, according to an embodiment.

FIG. 16 illustrates a processing block serving as a unit for determining a determination order of reference coding units included in a picture, according to an embodiment.

FIG. 17 is a diagram for describing block shape information according to an embodiment.

FIG. 18 is a diagram for describing block shape information according to an embodiment.

FIG. 19 is a diagram for describing a method of determining a splitting rule, according to an embodiment of the present disclosure.

FIG. 20 is a diagram for describing a method of determining a splitting rule, according to an embodiment of the present disclosure.

FIG. 21 is a table for describing a method of transmitting/receiving information about a split shape mode of a coding unit, according to an embodiment of the present disclosure.

FIGS. 22A and 22B are diagrams for describing a process, performed by the image decoding apparatus 100, of determining a split shape mode index of a current coding unit based on a table, according to various embodiments.

FIG. 23 is a diagram for describing a process, performed by the image decoding apparatus 100, of determining a split shape mode index of a current coding unit based on a table, according to an embodiment.

FIG. 24A is a diagram illustrating a pseudocode for performing a binarization method according to an allowable split shape mode, according to an embodiment.

FIG. 24B is a diagram illustrating a pseudocode for performing an inverse-binarization method according to an allowable split shape mode, according to an embodiment.

FIG. 24C is a diagram illustrating a pseudocode for performing an inverse-binarization method according to an allowable split shape mode, according to another embodiment.

FIG. 25 is a diagram for describing a method of indicating splitting of a current coding unit.

### MODE OF DISCLOSURE

Advantages and features of disclosed embodiments and a method of achieving the advantages and features will be apparent by referring to embodiments described below in connection with the accompanying drawings. However, the present disclosure is not restricted by these embodiments but can be implemented in many different forms, and the present embodiments are provided to complete the present disclosure and to allow one of ordinary skill in the art to understand the scope of the disclosure.

Terms used in this specification will be briefly described, and the disclosed embodiments will be described in detail.

Although general terms being widely used in the present specification were selected as terminology used in the disclosure while considering the functions of the disclosure, they may vary according to intentions of one of ordinary skill in the art, judicial precedents, the advent of new technologies, and the like. Terms arbitrarily selected by the applicant of the disclosure may also be used in a specific case. In this case, their meanings will be described in detail in the detailed description of the disclosure. Hence, the terms must be defined based on the meanings of the terms and the contents of the entire specification, not by simply stating the terms themselves.

It is to be understood that the singular forms “a,” “an,” and “the” include plural referents unless the context clearly dictates otherwise.

It will be understood that when a certain part “includes” a certain component, the part does not exclude another component but can further include another component, unless the context clearly dictates otherwise.

As used herein, the terms “portion” or “unit” refers to a software or hardware component that performs predetermined functions. However, the term “portion” or “unit” is not limited to software or hardware. The “portion” or “unit” may be configured in an addressable storage medium, or may be configured to run on at least one processor. Therefore, as an example, the “portion” or “unit” includes: components such as software components, object-oriented software components, class components, and task components; processors, functions, attributes, procedures, sub-routines, segments of program codes, drivers, firmware, microcodes, circuits, data, databases, data structures, tables, arrays, and variables. Functions provided in the components and “portions” or “units” may be combined into a smaller number of components and “portions” and “units”, or sub-divided into additional components and “portions” or “units”.

In an embodiment of the present disclosure, the “portion” or “unit” may be implemented as a processor and a memory. The term “processor” should be interpreted in a broad sense to include a general-purpose processor, a central processing unit (CPU), a microprocessor, a digital signal processor (DSP), a controller, a microcontroller, a state machine, etc. In some embodiments, the “processor” may indicate an application-specific integrated circuit (ASIC), a programmable logic device (PLD), a field programmable gate array (FPGA), etc. The term “processor” may indicate a combination of processing devices, such as, for example, a combination of a DSP and a microprocessor, a combination of a plurality of microprocessors, a combination of one or more microprocessors coupled to a DSP core, or a combination of arbitrary other similar components.

The term “memory” should be interpreted in a broad sense to include an arbitrary electronic component capable of storing electronic information. The term “memory” may indicate various types of processor-readable media, such as random-access memory (RAM), read-only memory (ROM), non-volatile RAM (NVRAM), programmable ROM (PROM), erasable programmable ROM (EPROM), electrically erasable PROM (EEPROM), flash memory, a magnetic or optical data storage device, registers, etc. When a processor can read information from a memory and/or write information in the memory, the memory can be considered to electronically communicate with the processor. A memory integrated into a processor electronically communicates with the processor.

Hereinafter, an “image” may represent a static image such as a still image of video, or a moving image, that is, a dynamic image such as video itself.

Hereinafter, a “sample”, which is data assigned to a sampling location of an image, means data that is to be processed. For example, pixel values in an image of a spatial region and transform coefficients on a transform region may be samples. A unit including at least one of such samples may be defined as a block.

Hereinafter, embodiments will be described in detail with reference to the accompanying drawings so that the present disclosure may be readily implemented by one of ordinary skill in the technical field to which the present disclosure pertains. Also, in the drawings, parts irrelevant to the description will be omitted for the simplicity of explanation.

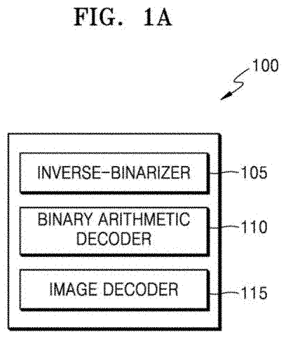

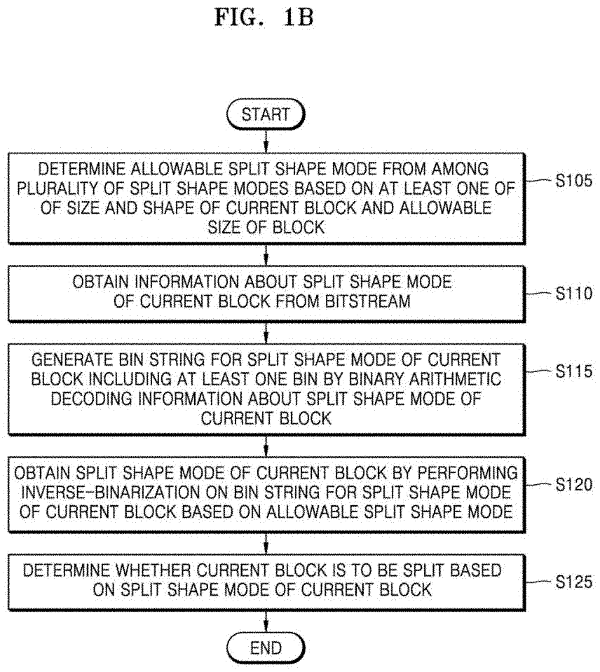

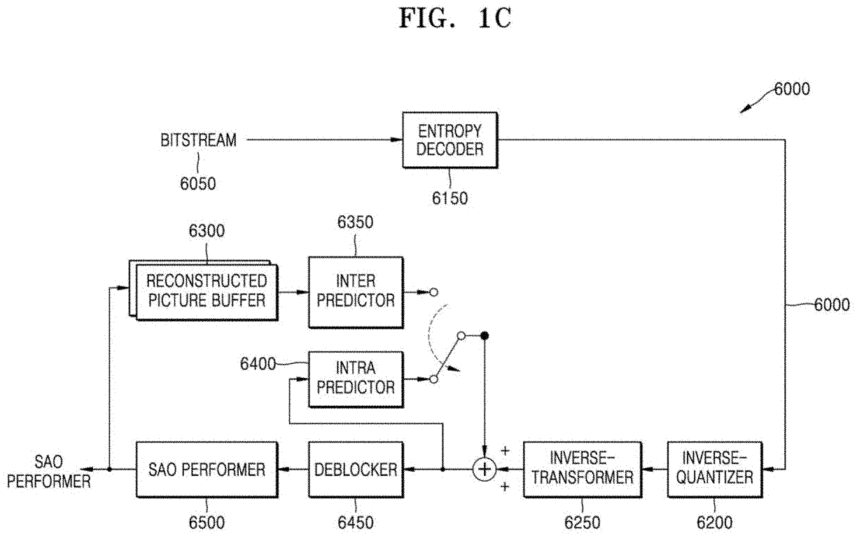

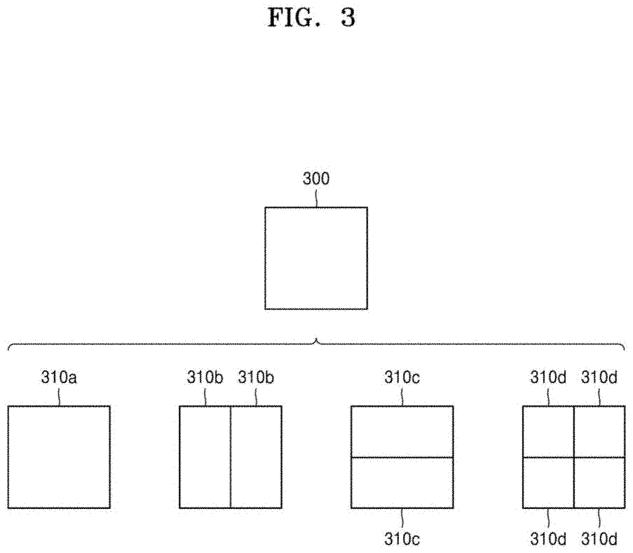

An image encoding apparatus and an image decoding apparatus, and an image encoding method and an image decoding method acceding to an embodiment will be described in detail with reference to FIGS. 1A through 25. A method of determining a data unit of an image according to an embodiment will be described with reference to FIGS. 3 through 16, and an encoding or decoding method and apparatus for adaptively binarizing a split shape mode or inverse-binarizing a bin string for the split shape mode based on coding units of various shapes according to an embodiment will be described with reference to FIGS. 1A through 1C, 2A through 2C, and 17 through 25.

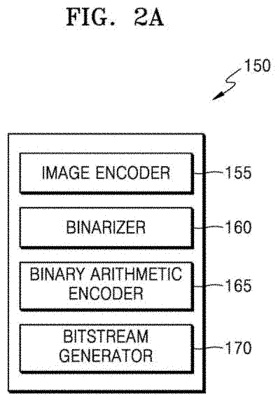

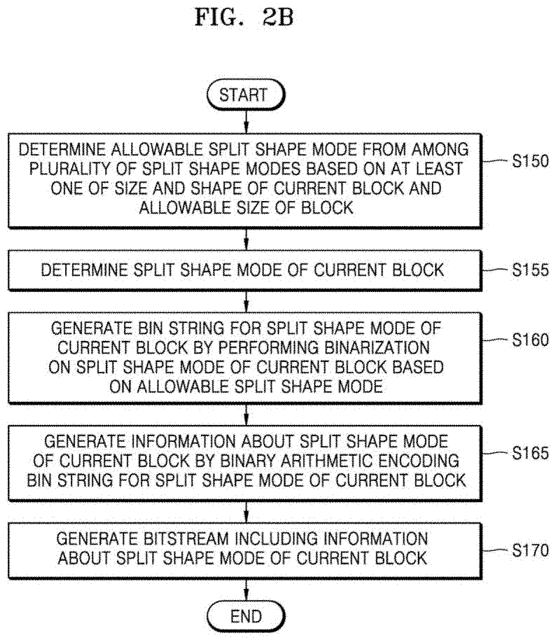

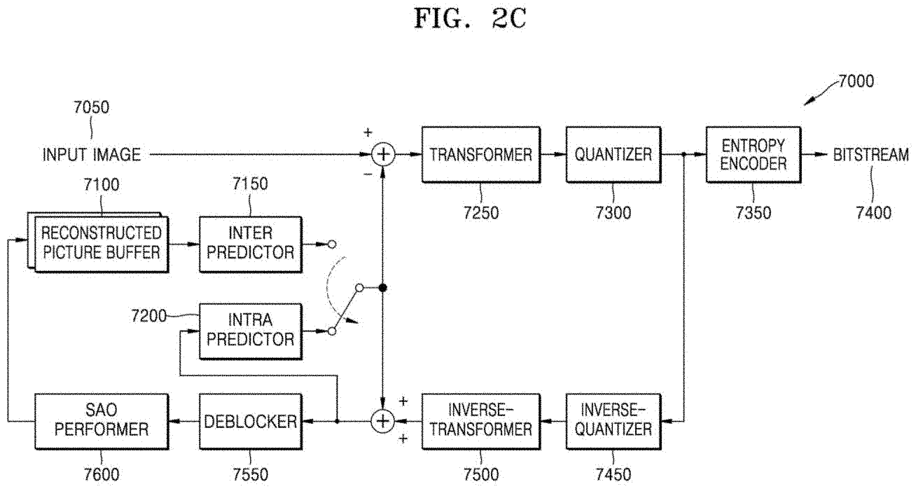

Hereinafter, an encoding/decoding method and apparatus for adaptively performing binarization/inverse-binarization based on coding units of various shapes according to an embodiment of the present disclosure will be described in detail with reference to FIGS. 1A through 2C.

FIG. 1A is a block diagram of an image decoding apparatus according to various embodiments.

An image decoding apparatus 100 according to various embodiments may include a binary arithmetic decoder 110, an inverse-binarizer 105, and an image decoder 115. The binary arithmetic decoder 110, the inverse-binarizer 105, and the image decoder 115 may include at least one processor. Also, the binary arithmetic decoder 110, the inverse-binarizer 105, and the image decoder 115 may include a memory in which instructions to be executed by the at least one processor are stored. The image decoder 115 may be implemented as hardware separate from the binary arithmetic decoder 110 and the inverse-binarizer 110 105, or may include the binary arithmetic decoder 110 and the inverse-binarizer 105.

The binary arithmetic decoder 110 may obtain information about a split shape mode of a current block from a bitstream. The information about the split shape mode of the current block may be syntax element information about the split shape mode of the current block. The information about the split shape mode may include information about whether a block is split, information about a split direction of the block, and information about a split type. The information about the split direction of the block may be information indicating whether the block is to be split in a horizontal direction or a vertical direction. The information about the split type may be information indicating whether the block is to be binary split or tri-split. However, the present disclosure is not limited thereto, and the information about the split shape mode may include information indicating whether quad splitting is performed, and in this case, the information about whether splitting is performed from among the information about the split shape mode may indicate that the bloc is split, the information about the split direction of the block may indicate that the block is split in both a horizontal direction and a vertical direction, and the information about the split type may indicate that the block is binary split. The present disclosure is not limited thereto, and the information about the split shape mode may include information indicating whether quad splitting is performed, the information about whether splitting is performed from among the information about the split shape mode may indicate that the block is split, there may be no information about the split direction of the block, and the information about the split type may indicate that the block is quad split.

However, the present disclosure is not limited thereto, and the information about the split shape mode obtained from the bitstream from among the information about the split shape mode may not include information about a mode in which the block is quad split. That is, when a height and a width of a current coding unit are the same as a height and a width of a largest coding unit, the split shape mode may be set to a mode in which the block is quad split, and information about a separate split shape mode may not be obtained from the bitstream. Except for this case, the information about the split shape mode obtained from the bitstream may include a split shape mode (hereinafter, referred to as SPLIT_BI_HOR or BI_HOR_SPLIT) in which the block is binary split in a horizontal direction, a split shape mode (hereinafter, referred to as SPLIT_TRI_HOR or TRI_HOR_SPLIT) in which the block is tri-split in a vertical direction, a split shape mode (hereinafter, referred to as SPLIT_BI_VER or BI_VER_SPLIT) in which the block is binary split in a horizontal direction, a split shape mode (hereinafter, referred to as SPLIT_TRI_VER or TRI_VER_SPLIT) in which the block is tri-split in a vertical direction, and a mode (hereinafter, referred to as NO_SPLIT) in which the block is not split.

The binary arithmetic decoder 110 may generate a bin string for the split shape mode of the current block including at least one bin by performing binary arithmetic decoding on syntax element information (syntax information about the split shape mode of the current block). For example, the binary arithmetic decoder 110 may perform binary arithmetic decoding based on a predetermined context model on syntax context information (the information about the split shape mode of the current block) obtained from a bitstream. The term ‘context model’ may refer to information about an occurrence probability of a bin. The information about the occurrence probability of the bin may include information vaIMPS indicating one of a least probable symbol (LPS) having a relatively low occurrence probability and a least most probable symbol (MPS) having a relatively high occurrence probability from among two symbols 0 and 1 and information about an occurrence probability of one symbol. The occurrence probability has a value between 0 and 1. Accordingly, when a probability of one of the MPS and the LPS is determined, information about an occurrence probability of the other symbol is information about a probability obtained by subtracting the pre-determined occurrence probability of the one symbol from 1. Accordingly, once an occurrence probability of one symbol is determined, the binary arithmetic decoder 110 may determine an occurrence probability of the other symbol. In this case, the occurrence probability of the one symbol that is first determined may be an occurrence probability of the LPS. Occurrence probabilities of symbols corresponding to index values may be pre-determined in a table, and occurrence probability information about the symbols may be information pStateIdx indicating indexes indicating the occurrence probabilities of the symbols determined in the table.

The predetermined context model may be determined based on a bin index indicating a position of a bin, an occurrence probability of the bin included in a neighboring block of a block including the bin, various elements of the current block or the neighboring block, etc. For example, the binary arithmetic decoder 110 may determine the predetermined context model based on block shape information of the current coding unit.

Alternatively, the binary arithmetic decoder 110 may perform binary arithmetic decoding according to a by-pass mode on the syntax element information obtained from the bitstream. In this case, a probability that a bin that is currently binary arithmetic decoded contains 0 or 1 may be fixed to 0.5, and binary arithmetic decoding may be performed on the syntax element information based on the probability.

The inverse-binarizer 105 may perform inverse-binarization on the bin string for the split shape mode of the current block. The binarization and the inverse-binarization define a 1:1 correspondence relationship between a bin string including at least one bin and a value of a syntax element (e.g., an index value) or information indicated by the syntax element. In terms of encoding, according to one of various binarization methods, a bin string including at least one bin corresponding to a value of a syntax element or information indicated by the syntax element may be determined, whereas in terms of decoding, according to an inverse-binarization method corresponding to any of the various binarization methods, the value of the syntax element or the information indicated by the syntax element corresponding to the bin string may be determined. For example, when a bin string ‘A’ corresponding to or a value ‘a’ (a is a real number) of a syntax element or information indicated by the syntax element is determined according to a predetermined binarization/inverse-binarization method, a process of determining the bin string ‘A’ based on the value ‘a’ of the syntax element or the information indicated by the syntax element may be referred to as a binarization process, and a process of determining the value ‘a’ of the syntax element or the syntax element itself based on the bin string ‘A’ may be referred to as an inverse-binarization process. However, as described above, it will be easily understood by one of ordinary skill in the art that binarization and inverse-binarization basically define a mapping relationship between a bin string and a value of a syntax element or the syntax element itself, and thus are substantially the same.

The image decoder 115 may determine an allowable split shape mode from among a plurality of split shape modes based on at least one of a size and a shape of a current block, and an allowable size of a block. In this case, examples of the shape may include a square shape, a rectangular shape whose width is greater than a height, and a rectangular shape whose height is greater than a width. The allowable size of the block may be determined based on a minimum size and a maximum size of a block allowable for decoding. For example, when the minimum size and the maximum size of the allowable block of the block are respectively 8×8 and 128×128, the allowable size of the block may range from 8×8 to 128×128, and a size of blocks generated when the current block is split according to a first split shape mode corresponds to the allowable size, the first split shape mode may be determined as the allowable split shape mode for the current block. When a size of at least one block from among blocks generated when the current block is split according to a second split shape mode does not correspond to the allowable size, the image decoder 115 may not determine the second split shape mode as the allowable split shape mode for the current block.

The image decoding apparatus 100 may determine a splitting rule of a coding unit based on at least one of the size and the shape of the current block and the allowable size of the block, and may determine the allowable split shape mode from among the plurality of split shape modes based on the splitting rule.

The plurality of split shape modes may be all split shape modes available by the image decoding apparatus 100 regardless of the size and the shape of the current block and the allowable size of the block. For example, the plurality of split shape modes may include SPLIT_BI_HOR, SPLIT_TRI_HOR, SPLIT_BI_VER, SPLIT_TRI_VER, and NO_SPLIT. The number of allowable split shape modes may be equal to or less than the number of the plurality of split shape modes.

The inverse-binarizer 105 may obtain the split shape mode of the current block by performing inverse-binarization on the bin string for the split shape mode of the current block based on the allowable split shape mode.

The inverse-binarizer 105 may determine the bin string corresponding to the allowable split shape mode. The inverse-binarizer 105 may determine the bin string corresponding to the allowable split shape mode from one of tables showing a correspondence relationship between allowable split shape modes and bin strings.

The inverse-binarizer 105 may determine the bin string corresponding to the allowable split shape mode based on a predetermined binarization method.

For example, a binarization method may be a unary binarization method, and a bin string allocated to each allowable split shape mode may be determined according to the number of allowable split shape modes and a priority of the allowable split shape modes.

For example, when the number of allowable split shape modes is 4 and a priority number of SPLIT_TRI_HOR is 4 after other split shape modes, according to a unary binarization method, a bin string allocated to SPLIT_TRI_HOR may be “1111”. At least one bin in a bin string allocated to an allowable split shape mode according to the binarization method corresponding to the allowable split shape mode may be at least one bin indicating whether splitting is performed. Alternatively, at least one bin in the bin string may indicate a split direction of a block. Also, at least one bin in the bin string may indicate a split type of the block.

For example, a first bin in the bin string may indicate whether the block is split. That is, when the first bin is 1, it may be indicated that the block is split, and when the first bin is 0, it may be indicated that the block is not split. A second bin or a third bin the bin string may indicate a split direction of the block. That is, when the second bin or the third bin is 1, a horizontal direction (or a vertical direction) may be indicated, and when the second bin or the third bin is 0, a vertical direction (or a horizontal direction) may be indicated. A third bin or a second bin in the bin string may indicate a split type. That is, when the third bin or the second bin is 1, tri-splitting (or binary splitting) may be indicated, and when the third bin or the second bin is 0, binary splitting (or tri-splitting) may be indicated.

The inverse-binarizer 105 may obtain the split shape mode of the current block by performing inverse-binarization on the bin string for the split shape mode of the current block based on the bin string corresponding to the allowable split shape mode.

When at least one remaining second split shape mode that is different in one of a split direction of a block and a split type of the block from a first split shape mode from among allowable split shape modes is not an allowable split shape mode, a part of at least one bin for one of the split direction of the block and the split type of the block may not be allocated.

For example, when a first split shape mode allowable for the current block is SPLIT_BI_VER and a second split shape mode that is not allowable is SPLIT_TRI_VER, split directions of the first split shape mode and the second split shape mode may be the same, that is, a vertical direction, but split types of the first split shape mode and the second split shape mode may be different, that is, may respectively indicate binary splitting and tri-splitting. In this case, when a bin indicating a split direction indicates a vertical direction, a split shape mode corresponding to a vertical direction from among allowable split shape modes may be SPLIT_BI_VER, and thus a bin indicating the number of splitting times may not be allocated. Alternatively, when the first split mode allowable for the current block is SPLIT_BI_HOR and the second split mode that is not allowable is SPLI_BI_VER, split types of the first split shape mode and the second split shape mode may be the same, that is, may indicate binary splitting, and split directions may be different, that is, may respectively indicate a horizontal direction and a vertical direction. In this case, when a bin indicating a split type indicates binary splitting, a split shape mode indicating binary splitting from among allowable split shape modes may be SPLIT_BI_HOR, and thus a bin indicating a split direction may not be allocated. That is, when the first split shape mode allowable for the current block and the second split shape mode that is not allowable are the same in one of a split direction and a split type and are different in the other, without allocating one bin from among at least one bin allocated to the different one, the inverse-binarizer 105 may determine the first split shape mode by using only a remaining bin.

The inverse-binarizer 105 may determine a bin string allocated to each allowable split shape mode according to a binarization method corresponding to the allowable split shape mode based on the number of allowable split shape modes and types of the allowable split shape modes.

The inverse-binarizer 105 may determine the number of bins that may be included in a bin string based on the number of allowable split shape modes, and may determine a bin string allocated to each allowable split shape mode according to types of the allowable modes.

For example, when the number of allowable split shape modes including NO_SPLIT is 5, the number of allowable split shape modes except NO_SPLIT may be 4, and the inverse-binarizer 105 may determine that the number of bins that may be included in a bin string is 1 or 3. That is, the inverse-binarizer 105 may allocate a bin indicating whether splitting is performed to a first bin, may allocate a bin indicating a split direction or a split type to a second bin, and may allocate a bin indicating a split type or a split direction to a third bin. When the first bin indicating whether splitting is performed is 0, the inverse-binarizer 105 may no longer obtain a bin and may determine that a split shape mode of the current block is NO_SPLIT by using one bin. When the first bin indicating whether splitting is performed is 1, the inverse-binarizer 105 may obtain a second bin and a third bin, may determine a split direction or a split type indicated by the second bin, may determine a split type or a split direction indicated by the third bin, and may determine the split shape mode of the current block from among split shape modes except NO_SPLIT by using three bins.

Also, for example, when the number of allowable split shape modes including NO_SPLIT is 4, the number of allowable split shape modes except NO_SPLIT may be 3, and the inverse-binarizer 105 may determine that the number of bins that may be included in a bin string is from 1 to 3. That is, the inverse-binarizer 105 may allocate a bin indicating whether splitting is performed to a first bin, may allocate a bin indicating a split direction to a second bin, and may allocate a bin indicating a split type to a third bin. When the first bin indicating whether splitting is performed is 0, the inverse-binarizer 105 may no longer obtain a bin and may determine that the split shape mode of the current block is NO_SPLIT by using one bin. When the first bin indicating whether splitting is performed is 1, the inverse-binarizer 105 may obtain the second bin indicating a split direction, and when SPLIT_BI_HOR is not an allowable split shape mode or SPLIT_TRI_HOR is not an allowable split shape mode, if the second bin is 1 (i.e., indicates a vertical direction), the inverse-binarizer 105 may obtain the third bin and may determine the split shape mode of the current block by using three bins. However, when the second bin is 0 (i.e., indicates a horizontal direction), the inverse-binarizer 105 may determine a split type without obtaining a new bin according to whether SPLIT_BI_HOR is an allowable mode (or whether SPLIT_TRI_HOR is an allowable split shape mode), and thus may determine the split shape mode of the current block by using two bins.

When SPLIT_BI_VER is not an allowable split shape mode or SPLIT_TRI_VER is not an allowable split shape mode, if the second bin is 0 (i.e., indicates a horizontal direction), the inverse-binarizer 105 may obtain the third bin and may determine the split shape mode of the current block by using three bins. However, when the second bin is 1 (i.e., indicates a vertical direction), the inverse-binarizer 105 may determine a split type without obtaining a new bin according to whether SPLIT_BI_VER is an allowable mode (or whether SPLIT_TRI_VER is an allowable mode), and may determine the split shape mode of the current block by using two bins.

Also, for example, when the number of allowable split shape modes including NO_SPLIT is 3, the number of allowable split shape modes except NO_SPLIT may be 2, and the inverse-binarizer 105 may determine that the number of bins that may be included in a bin string is 2.

When a first bin indicating whether splitting is performed is 0, the inverse-binarizer 105 may no longer obtain a bin and may determine that the split shape mode of the current block is NO_SPLIT. When the first bin indicating whether splitting is performed is 1, the inverse-binarizer 105 may check whether both SPLIT_BI_HOR and SPLIT_TRI_HOR are allowable modes or both SPLIT_BI_VER and SPLIT_TR_VER are allowable modes (i.e., whether both modes having the same split direction are allowable modes), and, if so, the inverse-binarizer 105 may determine a split direction according to whether SPLIT_BI_HOR is an allowable mode without obtaining a bin. The inverse-binarizer 105 may obtain a second bin, may determine a split type from the second bin, and thus may determine the split shape mode of the current block by using two bins.

When the first bin indicating whether splitting is performed is 1, the inverse-binarizer 105 may check whether both SPLIT_BI_HOR and SPLIT_TRI_HOR are allowable modes or both SPLIT_BI_VER and SPLIT_TRI_VER are allowable modes (i.e., whether both modes having the same split direction are allowable modes), and if not (i.e., when one of SPLIT_BI_HOR and SPLIT_TRI_HOR is not allowable and one of SPLIT_BI_VER and SPLIT_TRI_VER is not allowable), the inverse-binarizer 105 may obtain the second bin and may determine a split direction from the second bin. When both SPLIT_TRI_HOR and SPLIT_TRI_VER are not allowable modes, the inverse-binarizer 105 may determine that a split type is 0 (i.e., indicates binary splitting) without obtaining an additional bin. When SPLIT_TRI_VER is an allowable mode and SPLIT_BI_HOR is an allowable mode, the inverse-binarizer 105 may determine a split type by using a value of a bin indicating a split direction without obtaining an additional bin.

When SPLIT_TRI_HOR is an allowable mode and SPLIT_BI_VER is an allowable mode, the inverse-binarizer 105 may determine a split type by using the opposite value to a bin indicating a split direction without obtaining an additional bin.

For example, when the number of allowable split shape modes including NO_SPLIT is 2, the number of allowable split shape modes except NO_SPLIT may be 1, and the inverse-binarizer 105 may determine that the number of bins that may be included in a bin string is 1.

When a first bin indicating whether splitting is performed is 0, the inverse-binarizer 105 may no longer obtain a bin and may determine that the split shape mode of the current block is NO_SPLIT. When the first bin indicating whether splitting is performed is 1, the inverse-binarizer 105 may determine a split direction based on whether one of SPLIT_BI_VER and SPLIT_TRI_VER is an allowable mode without obtaining a bin. That is, when one of SPLIT_BI_VER and SPLIT_TRI_VER is an allowable mode, the inverse-binarizer 105 may determine that a split direction is 1 (i.e., indicates a vertical direction), and when one of SPLIT_TRI_HOR and SPLIT_TRI_VER is an allowable mode, the inverse-binarizer 105 may determine that a split type is 1 (i.e., indicates tri-splitting).

When a split type is 0 (i.e., binary splitting), if a split direction is 1 (i.e., indicates a vertical direction), the inverse-binarizer 105 may determine that the split shape mode of the current block is SPLIT_BI_VER. When a split direction is 0 (i.e., indicates a horizontal direction), the inverse-binarizer 105 may determine that the split shape mode of the current block is SPLIT_BI_HOR.

When a split type is 1 (i.e., tri-splitting), if a split direction is 1 (i.e., indicates a vertical direction), the inverse-binarizer 105 may determine that the split shape mode of the current block is SPLIT_TRI_VER. When a split direction is 0 (i.e., indicates a horizontal direction), the inverse-binarizer 105 may determine that the split shape mode of the current block is SPLIT_TRI_HOR.

Alternatively, for example, when the number of allowable split shape modes is 5 and a type of split shape modes allowable for the current block is NO_SPLIT, SPLIT_BI_HOR, SPLIT_BI_VER, SPLIT_TRI_HOR, or SPLIT_TRI_VER, the inverse-binarizer 105 may determine a priority of the allowable split shape modes in the current block in an order of NO_SPLIT, SPLI_TBI_HOR, SPLIT_BI_VER, SPLIT_TRI_HOR, and SPLIT_TRI_VER in consideration of the type of the allowable split shape modes, and may determine that a binarization method corresponding to a split mode is a unary binarization method. In this case, the priority may be a priority number of an index value corresponding to each split shape mode. That is, the index value corresponding to each split shape mode may be determined according to a priority from 0 to a value obtained by subtracting 1 from the number of allowable split shape modes. The priority is not limited to the above example, and may be determined in any of various ways. Also, it will be easily understood by one of ordinary skill in the art that the binary method is not limited to the unary binarization method and any of various other binarization methods may be used.

The inverse-binarizer 105 may determine a bin string allocated according to a priority between types of allowable split shape modes and a unary binarization method for the allowable split shape modes. For example, the inverse-binarizer 105 may determine that a bin string for SPLIT_BI_VER located at a third position in a priority of allowable split shape modes from among 5 allowable split shape modes is “110”

For example, when the number of allowable split shape modes is 3 and types of split shape modes allowable for the current block are NO_SPLIT, SPLIT_BI_HOR, and SPLIT_BI_VER, the inverse-binarizer 105 may determine a priority of the allowable split shape modes in the current block in an order of NO_SPLIT, SPLIT_BI_HOR, and SPLIT_BI_VER in consideration of the types of the allowable split shape modes, and may determine that a binarization method corresponding to a split mode is a unary binarization method. The inverse-binarizer 105 may determine a bin string allocated according to the unary binarization method for the allowable split shape modes. For example, the inverse-binarizer 105 may determine that a bin string for SPLIT_BI_VER located at a third position in a priority of allowable split shape odes from among 3 allowable split shape modes is “11”.

The inverse-binarizer 105 may first check the number of allowable split shape modes in the current block, and may check a value of a first bin. When the value of the first bin is 0, the inverse-binarizer 105 may obtain a split shape mode having a first priority number from among the allowable split shape modes as the split shape mode of the current block.

When the value of the first bin is 1, the inverse-binarizer 105 may increase a count value by 1, and the inverse-binarizer 105 may check values of bins until a (number of allowable split shape modes −2)^{th} bin from the number of allowable split shape modes. When the values of the bins are sequentially checked to reach 1, the inverse-binarizer 105 may increase a count value by 1, and when a value of a bin is 0, the inverse-binarizer 105 may no longer increase a count value and may no longer obtain a bin. When a value of the (number of allowable split shape modes−2)^{th} bin is 1, the inverse-binarizer 105 may additionally increase a count value by 1. The inverse-binarizer 105 may obtain the split shape mode of the current block corresponding to a count value according to a priority of allowable split shape modes.

The inverse-binarizer 105 may obtain the split shape mode of the current block by performing inverse-binarization on information about the split shape mode of the current block based on the bin string allocated to the allowable split shape mode. That is, the inverse-binarizer 105 may obtain the split shape mode of the current block corresponding to the bin string obtained from the information about the split shape mode of the current block by performing inverse-binarization on the information about the split shape mode of the current block.

The image decoder 115 may determine whether the current block is to be split based on the split shape mode of the current block. In this case, the current block may be a coding unit.

When it is determined that the current block is not split based on the split shape mode of the current block, the image decoder 115 may perform decoding based on the current block. That is, when it is determined that the current block is not split based on information about whether the current block included in the split shape mode of the current block is split, the image decoder 115 may perform decoding based on the current block.

When it is determined that the current block is split based on the split shape mode of the current block, the image decoder 115 may split the current block included in the split shape mode of the current block into a plurality of blocks based on information about a split direction and a split type of a block.

In this case, the binary arithmetic decoder 110 may generate a bin string for a split shape mode of one block from among the plurality of blocks by obtaining information about the split shape mode of one block from among the plurality of blocks from a bitstream and binary arithmetic decoding the information about the split shape mode. The inverse-binarizer 105 may determine an allowable first split shape mode from among a plurality of split shape modes based on at least one of a size and a shape of one block from among the plurality of blocks and an allowable size of the blocks.

The inverse-binarizer 105 may obtain the split shape mode of one block from among the plurality of blocks by performing inverse-binarization on the bin string for the split shape mode of the current block based on allowable split shape modes.

The image decoder 115 may determine whether one block from among the plurality of blocks is to be split based on the split shape mode of one block from among the plurality of blocks.

When the image decoding apparatus 100 changes a splitting rule by obtaining information of changing the splitting rule at a sequence parameter level, a slice parameter level, a picture parameter level, or a largest coding unit parameter level, or changes the splitting rule by using a pre-defined method between the image decoding apparatus 100 and the image encoding apparatus, if the number of allowable split shape modes is changed before and after the splitting rule is changed, a correspondence relationship between the bin string of the split shape mode of the current block and the allowable split shape modes may be changed.

FIG. 1B is a flowchart of an image decoding method according to various embodiments.

In operation S105, the image decoding apparatus 100 may determine an allowable split shape mode from among a plurality of split shape modes based on at least one of a size and a shape of a current block and an allowable size of a block.

In operation S110, the image decoding apparatus 100 may obtain information about a split shape mode of the current block from a bitstream.

In operation S115, the image decoding apparatus 100 may generate a bin string for the split shape mode of the current block including at least one bin by binary arithmetic decoding the information about the split shape mode of the current block.

In operation S120, the image decoding apparatus 100 may obtain the split shape mode of the current block by performing inverse-binarization on the bin string for the split shape mode of the current block based on the allowable split shape mode.

In operation S125, the image decoding apparatus 100 may determine whether the current block is to be split based on the split shape mode of the current block.

FIG. 1C is a block diagram of an image decoder 6000 according to various embodiments.

The image decoder 6000 according to various embodiments performs tasks that are performed by the image decoder 115 of the image decoding apparatus 100 to encode image data.

Referring to FIG. 1C, an entropy decoder 6150 parses encoding information needed for decoding and encoded image data to be decoded from a bitstream 6050. The encoded image data is a quantized transform coefficient, and an inverse-quantizer 6200 and an inverse-transformer 6250 reconstruct residue data from the quantized transform coefficient. The entropy decoder 6150 of FIG. 1C may correspond to the binary arithmetic decoder 110 and the inverse-binarizer 105 of FIG. 1A.

An intra predictor 6400 performs intra prediction for each block. An inter predictor 6350 performs inter prediction by using a reference image obtained from a reconstructed picture buffer 6300 for each block. Prediction data for each block generated by the intra predictor 6400 or the inter predictor 6350 may be added the residue data to reconstruct data of a spatial domain for a block of a current image 6050, and a deblocker 6450 and a sample adaptive offset (SAO) performer 6500 may output a filtered reconstruction image 6600 by performing loop filtering on the reconstructed data of the spatial domain. Also, reconstruction images stored in the reconstructed picture buffer 6300 may be output as reference images. In order for a decoder (not shown) of the image decoding apparatus 100 to decode image data, tasks of the image decoder 6000 according to various embodiments may be performed according to blocks.

FIG. 2A is a block diagram of an image encoding apparatus according to various embodiments.

The image encoding apparatus 150 according to various embodiments may include an image encoder 155, a binarizer 160, a binary arithmetic encoder 165, and a bitstream generator 170.

The image encoder 155, the binarizer 160, the binary arithmetic encoder 165, and the bitstream generator 170 may include at least one processor. Also, the image encoder 155, the binarizer 160, the binary arithmetic encoder 165, and the bitstream generator 170 may include a memory that stores instructions to be executed by the at least one processor. The image encoder 155 may be implemented as separate hardware from the binarizer 160, the binary arithmetic encoder 165, and the bitstream generator 170, or may include the binarizer 160, the binary arithmetic encoder 165, and the bitstream generator 170.

The image encoder 155 may determine a split shape mode of a current block from among a plurality of split shape modes. The plurality of split shape modes may be all split shape modes available by the image encoding apparatus 150 regardless of a size and a shape of the current block and an allowable size of a block.

The image encoding apparatus 150 may determine a splitting rule of a coding unit based on at least one of the size and the shape of the current block and the allowable size of the block, and may determine an allowable split shape mode from among the plurality of split shape modes based on the splitting rule.

The binarizer 160 may determine the allowable split shape mode from among the plurality of split shape modes based on at least one of the size and the shape of the current block and the allowable size of the block. The binarizer 160 may generate a bin string for a split shape mode of the current block by performing binarization on the split shape mode of the current block based on the allowable split shape mode. The allowable size of the block may be determined based on a minimum size and a maximum size of a block allowable for encoding.

The binarizer 160 may determine a bin string corresponding to each split shape mode allocated according to a binarization method corresponding to the allowable split shape mode, and may generate the bin string for the split shape mode of the current block by performing binarization on the split shape mode of the current block based on the bin string. In this case, the binarization method may be a unary binarization method, and the binarizer 160 may determine a bin string allocated to each allowable split shape mode according to the number of allowable split shape modes and a priority of the allowable split shape modes. For example, when the number of allowable split shape modes is 4 and a priority number of SPLIT_TRI_HOR is 4 after other split shape modes, according to a unary binarization method, a bin string allocated to SPLIT_TRI_HOR may be “1111”. At least one bin in a bin string may be a bin indicating whether the block is split. A first bin in the bin string may indicate whether the block is split. That is, when a value of the first bin is 1, it may be indicated that the block is split, and when a value of the bin is 0, it may be indicated that the block is not split. Alternatively, at least one bin in the bin string may be a bin indicating a split direction or a split type of the block. A second bin or a third bin in the bin string may indicate a split direction of the block. That is, when a value of a bin is 1, a horizontal direction may be indicated, and when a value of a bin is 0, a vertical direction may be indicated. Alternatively, at least one bin in the bin string may be a bin indicating a split type. The second bin or the third bin the bin string may indicate a split type. That is, when a value of a bin is 1, tri-splitting may be indicated, and when a value of a bin is 0, binary splitting may be indicated.

When at least one remaining second split shape mode that is different in one of a split direction of a block and a split type of the block from a first split shape mode from among allowable split shape modes is not the allowable split shape mode, a part of at least one bin for one of the split direction of the block and the split type of the block may not be allocated.

For example, when a first split shape mode allowable for the current block is SPLIT_BI_VER and a second split shape mode that is not allowable is SPLIT_TRI_VER, split directions of the first split shape mode and the second split shape mode may be the same, that is, a vertical direction, but split types of the first split shape mode and the second split shape mode may be different, that is, may respectively indicate binary splitting and tri-splitting. In this case, when a bin indicating a split direction indicates a vertical direction, a split shape mode corresponding to a vertical direction from among allowable split shape modes may be SPLIT_BI_VER, and thus a bin indicating the number of splitting times may not be allocated. Alternatively, when the first split mode allowable for the current block is SPLIT_BI_HOR and the second split mode that is not allowable is SPLI_BI_VER, split types of the first split shape mode and the second split shape mode may be the same, that is, may indicate binary splitting, and split directions may be different, that is, may respectively indicate a horizontal direction and a vertical direction. In this case, when a bin indicating a split type indicates binary splitting, a split shape mode indicating binary splitting from among allowable split shape modes may be SPLIT_BI_HOR, and thus a bin indicating a split direction may not be allocated.

That is, when the first split shape mode allowable for the current block and the second split shape mode that is not allowable are the same in one of a split direction and a split type and are different in the other, without allocating one bin from among at least one bin allocated to the different one, the binarizer 160 may determine the first split shape mode by using only a remaining bin.

The binarizer 160 may determine a bin string allocated to each allowable split shape mode according to a binarization method corresponding to the allowable split shape mode based on the number of allowable split shape modes and types of the allowable split shape modes.

The binarizer 160 may check the number of split shape modes allowable for the current block. The binarizer 160 may determine a bin string allocated to each of allowable split shape modes according to the number of split shape modes allowable for the current block and a priority of the allowable split shape modes.

The binarizer 160 may obtain the split shape mode of the current block, may check the number of split shape modes allowable for the current block, and may check an order number of the split shape mode of the current block from among the allowable split shape modes. The binarizer 160 may generate bins so that the bins, the number of which corresponds to a value obtained by subtracting 1 from the order number of the split shape mode of the current block, have a value of 1, and a last bin has a value of 0. The binarizer 160 may generate a bin string including the generated at least one bin.

However, when the split shape mode of the current block is a last mode from among modes allowable, the binarizer 160 may generate bins so that bins, the number of which corresponds to a value obtained by subtracting 1 from the order number of the split shape mode of the current block, have a value of 1, and a last bin has a value of 1. The binarizer 160 may generate a bin string including the generated at least one bin.

The binary arithmetic encoder 165 may generate information about the split shape mode of the current block by performing binary arithmetic encoding on the bin string for the block shape mode of the current block.

For example, the binary arithmetic encoder 165 may perform binary arithmetic decoding based on a predetermined context model on the bin string for the block shape mode of the current block. The term ‘context model’ may refer to information about an occurrence probability of a bin. The predetermined context model may be determined based on a bin index indicating a position of a bin, an occurrence probability of the bin included in a neighboring block of a block including the bin, various elements of the current block or the neighboring block, etc. For example, the binary arithmetic encoder 165 may determine the predetermined context model based on block shape information of a current coding unit.

Alternatively, the binary arithmetic encoder 165 may perform binary arithmetic encoding according to a by-pass mode on the bin string for the block shape mode of the current block. In this case, a probability that a bin that is currently binary arithmetic encoded contains 0 or 1 may be fixed 0.5, and binary arithmetic decoding may be performed on the bin string for the block shape mode of the current block based on the probability.

The bitstream generator 170 may generate a bitstream including the information about the split shape mode of the current block. The information about the split shape mode may include information about whether the block is split, a split direction of the block, and a split type of the block. The information about the split type may indicate one of binary splitting and tri-splitting.

FIG. 2B is a flowchart of an image encoding method according to various embodiments.

In operation S150, the image encoding apparatus 150 may determine an allowable split shape mode from among a plurality of split shape modes based on at least one of a size and a shape of a current block and an allowable size of a block.

In operation S155, the image encoding apparatus 150 may determine a split shape mode of the current block.

In operation S160, the image decoding apparatus 100 may generate a bin string for the split shape mode of the current block by performing binarization on the split shape mode of the current block based on the allowable split shape mode.

In operation S165, the image decoding apparatus 100 may generate information about the split shape mode of the current block by binary arithmetic encoding the bin string for the split shape mode of the current block.

In operation S170, the image decoding apparatus 100 may generate a bitstream including the information about the split shape mode of the current block.

FIG. 2C is a block diagram of an image encoder according to various embodiments.

An image encoder 7000 according to various embodiments performs tasks performed by the image encoder 155 of the image encoding apparatus 150 to encode image data.

That is, an intra predictor 7200 performs intra prediction for each block in a current image 7050, and an inter predictor 7150 performs inter prediction by using the current image 7050 and a reference image obtained by a reconstructed picture buffer 7100 for each block.

Residue data may be generated by subtracting prediction data for each block output from the intra predictor 7200 or the inter predictor 7150 from data for an encoded block of the current image 7050, and a transformer 7250 and a quantizer 7300 may output a quantized transform coefficient for each block by performing transformation and quantization on the residue data. An inverse-quantizer 7450 and an inverse-transformer 7500 may reconstruct the residue data of a spatial domain by performing inverse-quantization and inverse-transformation on the quantized transform coefficient. The reconstructed residue data of the spatial domain is added to the prediction data for each block output from the intra predictor 7200 or the inter predictor 7150, to be reconstructed as data of a spatial domain for the block of the current image 7050. A deblocker 7550 and an SAO performer perform in-loop filtering on the reconstructed data of the spatial domain and generate a filtered reconstruction image. The generated reconstruction image is stored in the reconstructed picture buffer 7100. Reconstruction images stored in the reconstructed picture buffer 7100 may be used as reference images for inter prediction of other images. An entropy encoder 7350 may entropy encode the quantized transform coefficient and the entropy encoded coefficient may be output as a bitstream 7400. The entropy encoder 7350 of FIG. 2C may correspond to the binarizer 160 and the binary arithmetic encoder 165 of FIG. 2A.

In order to apply the image encoder 7000 according to various embodiments to the image encoding apparatus 150, tasks of the image encoder 7000 according to various embodiments may be performed for each block.

Splitting of a coding unit according to an embodiment of the present disclosure will now be described in detail.

An image may be split into largest coding units. A size of each largest coding unit may be determined based on information obtained from a bitstream. A shape of each largest coding unit may be a square shape of the same size. However, the present disclosure is not limited thereto. Also, a largest coding unit may be hierarchically split into coding units based on information about a split shape mode obtained from a bitstream. The information about the split shape mode may include at least one of information indicating whether splitting is performed, split direction information, and split type information. The information indicating whether splitting is performed indicates whether a coding unit is to be split. The split direction information indicates that splitting is performed in one of a horizontal direction and a vertical direction. The split type information indicates that splitting is performed in one of binary splitting, tri-splitting, and quad splitting.

Although it is described that the information about the split shape mode includes the information indicating whether splitting is performed, the split direction information, and the split type information for convenience of explanation, the present disclosure is not limited thereto. The image decoding apparatus 100 may obtain the information about the split shape mode from a bitstream by using one bin string. The image decoding apparatus 100 may determine whether a coding unit is to be split, a split direction, and a split type, based on one bin string.

The coding unit may be equal to or less than a largest coding unit. For example, when the information about the split shape mode indicates that splitting is not performed, the coding unit has the same size as the largest coding unit. When the information about the split shape mode indicates that splitting is performed, the largest coding unit may be split into coding units of a lower depth. Also, when the information about the split shape mode for the coding units of the lower depth indicates that splitting is performed, the coding units of the lower depth may be split into smaller coding units. However, splitting of an image is not limited thereto, and largest coding unit and a coding unit may not be distinguished from each other. Splitting of a coding unit will be described in more detail with reference to FIGS. 3 through 16.

Also, a coding unit may be split into prediction units for prediction of an image. Each of the prediction units may be equal to or less than the coding unit. Also, the coding unit may be split into transform units for transformation of an image. Each of the transform units may be equal to or less than the coding unit. Shapes and sizes of the transform unit and the prediction unit may not be related to each other. The coding unit may be distinguished from the prediction unit and the transform unit, or the coding unit, the prediction unit, and the transform unit may be the same. Splitting of the prediction unit and the transform unit may be performed in the same manner as that of the coding unit. Splitting of the coding unit will be described in more detail with reference to FIGS. 3 through 16. Each of a current block and a neighboring block of the present disclosure may indicate one of a largest coding unit, a coding unit, a prediction unit, and a transform unit. Also, a current block or a current coding unit is a block where decoding or encoding is currently performed or splitting is currently performed. The neighboring block may be a block that is reconstructed earlier than the current block. The neighboring block may be spatially or temporally adjacent to the current block. The neighboring block may be located at one of a left lower side, a left side, a left upper side, an upper side, a right upper side, a right side, and a right lower side of the current block.

FIG. 3 illustrates a process, performed by the image decoding apparatus 100, of determining at least one coding unit by splitting a current coding unit, according to an embodiment.

A block shape may include 4N×4N, 4N×2N, 2N×4N, 4N×N, or N×4N. N may be a positive integer. Block shape information is information indicating at least one of a shape, a direction, a ratio between a width and a height, and a size of a coding unit.

The shape of the coding unit may include a square shape and a non-square shape. When the width and the height of the coding unit are the same (i.e., when the block shape of the coding unit is 4N×4N), the image decoding apparatus 100 may determine the block shape information of the coding unit as a square shape. The image decoding apparatus 100 may determine the shape of the coding unit as a non-square shape.

When the width and the height of the coding unit are different from each other (i.e., when the block shape of the coding unit is 4N×2N, 2N×4N, 4N×N, or N×4N), the image decoding apparatus 100 may determine the block shape information of the coding unit as a non-square shape. When the shape of the coding unit is a non-square shape, the image decoding apparatus 100 may determine the width-to-height ratio in the block shape information of the coding unit as at least one of 1:2, 2:1, 1:4, 4:1, 1:8, and 8:1. Also, the image decoding apparatus 100 may determine whether the coding unit is in a horizontal direction or a vertical direction, based on a length of the width and a length of the height of the coding unit. Also, the image decoding apparatus 100 may determine the size of the coding unit, based on at least one of the length of the width, the length of the height, and an area of the coding unit.

According to an embodiment, the image decoding apparatus 100 may determine a shape of the coding unit by using the block shape information, and may determine which shape the coding unit is split into by using information about a split shape mode. That is, a coding unit splitting method indicated by the information about the split shape mode may be determined according to which block shape is indicated by the block shape information used by the image decoding apparatus 100.

The image decoding apparatus 100 may determine the information about the split shape mode from a bitstream. However, the present disclosure is not limited thereto, and the image decoding apparatus 100 and the image encoding apparatus 150 may determine the information about the split shape mode that is pre-promised based on the block shape information. The image decoding apparatus 100 may determine the information about the split shape mode that is pre-promised for a largest coding unit or a smallest coding unit. For example, the image decoding apparatus 100 may determine that the information about the split shape mode for the largest coding unit indicates quad splitting. Also, the image decoding apparatus 100 may determine that the information about the split shape mode for the smallest coding unit indicates “not to perform splitting”. For example, the image decoding apparatus 100 may determine that a size of the largest coding unit is 256×256. The image decoding apparatus 100 may determine that the pre-promised information about the split shape mode indicates quad splitting. The quad splitting is a split shape mode in which the width and the height of the coding unit are halved. The image decoding apparatus 100 may obtain the coding unit having a size of 128×128 from the largest coding unit having a size of 256×256 based on the information about the split shape mode. Also, the image decoding apparatus 100 may determine that a size of the smallest coding unit is 4×4. The image decoding apparatus 100 may obtain the information about the split shape mode indicating “not to perform splitting” for the smallest coding unit.

According to an embodiment, the image decoding apparatus 100 may use the block shape information indicating that the current coding unit has a square shape. For example, the image decoding apparatus 100 may determine whether not to split a square coding unit, whether to vertically split the square coding unit, whether to horizontally split the square coding unit, or whether to split the square coding unit into four coding units, based on the information about the split shape mode. Referring to FIG. 3, when the block shape information of a current coding unit 300 indicates a square shape, the decoder 120 may determine that a coding unit 310a having the same size as the current coding unit 300 is not split, based on the information about the split shape mode indicating not to perform splitting, or may determine coding units 310b, 310c, and 310d split based on the information about the split shape mode indicating a predetermined splitting method.

Referring to FIG. 3, according to an embodiment, the image decoding apparatus 100 may determine two coding units 310b obtained by vertically splitting the current coding unit 300, based on the information about the split shape mode indicating to vertically perform splitting. The image decoding apparatus 100 may determine two coding units 310c obtained by horizontally splitting the current coding unit 300, based on the information about the split shape mode indicating to horizontally perform splitting. The image decoding apparatus 100 may determine four coding units 310d obtained by vertically and horizontally splitting the current coding unit 300, based on the information about the split shape mode indicating to vertically and horizontally perform splitting. However, splitting methods of the square coding unit are not limited to the above-described methods, and the information about the split shape mode may include various methods. Predetermined splitting methods of splitting the square coding unit will be described in detail below through various embodiments.

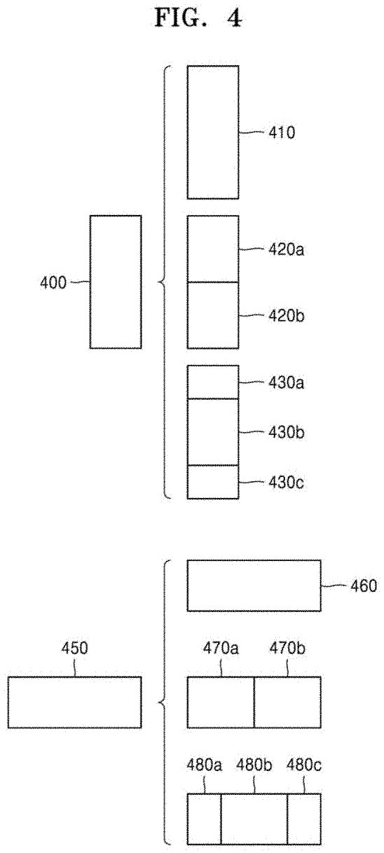

FIG. 4 illustrates a process, performed by the image decoding apparatus 100, of determining at least one coding unit by splitting a non-square coding unit, according to an embodiment.

According to an embodiment, the image decoding apparatus 100 may use block shape information indicating that a current coding unit has a non-square shape. The image decoding apparatus 100 may determine, according to information about a split shape mode, whether not to split the non-square current coding unit or whether to split the non-square current coding unit by using a predetermined method. Referring to FIG. 4, when the block shape information of a current coding unit 400 or 450 indicates a non-square shape, the image decoding apparatus 100 may determine a coding unit 410 or 460 having the same size as the current coding unit 400 or 450 based on the information about the split shape mode indicating not to perform splitting, or determine coding units 420a and 420b, 430a to 430c, 470a and 470b, or 480a to 480c split based on the information about the split shape mode indicating a predetermined splitting method. Predetermined splitting methods of splitting a non-square coding unit will be described in detail below through various embodiments.

According to an embodiment, the image decoding apparatus 100 may determine a splitting method of a coding unit by using the information about the split shape mode and, in this case, the information about the split shape mode may indicate the number of one or more coding units generated by splitting the coding unit. Referring to FIG. 4, when the information about the split shape mode indicates to split the current coding unit 400 or 450 into two coding units, the image decoding apparatus 100 may determine two coding units 420a and 420b, or 470a and 470b included in the current coding unit 400 or 450 by splitting the current coding unit 400 or 450 based on the information about the split shape mode.

According to an embodiment, when the image decoding apparatus 100 splits the non-square current coding unit 400 or 450 based on the information about the split shape mode, a location of a long side of the non-square current coding unit 400 or 450 may be considered. For example, the image decoding apparatus 100 may determine a plurality of coding units by splitting the long side of the current coding unit 400 or 450, in consideration of a shape of the current coding unit 400 or 450.

According to an embodiment, when the information about the split shape mode indicates to split (tri-split) a coding unit into an odd number of blocks, the image decoding apparatus 100 may determine an odd number of coding units included in the current coding unit 400 or 450. For example, when the information about the split shape mode indicates to split the current coding unit 400 or 450 into three coding units, the image decoding apparatus 100 may split the current coding unit 400 or 450 into three coding units 430a, 430b, and 430c, or 480a, 480b, and 480c.

According to an embodiment, a width-to-height ratio of the current coding unit 400 or 450 may be 4:1 or 1:4. When the width-to-height ratio is 4:1, a length of the width is greater than a length of the height, and thus the block shape information may be horizontal. When the width-to-height ratio is 1:4, a length of the width is less than a length of the height, and thus the block shape information may be vertical. The image decoding apparatus 100 may determine to split the current coding unit into an odd number of blocks based on the information about the split shape mode. Also, the image decoding apparatus 100 may determine a split direction of the current coding unit 400 or 450 based on the block shape information of the current coding unit 400 or 450. For example, when the current coding unit 400 is in a vertical direction, the image decoding apparatus 100 may horizontally split the current coding unit 400 and may determine the coding units 430a, 430b, and 430c. Also, when the current coding unit 450 is in a horizontal direction, the image decoding apparatus 100 may vertically split the current coding unit 450 and may determine the coding units 480a, 480b, and 480c.

According to an embodiment, the image decoding apparatus 100 may determine an odd number of coding units included in the current coding unit 400 or 450, and sizes of all of the determined coding units may not be the same. For example, a predetermined coding unit 430b or 480b from among the determined odd number of coding units 430a, 430b, and 430c, or 480a, 480b, and 480c may have a size different from sizes of the other coding units 430a and 430c, or 480a and 480c. That is, coding units which may be determined by splitting the current coding unit 400 or 450 may have multiple sizes and, in some cases, all of the odd number of coding units 430a, 430b, and 430c, or 480a, 480b, and 480c may have different sizes.

According to an embodiment, when the information about the split shape mode indicates to split a coding unit into an odd number of blocks, the image decoding apparatus 100 may determine an odd number of coding units included in the current coding unit 400 or 450, and may put a predetermined restriction on at least one coding unit from among the odd number of coding units generated by splitting the current coding unit 400 or 450. Referring to FIG. 4, the image decoding apparatus 100 may allow a decoding method of the coding unit 430b or 480b to be different from that of the other coding units 430a and 430c, or 480a and 480c, wherein the coding unit 430b or 480b is at a center location from among the three coding units 430a, 430b, and 430c, or 480a, 480b, and 480c generated by splitting the current coding unit 400 or 450. For example, the image decoding apparatus 100 may restrict the coding unit 430b or 480b at the center location to be no longer split or to be split only a predetermined number of times, unlike the other coding units 430a and 430c, or 480a and 480c.

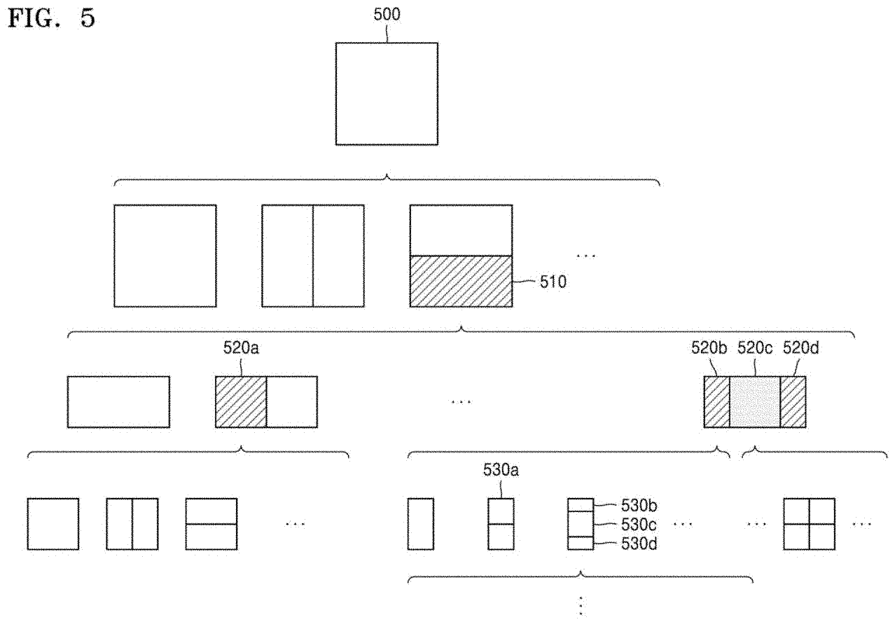

FIG. 5 illustrates a process, performed by the image decoding apparatus 100, of splitting a coding unit based on at least one of block shape information and information about a split shape mode, according to an embodiment.

According to an embodiment, the image decoding apparatus 100 may determine to split or not to split a square first coding unit 500 into coding units based on at least one of the block shape information and the information about the split shape mode. According to an embodiment, when the information about the split shape mode indicates to split the first coding unit 500 in a horizontal direction, the image decoding apparatus 100 may determine a second coding unit 510 by splitting the first coding unit 500 in a horizontal direction. A first coding unit, a second coding unit, and a third coding unit used according to an embodiment are terms used to understand a relation before and after splitting a coding unit. For example, the second coding unit may be determined by splitting the first coding unit, and the third coding unit may be determined by splitting the second coding unit. It will be understood that a relationship among the first coding unit, the second coding unit, and the third coding unit applies to the following descriptions.

According to an embodiment, the image decoding apparatus 100 may determine to split or not to split the determined second coding unit 510 into coding units, based on at least one of the block shape information and the information about the split shape mode. Referring to FIG. 5, the image decoding apparatus 100 may or may not split the non-square second coding unit 510, which is determined by splitting the first coding unit 500, into one or more third coding units 520a, or 520b, 520c, and 520d based on at least one of the block shape information and the information about the split shape mode. The image decoding apparatus 100 may obtain at least one of the block shape information and the information about the split shape mode, and may split a plurality of various-shaped second coding units (e.g., 510) by splitting the first coding unit 500, based on at least one of the block shape information and the information about the split shape mode, and the second coding unit 510 may be split by using a splitting method of the first coding unit 500 based on at least one of the block shape information and the information about the split shape mode. According to an embodiment, when the first coding unit 500 is split into the second coding units 510 based on at least one of the block shape information and the information about the split shape mode of the first coding unit 500, the second coding unit 510 may also be split into the third coding units 520a, or 520b, 520c, and 520d based on at least one of the block shape information and the information about the split shape mode of the second coding unit 510. That is, a coding unit may be recursively split based on at least one of the block shape information and the information about the split shape mode of each coding unit. Therefore, a square coding unit may be determined by splitting a non-square coding unit, and a non-square coding unit may be determined by recursively splitting the square coding unit.

Referring to FIG. 5, a predetermined coding unit (e.g., a coding unit at a center location or a square coding unit) from among an odd number of third coding units 520b, 520c, and 520d determined by splitting the non-square second coding unit 510 may be recursively split. According to an embodiment, the square third coding unit 520b from among the odd number of third coding units 520b, 520c, and 520d may be split in a horizontal direction into a plurality of fourth coding units. A non-square fourth coding unit 530b or 530d from among the plurality of fourth coding units 530a, 530b, 530c, and 530d may be split again into a plurality of coding units. For example, the non-square fourth coding unit 530b or 530d may be split again into an odd number of coding units, A method that may be used to recursively split a coding unit will be described below through various embodiments.

According to an embodiment, the image decoding apparatus 100 may split each of the third coding units 520a, or 520b, 520c, and 520d into coding units, based on at least one of the block shape information and the information about the split shape mode. Also, the image decoding apparatus 100 may determine not to split the second coding unit 510 based on at least one of the block shape information and the information about the split shape mode. According to an embodiment, the image decoding apparatus 100 may split the non-square second coding unit 510 into the odd number of third coding units 520b, 520c, and 520d. The image decoding apparatus 100 may put a predetermined restriction on a predetermined third coding unit from among the odd number of third coding units 520b, 520c, and 520d. For example, the image decoding apparatus 100 may restrict the third coding unit 520c at a center location from among the odd number of third coding units 520b, 520c, and 520d to be no longer split or to be split a settable number of times.

Referring to FIG. 5, the image decoding apparatus 100 may restrict the third coding unit 520c, which is at the center location from among the odd number of third coding units 520b, 520c, and 520d included in the non-square second coding unit 510, to be no longer split, to be split by using a predetermined splitting method (e.g., split into only four coding units or split by using a splitting method of the second coding unit 510), or to be split only a predetermined number of times (e.g., split only n times (where n>0)). However, the restrictions on the third coding unit 520c at the center location are not limited to the above-described examples, and may include various restrictions for decoding the third coding unit 520c at the center location differently from the other third coding units 520b and 520d.

According to an embodiment, the image decoding apparatus 100 may obtain at least one of the block shape information and the information about the split shape mode, which is used to split a current coding unit, from a predetermined location in the current coding unit.

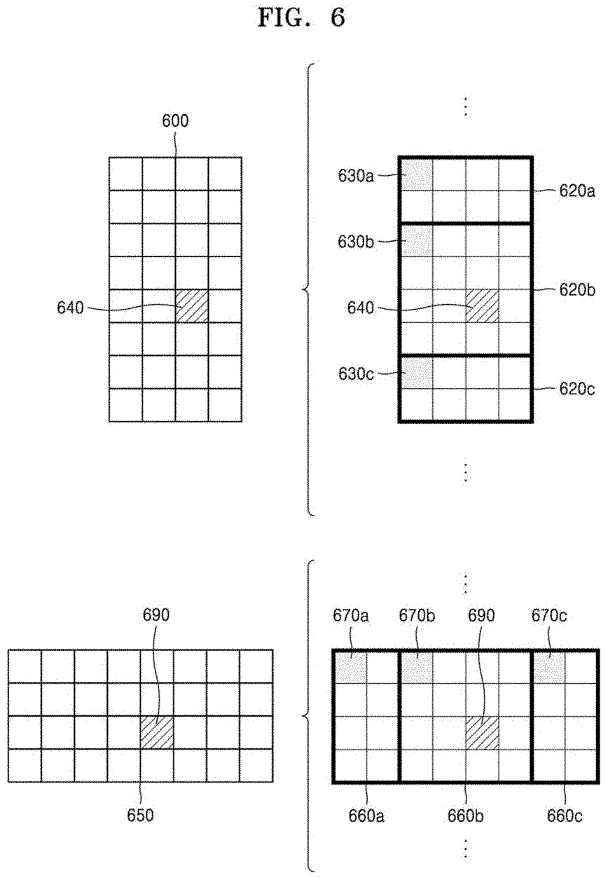

FIG. 6 illustrates a method, performed by the image decoding apparatus 100, of determining a predetermined coding unit from among an odd number of coding units, according to an embodiment.

Referring to FIG. 6, at least one of block shape information and information about a split shape mode of a current coding unit 600 or 650 may be obtained from a sample of a predetermined location (e.g., a sample 640 or 690 of a center location) from among a plurality of samples included in the current coding unit 600 or 650. However, the predetermined location in the current coding unit 600, from which at least one of the block shape information and the information about the split shape mode may be obtained, is not limited to the center location in FIG. 6, and may include various locations (e.g., top, bottom, left, right, top left, bottom left, top right, and bottom right locations) included in the current coding unit 600. The image decoding apparatus 100 may obtain at least one of the block shape information and the information about the split shape mode from the predetermined location and may determine to split or not to split the current coding unit into various-shaped and various-sized coding units.

According to an embodiment, when the current coding unit is split into a predetermined number of coding units, the image decoding apparatus 100 may select one of the coding units. Various methods that may be used to select one of a plurality of coding units will be described below through various embodiments.

According to an embodiment, the image decoding apparatus 100 may split the current coding unit into a plurality of coding units, and may determine a coding unit at a predetermined location.

According to an embodiment, the image decoding apparatus 100 may use information indicating locations of an odd number of coding units to determine a coding unit at a center location from among the odd number of coding units. Referring to FIG. 6, the image decoding apparatus 100 may determine an odd number of coding units 620a, 620b, and 620c or an odd number of coding units 660a, 660b, and 660c by splitting the current coding unit 600 or the current coding unit 650. The image decoding apparatus 100 may determine the coding unit 620b at a center location or the coding unit 660b at a center location by using information about locations of the odd number of coding units 620a, 620b, and 620c or the odd number of coding units 660a, 660b, and 660c. For example, the image decoding apparatus 100 may determine the coding unit 620b of the center location by determining the locations of the coding units 620a, 620b, and 620c based on information indicating locations of predetermined samples included in the coding units 620a, 620b, and 620c. In detail, the image decoding apparatus 100 may determine the coding unit 620b at the center location by determining the locations of the coding units 620a, 620b, and 620c based on information indicating locations of top left samples 630a, 630b, and 630c of the coding units 620a, 620b, and 620c.

According to an embodiment, the information indicating the locations of the top left samples 630a, 630b, and 630c, which are included in the coding units 620a, 620b, and 620c, respectively, may include information about locations or coordinates of the coding units 620a, 620b, and 620c in a picture. According to an embodiment, the information indicating the locations of the top left samples 630a, 630b, and 630c, which are included in the coding units 620a, 620b, and 620c, respectively, may include information indicating widths or heights of the coding units 620a, 620b, and 620c included in the current coding unit 600, and the widths or heights may correspond to information indicating differences between the coordinates of the coding units 620a, 620b, and 620c in the picture. That is, the image decoding apparatus 100 may determine the coding unit 620b at the center location by directly using the information about the locations or coordinates of the coding units 620a, 620b, and 620c in the picture, or by using the information about the widths or heights of the coding units, which correspond to the difference values between the coordinates.

According to an embodiment, information indicating the location of the top left sample 630a of the upper coding unit 620a may include coordinates (xa, ya), information indicating the location of the top left sample 630b of the middle coding unit 620b may include coordinates (xb, yb), and information indicating the location of the top left sample 630c of the lower coding unit 620c may include coordinates (xc, yc). The image decoding apparatus 100 may determine the middle coding unit 620b by using the coordinates of the top left samples 630a, 630b, and 630c which are included in the coding units 620a, 620b, and 620c, respectively. For example, when the coordinates of the top left samples 630a, 630b, and 630c are sorted in an ascending or descending order, the coding unit 620b including the coordinates (xb, yb) of the sample 630b at a center location may be determined as a coding unit at a center location from among the coding units 620a, 620b, and 620c determined by splitting the current coding unit 600. However, the coordinates indicating the locations of the top left samples 630a, 630b, and 630c may include coordinates indicating absolute locations in the picture, or may use coordinates (dxb, dyb) indicating a relative location of the top left sample 630b of the middle coding unit 620b and coordinates (dxc, dyc) indicating a relative location of the top left sample 630c of the lower coding unit 620c, with reference to the location of the top left sample 630a of the upper coding unit 620a. Also, a method of determining a coding unit at a predetermined location by using coordinates of a sample included in the coding unit as information indicating a location of the sample is not limited to the above-described method, and may include various arithmetic methods capable of using the coordinates of the sample.

According to an embodiment, the image decoding apparatus 100 may split the current coding unit 600 into the plurality of coding units 620a, 620b, and 620c, and may select one of the coding units 620a, 620b, and 620c based on a predetermined criterion. For example, the image decoding apparatus 100 may select the coding unit 620b, which has a size different from that of the others, from among the coding units 620a, 620b, and 620c.

According to an embodiment, the image decoding apparatus 100 may determine the widths or heights of the coding units 620a, 620b, and 620c by using the coordinates (xa, ya) indicating the location of the top left sample 630a of the upper coding unit 620a, the coordinates (xb, yb) indicating the location of the top left sample 630b of the middle coding unit 620b, and the coordinates (xc, yc) indicating the location of the top left sample 630c of the lower coding unit 620c. The image decoding apparatus 100 may determine the respective sizes of the coding units 620a, 620b, and 620c by using the coordinates (xa, ya), (xb, yb), and (xc, yc) indicating the locations of the coding units 620a, 620b, and 620c. According to an embodiment, the image decoding apparatus 100 may determine the width of the upper coding unit 620a to be a width of the current coding unit 600. The image decoding apparatus 100 may determine the height of the upper coding unit 620a to be yb-ya. According to an embodiment, the image decoding apparatus 100 may determine the width of the middle coding unit 620b to be a width of the current coding unit 600. The image decoding apparatus 100 may determine the height of the middle coding unit 620b to be yc-yb. According to an embodiment, the image decoding apparatus 100 may determine the width or height of the lower coding unit 620c by using the width or height of the current coding unit 600 and the widths or heights of the upper and middle coding units 620a and 620b. The image decoding apparatus 100 may determine a coding unit, which has a size different from that of the others, based on the determined widths and heights of the coding units 620a to 620c. Referring to FIG. 6, the image decoding apparatus 100 may determine the middle coding unit 620b, which has a size different from the size of the upper and lower coding units 620a and 620c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

The image decoding apparatus 100 may determine a width or a height of each of the coding units 660a, 660b, and 660c by using coordinates (xd, yd) that are information indicating a location of a top left sample 670a of the left coding unit 660a, coordinates (xe, ye) that are information indicating a location of a top left sample 670b of the middle coding unit 660b, and coordinates (xf, yf) that are information indicating a location of a top left sample 670c of the right coding unit 660c. The image decoding apparatus 100 may determine sizes of the coding units 660a, 660b, and 660c by using the coordinates (xd, yd), (xe, ye), and (xf, yf) indicating the locations of the coding units 660a, 660b, and 660c.

According to an embodiment, the image decoding apparatus 100 may determine the width of the left coding unit 660a to be xe-xd. The image decoding apparatus 100 may determine the height of the left coding unit 660a as the height of the current coding unit 650. According to an embodiment, the image decoding apparatus 100 may determine the width of the middle coding unit 660b to be xf-xe. The image decoding apparatus 100 may determine the height of the middle coding unit 660b to be the height of the current coding unit 600. According to an embodiment, the image decoding apparatus 100 may determine the width or the height of the right coding unit 660c by using the width or the height of the current coding unit 650 and the width and the height of the left coding unit 660a and the middle coding unit 660b. The image decoding apparatus 100 may determine a coding unit, which has a size different from that of the others, based on the determined widths and heights of the coding units 660a, 660b, and 660c. Referring to FIG. 6, the image decoding apparatus 100 may determine the middle coding unit 660b, which has a size different from the size of the left coding unit 660a and the right coding unit 660c, as the coding unit of the predetermined location. However, the above-described method, performed by the image decoding apparatus 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

However, locations of samples considered to determine locations of coding units are not limited to the above-described top left locations, and information about arbitrary locations of samples included in the coding units may be used.

According to an embodiment, the image decoding apparatus 100 may select a coding unit at a predetermined location from among an odd number of coding units determined by splitting the current coding unit, considering the shape of the current coding unit. For example, when the current coding unit has a non-square shape, a width of which is longer than a height, the image decoding apparatus 100 may determine the coding unit at the predetermined location in a horizontal direction. That is, the image decoding apparatus 100 may determine one of coding units at different locations in a horizontal direction and may put a restriction on the coding unit. When the current coding unit has a non-square shape, a height of which is longer than a width, the image decoding apparatus 100 may determine the coding unit at the predetermined location in a vertical direction. That is, the image decoding apparatus 100 may determine one of coding units at different locations in a vertical direction and may put a restriction on the coding unit.

According to an embodiment, the image decoding apparatus 100 may use information indicating respective locations of an even number of coding units, to determine the coding unit at the predetermined location from among the even number of coding units. The image decoding apparatus 100 may determine an even number of coding units by splitting (binary splitting) the current coding unit, and may determine the coding unit at the predetermined location by using the information about the locations of the even number of coding units. An operation related thereto may correspond to the operation of determining a coding unit at a predetermined location (e.g., a center location) from among an odd number of coding units, which has been described in detail above with reference to FIG. 6, and thus detailed descriptions thereof are not provided here.

According to an embodiment, when a non-square current coding unit is split into a plurality of coding units, predetermined information about a coding unit at a predetermined location may be used in a splitting operation to determine the coding unit at the predetermined location from among the plurality of coding units. For example, the image decoding apparatus 100 may use at least one of block shape information and information about a split shape mode, which is stored in a sample included in a coding unit at a center location, in a splitting operation to determine the coding unit at the center location from among the plurality of coding units determined by splitting the current coding unit.

Referring to FIG. 6, the image decoding apparatus 100 may split the current coding unit 600 into the plurality of coding units 620a, 620b, and 620c based on at least one of the block shape information and the information about the split shape mode, and may determine the coding unit 620b at a center location from among the plurality of the coding units 620a, 620b, and 620c. Furthermore, the image decoding apparatus 100 may determine the coding unit 620b at the center location, in consideration of a location from which at least one of the block shape information and the information about the split shape mode is obtained. That is, at least one of the block shape information and the information about the split shape mode of the current coding unit 600 may be obtained from the sample 640 at a center location of the current coding unit 600 and, when the current coding unit 600 is split into the plurality of coding units 620a, 620b, and 620c based on at least one of the block shape information and the information about the split shape mode, the coding unit 620b including the sample 640 may be determined as the coding unit at the center location. However, information used to determine the coding unit at the center location is not limited to at least one of the block shape information and the information about the split shape mode, and various kinds of information may be used to determine the coding unit at the center location.

According to an embodiment, predetermined information for identifying the coding unit at the predetermined location may be obtained from a predetermined sample included in a coding unit to be determined. Referring to FIG. 6, the image decoding apparatus 100 may use at least one of the block shape information and the information about the split shape mode, which is obtained from a sample at a predetermined location in the current coding unit 600 (e.g., a sample at a center location of the current coding unit 600) to determine a coding unit at a predetermined location from among the plurality of the coding units 620a, 620b, and 620c determined by splitting the current coding unit 600 (e.g., a coding unit at a center location from among a plurality of split coding units). That is, the image decoding apparatus 100 may determine the sample at the predetermined location by considering a block shape of the current coding unit 600, may determine the coding unit 620b including a sample, from which predetermined information (e.g., at least one of the block shape information and the information about the split shape mode) may be obtained, from among the plurality of coding units 620a, 620b, and 620c determined by splitting the current coding unit 600, and may put a predetermined restriction on the coding unit 620b. Referring to FIG. 6, according to an embodiment, the image decoding apparatus 100 may determine the sample 640 at the center location of the current coding unit 600 as the sample from which the predetermined information may be obtained, and may put a predetermined restriction on the coding unit 620b including the sample 640, in a decoding operation. However, the location of the sample from which the predetermined information may be obtained is not limited to the above-described location, and may include arbitrary locations of samples included in the coding unit 620b to be determined for a restriction.

According to an embodiment, the location of the sample from which the predetermined information may be obtained may be determined based on the shape of the current coding unit 600. According to an embodiment, the block shape information may indicate whether the current coding unit has a square or non-square shape, and the location of the sample from which the predetermined information may be obtained may be determined based on the shape. For example, the image decoding apparatus 100 may determine a sample located on a boundary for dividing at least one of a width and height of the current coding unit in half, as the sample from which the predetermined information may be obtained, by using at least one of information about the width of the current coding unit and information about the height of the current coding unit. As another example, when the block shape information of the current coding unit indicates a non-square shape, the image decoding apparatus 100 may determine one of samples adjacent to a boundary for dividing a long side of the current coding unit in half, as the sample from which the predetermined information may be obtained.

According to an embodiment, when the current coding unit is split into a plurality of coding units, the image decoding apparatus 100 may use at least one of the block shape information and the information about the split shape mode to determine a coding unit at a predetermined location from among the plurality of coding units. According to an embodiment, the image decoding apparatus 100 may obtain at least one of the block shape information and the information about the split shape mode from a sample at a predetermined location in a coding unit, and may split the plurality of coding units, which are generated by splitting the current coding unit, by using at least one of the block shape information and the information about the split shape mode, which is obtained from the sample of the predetermined location in each of the plurality of coding units. That is, a coding unit may be recursively split based on at least one of the block shape information and the information about the split shape mode, which is obtained from the sample at the predetermined location in each coding unit. An operation of recursively splitting a coding unit has been described above with reference to FIG. 5, and thus detailed descriptions thereof will not be provided here.

According to an embodiment, the image decoding apparatus 100 may determine one or more coding units by splitting the current coding unit, and may determine an order of decoding the one or more coding units based on a predetermined block (e.g., the current coding unit).

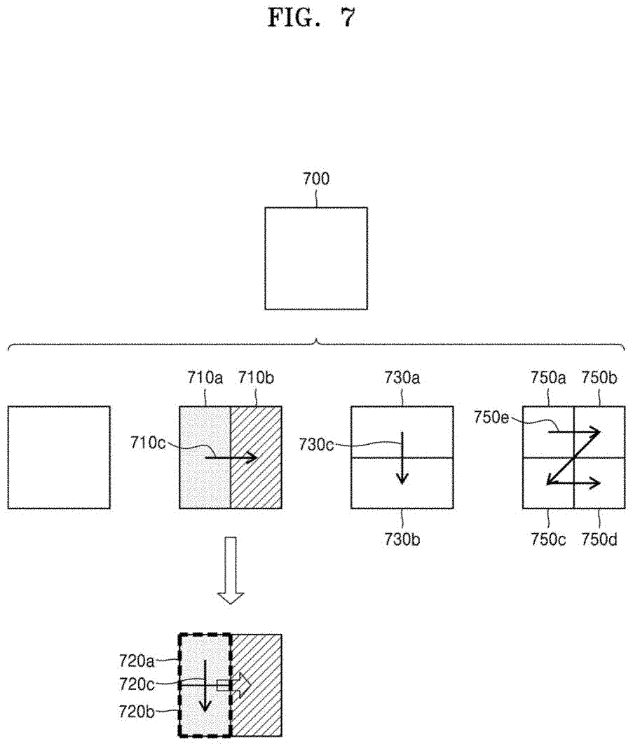

FIG. 7 illustrates an order of processing a plurality of coding units when the image decoding apparatus 100 determines the plurality of coding units by splitting a current coding unit, according to an embodiment.

According to an embodiment, the image decoding apparatus 100 may determine second coding units 710a and 710b by splitting a first coding unit 700 in a vertical direction, may determine second coding units 730a and 730b by splitting the first coding unit 700 in a horizontal direction, or may determine second coding units 750a to 750d by splitting the first coding unit 700 in vertical and horizontal directions, based on block shape information and information about a split shape mode.

Referring to FIG. 7, the image decoding apparatus 100 may determine to process the second coding units 710a and 710b, which are determined by splitting the first coding unit 700 in a vertical direction, in a horizontal direction order 710c. The image decoding apparatus 100 may determine to process the second coding units 730a and 730b, which are determined by splitting the first coding unit 700 in a horizontal direction, in a vertical direction order 730c. The image decoding apparatus 100 may determine to process the second coding units 750a to 750d, which are determined by splitting the first coding unit 700 in vertical and horizontal directions, in a predetermined order for processing coding units in a row and then processing coding units in a next row (e.g., in a raster scan order or Z-scan order 750e).

According to an embodiment, the image decoding apparatus 100 may recursively split coding units. Referring to FIG. 7, the image decoding apparatus 100 may determine the plurality of second coding units 710a, 710b, 730a, 730b, 750a, 750b, 750c, and 750d by splitting the first coding unit 700, and may recursively split each of the determined plurality of second coding units 710a, 710b, 730a, 730b, 750a, 750b, 750c, and 750d. A splitting method of the plurality of second coding units 710a, 710b, 730a, 730b, 750a, 750b, 750c, and 750d may correspond to a splitting method of the first coding unit 700. As such, each of the plurality of second coding units 710a, 710b, 730a, 730b, 750a, 750b, 750c, and 750d may be independently split into a plurality of coding units. Referring to FIG. 7, the image decoding apparatus 100 may determine the second coding units 710a and 710b by splitting the first coding unit 700 in a vertical direction, and may determine to independently split or not to split each of the second coding units 710a and 710b.

According to an embodiment, the image decoding apparatus 100 may determine third coding units 720a and 720b by splitting the left second coding unit 710a in a horizontal direction, and may not split the right second coding unit 710b.

According to an embodiment, a processing order of coding units may be determined based on an operation of splitting a coding unit. In other words, a processing order of split coding units may be determined based on a processing order of coding units immediately before being split. The image decoding apparatus 100 may determine a processing order of the third coding units 720a and 720b determined by splitting the left second coding unit 710a, independently of the right second coding unit 710b. Because the third coding units 720a and 720b are determined by splitting the left second coding unit 710a in a horizontal direction, the third coding units 720a and 720b may be processed in a vertical direction order 720c. Because the left and right second coding units 710a and 710b are processed in the horizontal direction order 710c, the right second coding unit 710b may be processed after the third coding units 720a and 720b included in the left second coding unit 710a are processed in the vertical direction order 720c. An operation of determining a processing order of coding units based on a coding unit before being split is not limited to the above-described example, and various methods may be used to independently process coding units, which are split and determined to various shapes, in a predetermined order.

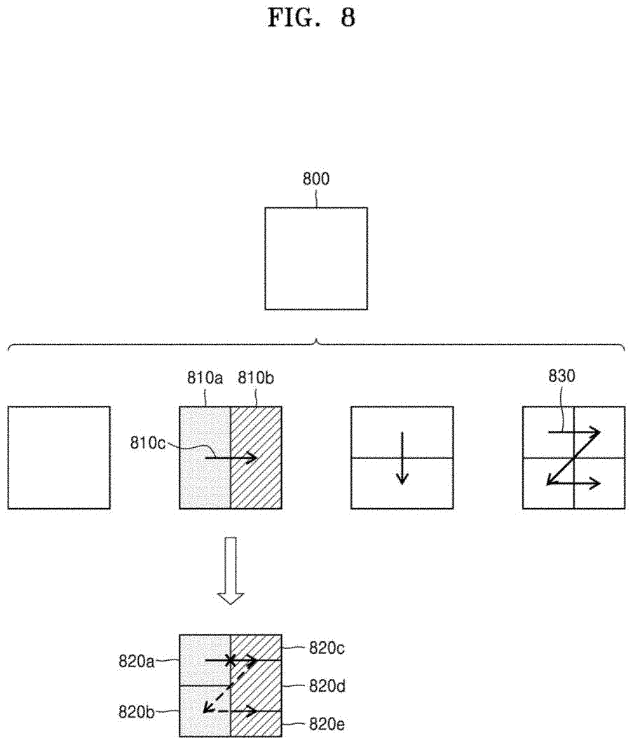

FIG. 8 illustrates a process, performed by the image decoding apparatus 100, of determining that a current coding unit is to be split into an odd number of coding units, when the coding units are not processable in a predetermined order, according to an embodiment.

According to an embodiment, the image decoding apparatus 100 may determine whether the current coding unit is split into an odd number of coding units, based on obtained block shape information and information about a split shape mode. Referring to FIG. 8, a square first coding unit 800 may be split into non-square second coding units 810a and 810b, and the second coding units 810a and 810b may be independently split into third coding units 820a and 820b, and 820c to 820e. According to an embodiment, the image decoding apparatus 100 may determine the plurality of third coding units 820a and 820b by splitting the left second coding unit 810a in a horizontal direction, and may split the right second coding unit 810b into an odd number of third coding units 820c to 820e.

According to an embodiment, the image decoding apparatus 100 may determine whether any coding unit is split into an odd number of coding units, by determining whether the third coding units 820a and 820b, and 820c to 820e are processable in a predetermined order. Referring to FIG. 8, the image decoding apparatus 100 may determine the third coding units 820a and 820b, and 820c to 820e by recursively splitting the first coding unit 800. The image decoding apparatus 100 may determine whether any of the first coding unit 800, the second coding units 810a and 810b, and the third coding units 820a and 820b, and 820c, 820d, and 820e is split into an odd number of coding units, based on at least one of block shape information and information about a split shape mode. For example, the right second coding unit 810b may be split into an odd number of third coding units 820c, 820d, and 820e. A processing order of a plurality of coding units included in the first coding unit 800 may be a predetermined order (e.g., a Z-scan order 830), and the image decoding apparatus 100 may decide whether the third coding units 820c, 820d, and 820e, which are determined by splitting the right second coding unit 810b into an odd number of coding units, satisfy a condition for processing in the predetermined order.

According to an embodiment, the image decoding apparatus 100 may determine whether the third coding units 820a and 820b, and 820c, 820d, and 820e included in the first coding unit 800 satisfy the condition for processing in the predetermined order, and the condition relates to whether at least one of a width and height of the second coding units 810a and 810b is divided in half along a boundary of the third coding units 820a and 820b, and 820c, 820d, and 820e. For example, the third coding units 820a and 820b determined by dividing the height of the non-square left second coding unit 810a in half may satisfy the condition. However, because boundaries of the third coding units 820c, 820d, and 820e determined by splitting the right second coding unit 810b into three coding units do not divide the width or height of the right second coding unit 810b in half, it may be determined that the third coding units 820c, 820d, and 820e do not satisfy the condition. When the condition is not satisfied as described above, the image decoding apparatus 100 may decide disconnection of a scan order, and determine that the right second coding unit 810b is split into an odd number of coding units, based on a result of the decision. According to an embodiment, when a coding unit is split into an odd number of coding units, the image decoding apparatus 100 may put a predetermined restriction on a coding unit at a predetermined location among the split coding units, and the restriction or the predetermined location has been described above through various embodiments and thus detailed descriptions thereof will not be provided here.

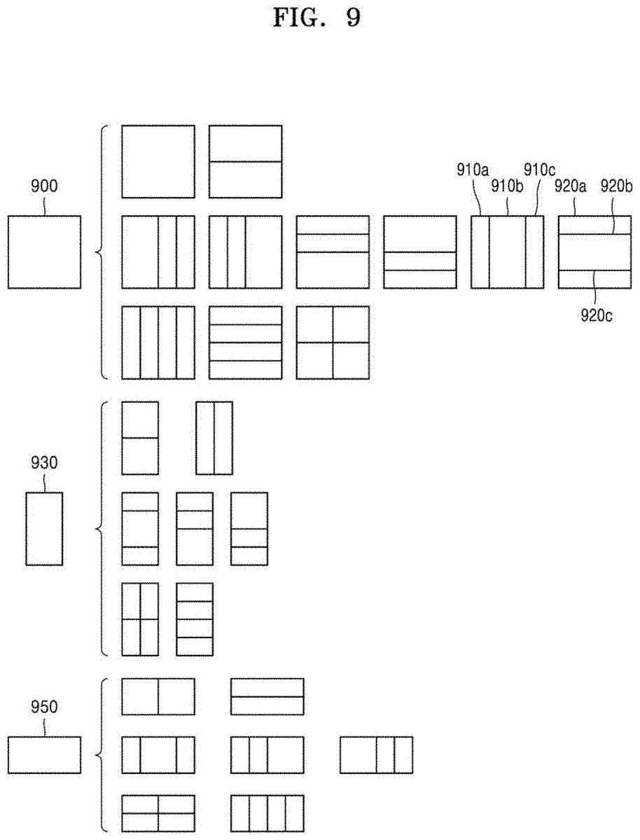

FIG. 9 illustrates a process, performed by the image decoding apparatus 100, of determining at least one coding unit by splitting a first coding unit 900, according to an embodiment.

According to an embodiment, the image decoding apparatus 100 may split the first coding unit 900, based on at least one of block shape information and information about a split shape mode, which is obtained by the receiver. The square first coding unit 900 may be split into four square coding units, or may be split into a plurality of non-square coding units. For example, referring to FIG. 9, when the block shape information indicates that the first coding unit 900 has a square shape and the information about the split shape mode indicates to split the first coding unit 900 into non-square coding units, the image decoding apparatus 100 may split the first coding unit 900 into a plurality of non-square coding units. In detail, when the information about the split shape mode indicates to determine an odd number of coding units by splitting the first coding unit 900 in a horizontal direction or a vertical direction, the image decoding apparatus 100 may split the square first coding unit 900 into an odd number of coding units, e.g., second coding units 910a, 910b, and 910c determined by splitting the square first coding unit 900 in a vertical direction or second coding units 920a, 920b, and 920c determined by splitting the square first coding unit 900 in a horizontal direction.

According to an embodiment, the image decoding apparatus 100 may determine whether the second coding units 910a, 910b, 910c, 920a, 920b, and 920c included in the first coding unit 900 satisfy a condition for processing in a predetermined order, and the condition relates to whether at least one of a width and height of the first coding unit 900 is divided in half along a boundary of the second coding units 910a, 910b, 910c, 920a, 920b, and 920c. Referring to FIG. 9, because boundaries of the second coding units 910a, 910b, and 910c determined by splitting the square first coding unit 900 in a vertical direction do not divide the width of the first coding unit 900 in half, it may be determined that the first coding unit 900 does not satisfy the condition for processing in the predetermined order. In addition, because boundaries of the second coding units 920a, 920b, and 920c determined by splitting the square first coding unit 900 in a horizontal direction do not divide the width of the first coding unit 900 in half, it may be determined that the first coding unit 900 does not satisfy the condition for processing in the predetermined order. When the condition is not satisfied as described above, the image decoding apparatus 100 may decide disconnection of a scan order, and may determine that the first coding unit 900 is split into an odd number of coding units based on a result of the decision. According to an embodiment, when a coding unit is split into an odd number of coding units, the image decoding apparatus 100 may put a predetermined restriction on a coding unit at a predetermined location from among the split coding units, and the restriction or the predetermined location has been described above through various embodiments and thus detailed descriptions thereof will not be provided here.

According to an embodiment, the image decoding apparatus 100 may determine various-shaped coding units by splitting a first coding unit.

Referring to FIG. 9, the image decoding apparatus 100 may split the square first coding unit 900 or a non-square first coding unit 930 or 950 into various-shaped coding units.

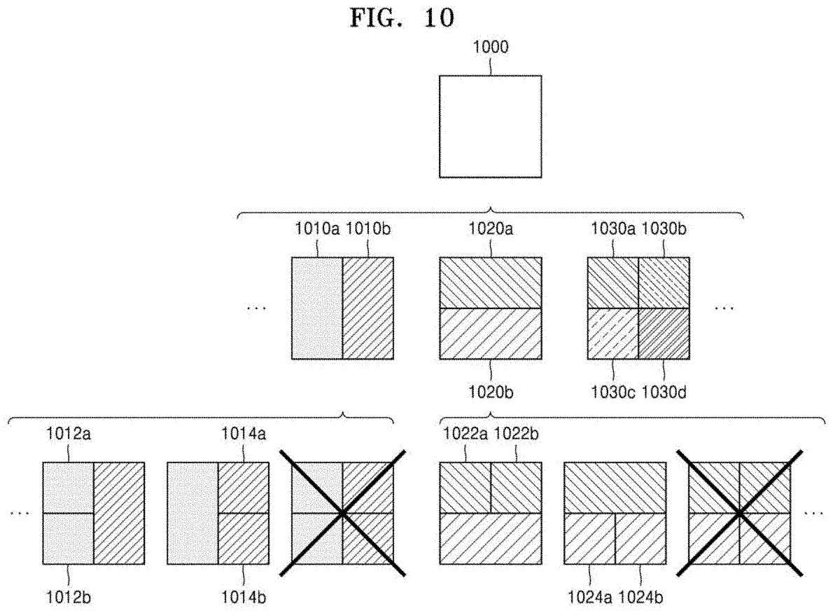

FIG. 10 illustrates that a shape into which a second coding unit is splittable by the image decoding apparatus 100 is restricted when the second coding unit having a non-square shape, which is determined by splitting a first coding unit 1000, satisfies a predetermined condition, according to an embodiment.

According to an embodiment, the image decoding apparatus 100 may determine to split the square first coding unit 1000 into non-square second coding units 1010a, 1010b, 1020a, and 1020b, based on at least one of block shape information and information about a split shape mode, which is obtained by the receiver. The second coding units 1010a, 1010b, 1020a, and 1020b may be independently split. As such, the image decoding apparatus 100 may determine to split or not to split the first coding unit 1000 into a plurality of coding units, based on at least one of the block shape information and the information about the split shape mode of each of the second coding units 1010a, 1010b, 1020a, and 1020b. According to an embodiment, the image decoding apparatus 100 may determine third coding units 1012a and 1012b by splitting the non-square left second coding unit 1010a, which is determined by splitting the first coding unit 1000 in a vertical direction, in a horizontal direction. However, when the left second coding unit 1010a is split in a horizontal direction, the image decoding apparatus 100 may restrict the right second coding unit 1010b to not be split in a horizontal direction in which the left second coding unit 1010a is split. When third coding units 1014a and 1014b are determined by splitting the right second coding unit 1010b in the same direction, because the left and right second coding units 1010a and 1010b are independently split in a horizontal direction, the third coding units 1012a, 1012b, 1014a, and 1014b may be determined. However, this case serves equally as a case in which the image decoding apparatus 100 splits the first coding unit 1000 into four square second coding units 1030a, 1030b, 1030c, and 1030d, based on at least one of the block shape information and the information about the split shape mode, and may be inefficient in terms of image decoding.

According to an embodiment, the image decoding apparatus 100 may determine third coding units 1022a, 1022b, 1024a, and 1024b by splitting the non-square second coding unit 1020a or 1020b, which is determined by splitting the first coding unit 1000 in a horizontal direction, in a vertical direction. However, when a second coding unit (e.g., the upper second coding unit 1020a) is split in a vertical direction, for the above-described reason, the image decoding apparatus 100 may restrict the other second coding unit (e.g., the lower second coding unit 1020b) to not be split in a vertical direction in which the upper second coding unit 1020a is split.

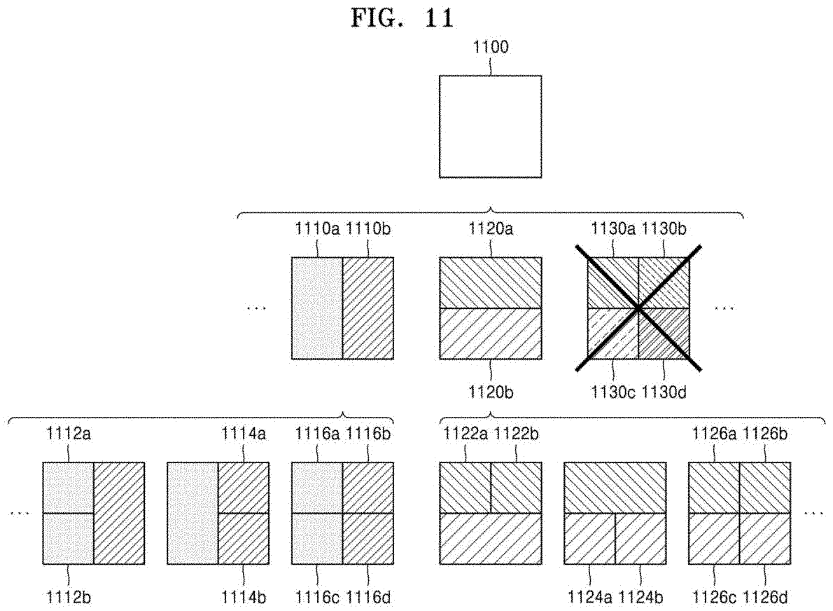

FIG. 11 illustrates a process, performed by the image decoding apparatus 100, of splitting a square coding unit when information about a split shape mode indicates that the square coding unit is not to be split into four square coding units, according to an embodiment.

According to an embodiment, the image decoding apparatus 100 may determine second coding units 1110a, 1110b, 1120a, 1120b, etc. by splitting a first coding unit 1100 based on at least one of block shape information and information about a split shape mode. The information about the split shape mode may include information about various methods of splitting a coding unit but, the information about various splitting methods may not include information for splitting a coding unit into four square coding units. According to such information about the split shape mode, the image decoding apparatus 100 may not split the first square coding unit 1100 into four square second coding units 1130a, 1130b, 1130c, and 1130d. The image decoding apparatus 100 may determine the non-square second coding units 1110a, 1110b, 1120a, 1120b, etc., based on the information about the split shape mode.

According to an embodiment, the image decoding apparatus 100 may independently split the non-square second coding units 1110a, 1110b, 1120a, 1120b, etc. Each of the second coding units 1110a, 1110b, 1120a, 1120b, etc. may be recursively split in a predetermined order, and this splitting method may correspond to a method of splitting the first coding unit 1100 based on at least one of the block shape information and the information about the split shape mode.

For example, the image decoding apparatus 100 may determine square third coding units 1112a and 1112b by splitting the left second coding unit 1110a in a horizontal direction, and may determine square third coding units 1114a and 1114b by splitting the right second coding unit 1110b in a horizontal direction. Furthermore, the image decoding apparatus 100 may determine square third coding units 1116a, 1116b, 1116c, and 1116d by splitting both of the left and right second coding units 1110a and 1110b in a horizontal direction. In this case, coding units having the same shape as the four square second coding units 1130a, 1130b, 1130c, and 1130d split from the first coding unit 1100 may be determined.

As another example, the image decoding apparatus 100 may determine square third coding units 1122a and 1122b by splitting the upper second coding unit 1120a in a vertical direction, and may determine square third coding units 1124a and 1124b by splitting the lower second coding unit 1120b in a vertical direction. Furthermore, the image decoding apparatus 100 may determine square third coding units 1126a, 1126b, 1126c, and 1126d by splitting both of the upper and lower second coding units 1120a and 1120b in a vertical direction. In this case, coding units having the same shape as the four square second coding units 1130a, 1130b, 1130c, and 1130d split from the first coding unit 1100 may be determined.

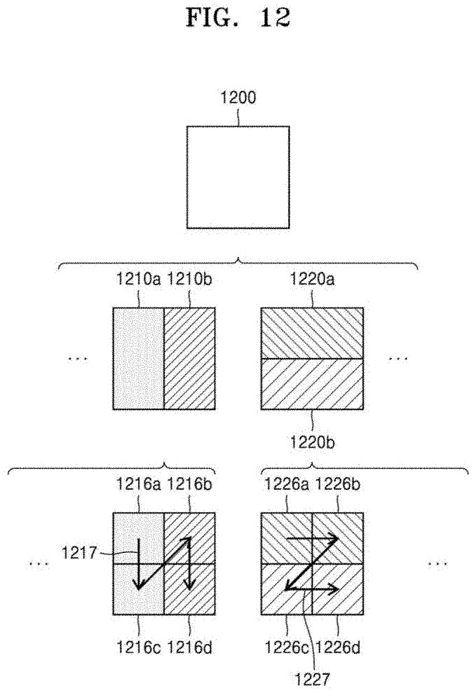

FIG. 12 illustrates that a processing order between a plurality of coding units may be changed depending on a process of splitting a coding unit, according to an embodiment.

According to an embodiment, the image decoding apparatus 100 may split a first coding unit 1200, based on block shape information and information about a split shape mode. When the block shape information indicates a square shape and the information about the split shape mode indicates to split the first coding unit 1200 in at least one of horizontal and vertical directions, the image decoding apparatus 100 may determine second coding units 1210a, 1210b, 1220a, 1220b, etc. by splitting the first coding unit 1200. Referring to FIG. 12, the non-square second coding units 1210a, 1210b, 1220a, and 1220b determined by splitting the first coding unit 1200 in only a horizontal direction or vertical direction may be independently split based on the block shape information and the information about the split shape mode of each coding unit. For example, the image decoding apparatus 100 may determine third coding units 1216a, 1216b, 1216c, and 1216d by splitting the second coding units 1210a and 1210b, which are generated by splitting the first coding unit 1200 in a vertical direction, in a horizontal direction, and may determine third coding units 1226a, 1226b, 1226c, and 1226d by splitting the second coding units 1220a and 1220b, which are generated by splitting the first coding unit 1200 in a horizontal direction, in a horizontal direction. An operation of splitting the second coding units 1210a, 1210b, 1220a, and 1220b has been described above with reference to FIG. 11, and thus detailed descriptions thereof will not be provided here.

According to an embodiment, the image decoding apparatus 100 may process coding units in a predetermined order. An operation of processing coding units in a predetermined order has been described above with reference to FIG. 7, and thus detailed descriptions thereof will not be provided here. Referring to FIG. 12, the image decoding apparatus 100 may determine four square third coding units 1216a, 1216b, 1216c, and 1216d, and 1226a, 1226b, 1226c, and 1226d by splitting the square first coding unit 1200. According to an embodiment, the image decoding apparatus 100 may determine processing orders of the third coding units 1216a, 1216b, 1216c, and 1216d, and 1226a, 1226b, 1226c, and 1226d based on a splitting method of the first coding unit 1200.

According to an embodiment, the image decoding apparatus 100 may determine the third coding units 1216a, 1216b, 1216c, and 1216d by splitting the second coding units 1210a and 1210b generated by splitting the first coding unit 1200 in a vertical direction, in a horizontal direction, and may process the third coding units 1216a, 1216b, 1216c, and 1216d in a processing order 1217 for initially processing the third coding units 1216a and 1216c, which are included in the left second coding unit 1210a, in a vertical direction and then processing the third coding unit 1216b and 1216d, which are included in the right second coding unit 1210b, in a vertical direction.

According to an embodiment, the image decoding apparatus 100 may determine the third coding units 1226a, 1226b, 1226c, and 1226d by splitting the second coding units 1220a and 1220b generated by splitting the first coding unit 1200 in a horizontal direction, in a vertical direction, and may process the third coding units 1226a, 1226b, 1226c, and 1226d in a processing order 1227 for initially processing the third coding units 1226a and 1226b, which are included in the upper second coding unit 1220a, in a horizontal direction and then processing the third coding unit 1226c and 1226d, which are included in the lower second coding unit 1220b, in a horizontal direction.

Referring to FIG. 12, the square third coding units 1216a, 1216b, 1216c, and 1216d, and 1226a, 1226b, 1226c, and 1226d may be determined by splitting the second coding units 1210a, 1210b, 1220a, and 1220b, respectively. Although the second coding units 1210a and 1210b are determined by splitting the first coding unit 1200 in a vertical direction differently from the second coding units 1220a and 1220b which are determined by splitting the first coding unit 1200 in a horizontal direction, the third coding units 1216a, 1216b, 1216c, and 1216d, and 1226a, 1226b, 1226c, and 1226d split therefrom eventually show same-shaped coding units split from the first coding unit 1200. As such, by recursively splitting a coding unit in different manners based on at least one of the block shape information and the information about the split shape mode, the image decoding apparatus 100 may process a plurality of coding units in different orders even when the coding units are eventually determined to be the same shape.

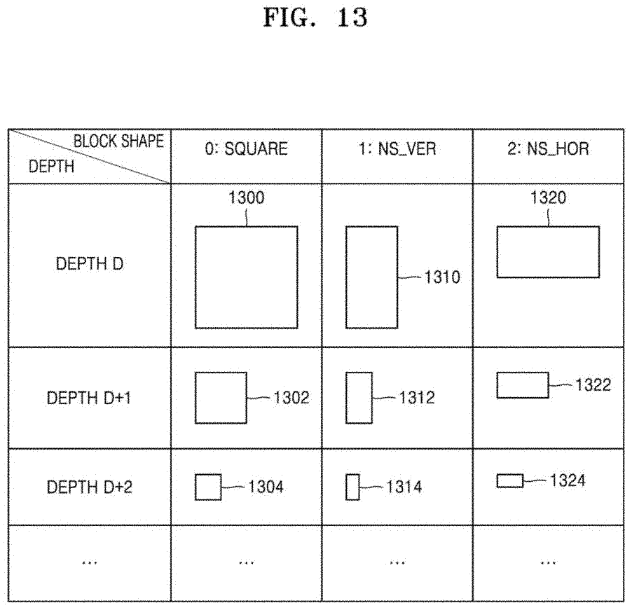

FIG. 13 illustrates a process of determining a depth of a coding unit as a shape and a size of the coding unit change, when the coding unit is recursively split such that a plurality of coding units are determined, according to an embodiment.

According to an embodiment, the image decoding apparatus 100 may determine the depth of the coding unit, based on a predetermined criterion. For example, the predetermined criterion may be the length of a long side of the coding unit. When the length of a long side of a coding unit before being split is 2n times (n>0) the length of a long side of a split current coding unit, the image decoding apparatus 100 may determine that a depth of the current coding unit is increased from a depth of the coding unit before being split, by n. In the following description, a coding unit having an increased depth is expressed as a coding unit of a deeper depth.

Referring to FIG. 13, according to an embodiment, the image decoding apparatus 100 may determine a second coding unit 1302, a third coding unit 1304, etc. of deeper depths by splitting a square first coding unit 1300 based on block shape information indicating a square shape (e.g., the block shape information may be expressed as ‘0: SQUARE’). Assuming that the size of the square first coding unit 1300 is 2N×2N, the second coding unit 1302 determined by dividing a width and height of the first coding unit 1300 to ½ may have a size of N×N. Furthermore, the third coding unit 1304 determined by dividing a width and height of the second coding unit 1302 to ½ may have a size of N/2×N/2. In this case, a width and height of the third coding unit 1304 are ¼ times those of the first coding unit 1300. When a depth of the first coding unit 1300 is D, a depth of the second coding unit 1302, the width and height of which are ½ times those of the first coding unit 1300, may be D+1, and a depth of the third coding unit 1304, the width and height of which are ¼ times those of the first coding unit 1300, may be D+2.

According to an embodiment, the image decoding apparatus 100 may determine a second coding unit 1312 or 1322, a third coding unit 1314 or 1324, etc. of deeper depths by splitting a non-square first coding unit 1310 or 1320 based on block shape information indicating a non-square shape (e.g., the block shape information may be expressed as ‘1: NS VER’ indicating a non-square shape, a height of which is longer than a width, or as ‘2: NS_HOR’ indicating a non-square shape, a width of which is longer than a height).

The image decoding apparatus 100 may determine the second coding unit 1302, 1312, or 1322 by dividing at least one of a width and height of the first coding unit 1310 having a size of N×2N. That is, the image decoding apparatus 100 may determine the second coding unit 1302 having a size of N×N or the second coding unit 1322 having a size of N×N/2 by splitting the first coding unit 1310 in a horizontal direction, or may determine the second coding unit 1312 having a size of N/2×N by splitting the first coding unit 1310 in horizontal and vertical directions.

According to an embodiment, the image decoding apparatus 100 may determine the second coding unit 1302, 1312, or 1322 by dividing at least one of a width and height of the first coding unit 1320 having a size of 2N×N. That is, the image decoding apparatus 100 may determine the second coding unit 1302 having a size of N×N or the second coding unit 1312 having a size of N/2×N by splitting the first coding unit 1320 in a vertical direction, or may determine the second coding unit 1322 having a size of N×N/2 by splitting the first coding unit 1320 in horizontal and vertical directions.

According to an embodiment, the image decoding apparatus 100 may determine the third coding unit 1304, 1314, or 1324 by dividing at least one of a width and height of the second coding unit 1302 having a size of N×N. That is, the image decoding apparatus 100 may determine the third coding unit 1304 having a size of N/2×N/2, the third coding unit 1314 having a size of N/4×N/2, or the third coding unit 1324 having a size of N/2×N/4 by splitting the second coding unit 1302 in vertical and horizontal directions.

According to an embodiment, the image decoding apparatus 100 may determine the third coding unit 1304, 1314, or 1324 by dividing at least one of a width and height of the second coding unit 1312 having a size of N/2×N. That is, the image decoding apparatus 100 may determine the third coding unit 1304 having a size of N/2×N/2 or the third coding unit 1324 having a size of N/2×N/4 by splitting the second coding unit 1312 in a horizontal direction, or may determine the third coding unit 1314 having a size of N/4×N/2 by splitting the second coding unit 1312 in vertical and horizontal directions.

According to an embodiment, the image decoding apparatus 100 may determine the third coding unit 1304, 1314, or 1324 by dividing at least one of a width and height of the second coding unit 1322 having a size of N×N/2. That is, the image decoding apparatus 100 may determine the third coding unit 1304 having a size of N/2×N/2 or the third coding unit 1314 having a size of N/4×N/2 by splitting the second coding unit 1322 in a vertical direction, or may determine the third coding unit 1324 having a size of N/2×N/4 by splitting the second coding unit 1322 in vertical and horizontal directions.

According to an embodiment, the image decoding apparatus 100 may split the square coding unit 1300, 1302, or 1304 in a horizontal or vertical direction. For example, the image decoding apparatus 100 may determine the first coding unit 1310 having a size of N×2N by splitting the first coding unit 1300 having a size of 2N×2N in a vertical direction, or may determine the first coding unit 1320 having a size of 2N×N by splitting the first coding unit 1300 in a horizontal direction. According to an embodiment, when a depth is determined based on the length of the longest side of a coding unit, a depth of a coding unit determined by splitting the first coding unit 1300 having a size of 2N×2N in a horizontal or vertical direction may be the same as the depth of the first coding unit 1300.

According to an embodiment, a width and height of the third coding unit 1314 or 1324 may be ¼ times those of the first coding unit 1310 or 1320. When a depth of the first coding unit 1310 or 1320 is D, a depth of the second coding unit 1312 or 1322, the width and height of which are ½ times those of the first coding unit 1310 or 1320, may be D+1, and a depth of the third coding unit 1314 or 1324, the width and height of which are ¼ times those of the first coding unit 1310 or 1320, may be D+2.

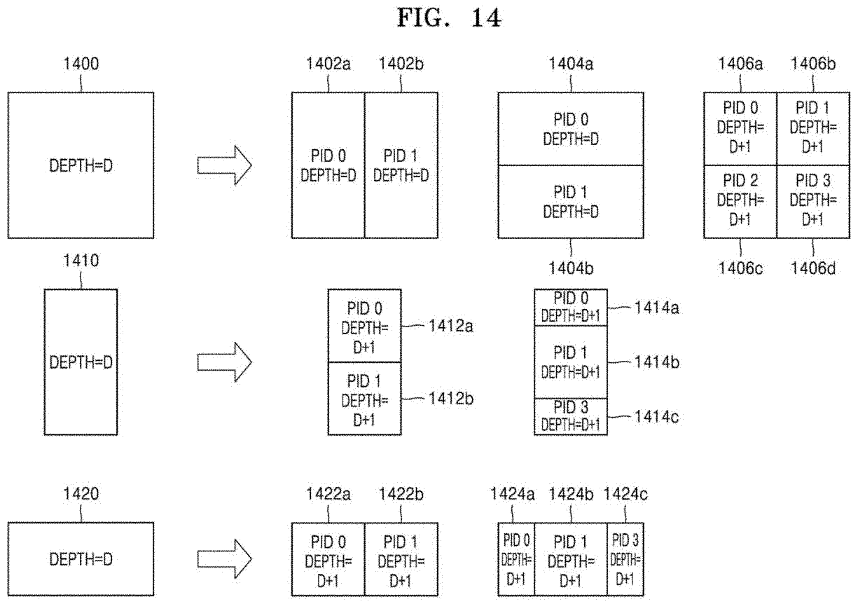

FIG. 14 illustrates depths that are determinable based on shapes and sizes of coding units, and part indexes (PIDs) that are for distinguishing the coding units, according to an embodiment.

According to an embodiment, the image decoding apparatus 100 may determine various-shaped second coding units by splitting a square first coding unit 1400. Referring to FIG. 14, the image decoding apparatus 100 may determine second coding units 1402a and 1402b, 1404a and 1404b, and 1406a, 1406b, 1406c, and 1406d by splitting the first coding unit 1400 in at least one of vertical and horizontal directions based on information about a split shape mode. That is, the image decoding apparatus 100 may determine the second coding units 1402a and 1402b, 1404a and 1404b, and 1406a, 1406b, 1406c, and 1406d, based on the information about the split shape mode of the first coding unit 1400.

According to an embodiment, a depth of the second coding units 1402a and 1402b, 1404a and 1404b, and 1406a, 1406b, 1406c, and 1406d, which are determined based on the information about the split shape mode of the square first coding unit 1400, may be determined based on the length of a long side thereof. For example, because the length of a side of the square first coding unit 1400 equals the length of a long side of the non-square second coding units 1402a and 1402b, and 1404a and 1404b, the first coding unit 1400 and the non-square second coding units 1402a and 1402b, and 1404a and 1404b may have the same depth, e.g., D. However, when the image decoding apparatus 100 splits the first coding unit 1400 into the four square second coding units 1406a, 1406b, 1406c, and 1406d based on the information about the split shape mode, because the length of a side of the square second coding units 1406a, 1406b, 1406c, and 1406d is ½ times the length of a side of the first coding unit 1400, a depth of the second coding units 1406a, 1406b, 1406c, and 1406d may be D+1 which is deeper than the depth D of the first coding unit 1400 by 1.

According to an embodiment, the image decoding apparatus 100 may determine a plurality of second coding units 1412a and 1412b, and 1414a, 1414b, and 1414c by splitting a first coding unit 1410, a height of which is longer than a width, in a horizontal direction based on the information about the split shape mode. According to an embodiment, the image decoding apparatus 100 may determine a plurality of second coding units 1422a and 1422b, and 1424a, 1424b, and 1424c by splitting a first coding unit 1420, a width of which is longer than a height, in a vertical direction based on the information about the split shape mode.

According to an embodiment, a depth of the second coding units 1412a and 1412b, 1414a, 1414b, and 1414c, 1422a and 1422b, and 1424a, 1424b, and 1424c, which are determined based on the information about the split shape mode of the non-square first coding unit 1410 or 1420, may be determined based on the length of a long side thereof. For example, because the length of a side of the square second coding units 1412a and 1412b is ½ times the length of a long side of the first coding unit 1410 having a non-square shape, a height of which is longer than a width, a depth of the square second coding units 1412a and 1412b is D+1 which is deeper than the depth D of the non-square first coding unit 1410 by 1.

Furthermore, the image decoding apparatus 100 may split the non-square first coding unit 1410 into an odd number of second coding units 1414a, 1414b, and 1414c based on the information about the split shape mode. The odd number of second coding units 1414a, 1414b, and 1414c may include the non-square second coding units 1414a and 1414c and the square second coding unit 1414b. In this case, because the length of a long side of the non-square second coding units 1414a and 1414c and the length of a side of the square second coding unit 1414b are ½ times the length of a long side of the first coding unit 1410, a depth of the second coding units 1414a, 1414b, and 1414c may be D+1 which is deeper than the depth D of the non-square first coding unit 1410 by 1. The image decoding apparatus 100 may determine depths of coding units split from the first coding unit 1420 having a non-square shape, a width of which is longer than a height, by using the above-described method of determining depths of coding units split from the first coding unit 1410.

According to an embodiment, the image decoding apparatus 100 may determine PIDs for identifying split coding units, based on a size ratio between the coding units when an odd number of split coding units do not have equal sizes. Referring to FIG. 14, the coding unit 1414b of a center location among the odd number of split coding units 1414a, 1414b, and 1414c may have a width equal to that of the other coding units 1414a and 1414c and a height which is two times that of the other coding units 1414a and 1414c. That is, in this case, the coding unit 1414b at the center location may include two of the other coding unit 1414a or 1414c. Therefore, when a PID of the coding unit 1414b at the center location is 1 based on a scan order, a PID of the coding unit 1414c located next to the coding unit 1414b may be increased by 2 and thus may be 3. That is, discontinuity in PID values may be present. According to an embodiment, the image decoding apparatus 100 may determine whether an odd number of split coding units do not have equal sizes, based on whether discontinuity is present in PIDs for identifying the split coding units.

According to an embodiment, the image decoding apparatus 100 may determine whether to use a specific splitting method, based on PID values for identifying a plurality of coding units determined by splitting a current coding unit. Referring to FIG. 14, the image decoding apparatus 100 may determine an even number of coding units 1412a and 1412b or an odd number of coding units 1414a, 1414b, and 1414c by splitting the first coding unit 1410 having a rectangular shape, a height of which is longer than a width. The image decoding apparatus 100 may use PIDs to identify respective coding units. According to an embodiment, the PID may be obtained from a sample of a predetermined location (e.g., a top left sample) of each coding unit.

According to an embodiment, the image decoding apparatus 100 may determine a coding unit at a predetermined location from among the split coding units, by using the PIDs for distinguishing the coding units. According to an embodiment, when the information about the split shape mode of the first coding unit 1410 having a rectangular shape, a height of which is longer than a width, indicates to split a coding unit into three coding units, the image decoding apparatus 100 may split the first coding unit 1410 into three coding units 1414a, 1414b, and 1414c. The image decoding apparatus 100 may assign a PID to each of the three coding units 1414a, 1414b, and 1414c. The image decoding apparatus 100 may compare PIDs of an odd number of split coding units to determine a coding unit at a center location from among the coding units. The image decoding apparatus 100 may determine the coding unit 1414b having a PID corresponding to a middle value among the PIDs of the coding units, as the coding unit at the center location from among the coding units determined by splitting the first coding unit 1410. According to an embodiment, the image decoding apparatus 100 may determine PIDs for distinguishing split coding units, based on a size ratio between the coding units when the split coding units do not have equal sizes. Referring to FIG. 14, the coding unit 1414b generated by splitting the first coding unit 1410 may have a width equal to that of the other coding units 1414a and 1414c and a height which is two times that of the other coding units 1414a and 1414c. In this case, when the PID of the coding unit 1414b at the center location is 1, the PID of the coding unit 1414c located next to the coding unit 1414b may be increased by 2 and thus may be 3. When the PID is not uniformly increased as described above, the image decoding apparatus 100 may determine that a coding unit is split into a plurality of coding units including a coding unit having a size different from that of the other coding units. According to an embodiment, when the information about the split shape mode indicates to split a coding unit into an odd number of coding units, the image decoding apparatus 100 may split a current coding unit in such a manner that a coding unit of a predetermined location (e.g., a coding unit of a center location) among an odd number of coding units has a size different from that of the other coding units. In this case, the image decoding apparatus 100 may determine the coding unit of the center location, which has a different size, by using PIDs of the coding units. However, the PID and the size or location of the coding unit of the predetermined location to be determined are not limited to the above-described examples, and various PIDs and various locations and sizes of coding units may be used.

According to an embodiment, the image decoding apparatus 100 may use a predetermined data unit where a coding unit starts to be recursively split.

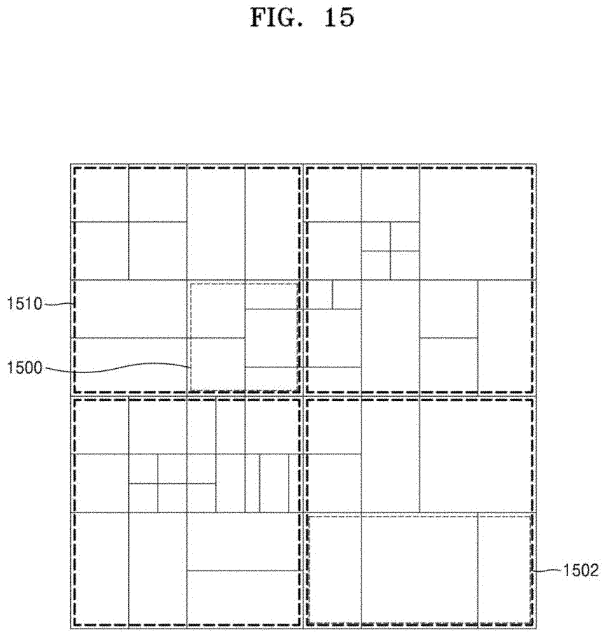

FIG. 15 illustrates that a plurality of coding units are determined based on a plurality of predetermined data units included in a picture, according to an embodiment.

According to an embodiment, a predetermined data unit may be defined as a data unit where a coding unit starts to be recursively split by using at least one of block shape information and information about a split shape mode. That is, the predetermined data unit may correspond to a coding unit of an uppermost depth, which is used to determine a plurality of coding units split from a current picture. In the following descriptions, for convenience of explanation, the predetermined data unit is referred to as a reference data unit.

According to an embodiment, the reference data unit may have a predetermined size and a predetermined shape. According to an embodiment, a reference coding unit may include M×N samples. Herein, M and N may be equal to each other, and may be integers expressed as powers of 2. That is, the reference data unit may have a square or non-square shape, and may be split into an integer number of coding units.

According to an embodiment, the image decoding apparatus 100 may split the current picture into a plurality of reference data units. According to an embodiment, the image decoding apparatus 100 may split the plurality of reference data units, which are split from the current picture, by using information about a split shape mode for each reference data unit. The operation of splitting the reference data unit may correspond to a splitting operation using a quadtree structure.

According to an embodiment, the image decoding apparatus 100 may previously determine the minimum size allowed for the reference data units included in the current picture. Accordingly, the image decoding apparatus 100 may determine various reference data units having sizes equal to or greater than the minimum size, and may determine one or more coding units by using the block shape information and the information about the split shape mode with reference to the determined reference data unit.

Referring to FIG. 15, the image decoding apparatus 100 may use a square reference coding unit 1500 or a non-square reference coding unit 1502. According to an embodiment, the shape and size of reference coding units may be determined based on various data units capable of including one or more reference coding units (e.g., sequences, pictures, slices, slice segments, largest coding units, or the like).

According to an embodiment, the receiver of the image decoding apparatus 100 may obtain, from a bitstream, at least one of reference coding unit shape information and reference coding unit size information with respect to each of the various data units. An operation of determining one or more coding units included in the square reference coding unit 1500 has been described above in relation to the operation of splitting the current coding unit 300 of FIG. 3, and an operation of determining one or more coding units included in the non-square reference coding unit 1502 has been described above in relation to the operation of splitting the current coding unit 400 or 450 of FIG. 4, and thus, detailed descriptions thereof will not be provided here.

According to an embodiment, the image decoding apparatus 100 may use a PID for identifying the size and shape of reference coding units, to determine the size and shape of reference coding units according to some data units previously determined based on a predetermined condition. That is, the receiver 110 may obtain, from the bitstream, only the PID for identifying the size and shape of reference coding units with respect to each slice, slice segment, or largest coding unit which is a data unit satisfying a predetermined condition (e.g., a data unit having a size equal to or smaller than a slice) among the various data units (e.g., sequences, pictures, slices, slice segments, largest coding units, or the like). The image decoding apparatus 100 may determine the size and shape of reference data units with respect to each data unit, which satisfies the predetermined condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding apparatus 100 may determine at least one of the size and shape of reference coding units included in a data unit serving as a unit for obtaining the PID, by selecting the previously determined at least one of the size and shape of reference coding units based on the PID.

According to an embodiment, the image decoding apparatus 100 may use one or more reference coding units included in a largest coding unit. That is, a largest coding unit split from an image may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quadtree structure. That is, the image decoding apparatus 100 may determine the reference coding units by splitting the largest coding unit n times based on a quadtree structure, and may split the reference coding unit based on at least one of the block shape information and the information about the split shape mode according to various embodiments.

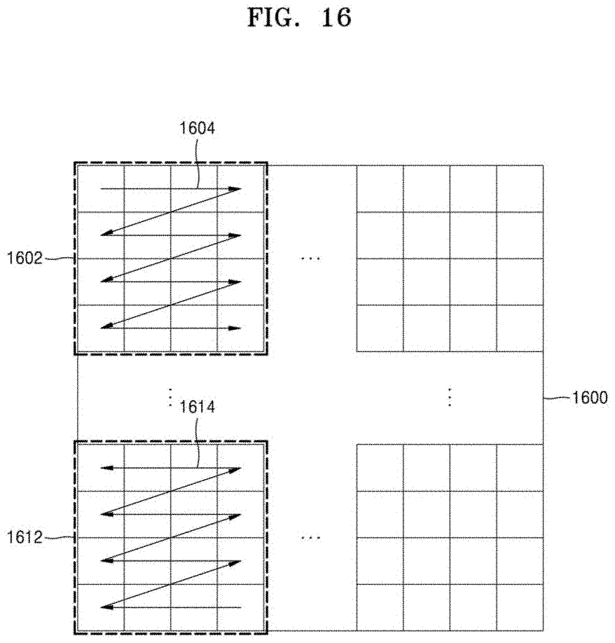

FIG. 16 illustrates a processing block serving as a unit for determining a determination order of reference coding units included in a picture 1600, according to an embodiment.

According to an embodiment, the image decoding apparatus 100 may determine one or more processing blocks split from a picture. The processing block is a data unit including one or more reference coding units split from an image, and the one or more reference coding units included in the processing block may be determined according to a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan, Z-scan, N-scan, up-right diagonal scan, horizontal scan, and vertical scan, but is not limited to the above-mentioned scan orders.

According to an embodiment, the image decoding apparatus 100 may obtain processing block size information and may determine the size of one or more processing blocks included in the image. The image decoding apparatus 100 may obtain the processing block size information from a bitstream and may determine the size of one or more processing blocks included in the image. The size of processing blocks may be a predetermined size of data units, which is indicated by the processing block size information.

According to an embodiment, the receiver 110 of the image decoding apparatus 100 may obtain the processing block size information from the bitstream according to each specific data unit. For example, the processing block size information may be obtained from the bitstream in a data unit such as an image, sequence, picture, slice, or slice segment. That is, the receiver 110 may obtain the processing block size information from the bitstream according to each of the various data units, the image decoding apparatus 100 may determine the size of one or more processing blocks, which are split from the picture, by using the obtained processing block size information, and the size of the processing blocks may be integer times that of the reference coding units.

According to an embodiment, the image decoding apparatus 100 may determine the size of processing blocks 1602 and 1612 included in the picture 1600. For example, the image decoding apparatus 100 may determine the size of processing blocks based on the processing block size information obtained from the bitstream. Referring to FIG. 16, according to an embodiment, the image decoding apparatus 100 may determine a width of the processing blocks 1602 and 1612 to be four times the width of the reference coding units, and may determine a height of the processing blocks 1602 and 1612 to be four times the height of the reference coding units. The image decoding apparatus 100 may determine a determination order of one or more reference coding units in one or more processing blocks.

According to an embodiment, the image decoding apparatus 100 may determine the processing blocks 1602 and 1612, which are included in the picture 1600, based on the size of processing blocks, and may determine a determination order of one or more reference coding units included in the processing blocks 1602 and 1612. According to an embodiment, determination of reference coding units may include determination of the size of the reference coding units.

According to an embodiment, the image decoding apparatus 100 may obtain, from the bitstream, determination order information of one or more reference coding units included in one or more processing blocks, and may determine a determination order with respect to one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding apparatus 100 may obtain, from the bitstream, the determination order information of reference coding units according to each specific data unit. For example, the receiver may obtain the determination order information of reference coding units from the bitstream according to each data unit such as an image, sequence, picture, slice, slice segment, or processing block. Because the determination order information of reference coding units indicates an order for determining reference coding units in a processing block, the determination order information may be obtained with respect to each specific data unit including an integer number of processing blocks.

According to an embodiment, the image decoding apparatus 100 may determine one or more reference coding units based on the determined determination order.

According to an embodiment, the receiver may obtain the determination order information of reference coding units from the bitstream as information related to the processing blocks 1602 and 1612, and the image decoding apparatus 100 may determine a determination order of one or more reference coding units included in the processing blocks 1602 and 1612 and determine one or more reference coding units, which are included in the picture 1600, based on the determination order. Referring to FIG. 16, the image decoding apparatus 100 may determine determination orders 1604 and 1614 of one or more reference coding units in the processing blocks 1602 and 1612, respectively. For example, when the determination order information of reference coding units is obtained with respect to each processing block, different kinds of the determination order information of reference coding units may be obtained for the processing blocks 1602 and 1612. When the determination order 1604 of reference coding units in the processing block 1602 is a raster scan order, reference coding units included in the processing block 1602 may be determined according to the raster scan order. On the contrary, when the determination order 1614 of reference coding units in the other processing block 1612 is a backward raster scan order, reference coding units included in the processing block 1612 may be determined according to the backward raster scan order.

According to an embodiment, the image decoding apparatus 100 may decode the determined one or more reference coding units. The image decoding apparatus 100 may decode an image, based on the reference coding units determined as described above. A method of decoding the reference coding units may include various image decoding methods.

According to an embodiment, the image decoding apparatus 100 may obtain block shape information indicating the shape of a current coding unit or information about a split shape mode indicating a splitting method of the current coding unit, from the bitstream, and may use the obtained information. The block shape information or the information about the split shape mode may be included in the bitstream related to various data units. For example, the image decoding apparatus 100 may use the block shape information of the information about the split shape mode included in a sequence parameter set, a picture parameter set, a video parameter set, a slice header, or a slice segment header. Furthermore, the image decoding apparatus 100 may obtain, from the bitstream, a syntax element corresponding to the block shape information or the information about the split shape mode according to each largest coding unit, each reference coding unit, or each processing block, and may use the obtained syntax element.

A method of determining a splitting rule according to an embodiment of the present disclosure will be described in detail.

The image decoding apparatus 100 may determine a splitting rule of an image. The splitting rule may be previously determined between the image decoding apparatus 100 and the image encoding apparatus 150. The image decoding apparatus 100 may determine the splitting rule of the image based on information obtained from a bitstream. The image decoding apparatus 100 may determine the splitting rule based on information obtained from at least one of a sequence parameter set, a picture parameter set, a video parameter set, a slice header, and a slice segment header. The image decoding apparatus 100 may differently determine the splitting rule according to a frame, a slice, a temporal layer, a largest coding unit, or a coding unit.

The image decoding apparatus 100 may determine the splitting rule based on block shape information of a coding unit. The image decoding apparatus 100 may determine block shape information of a coding unit. The block shape information may include information about a size, a shape, a ratio between a width and a height, and a direction of the coding unit. The image encoding apparatus 150 and the image decoding apparatus 100 may previously determine to determine the splitting rule based on the block shape information of the coding unit. However, the present disclosure is not limited thereto. The image decoding apparatus 100 may determine the splitting rule, based on the information obtained from the bitstream received from the image encoding apparatus 150.

The shape of the coding unit may include a square shape and a non-square shape. When the width and the height of the coding unit are the same, the image decoding apparatus 100 may determine that the shape of the coding unit is a square shape. Also, when the width and the height of the coding unit are not the same, the image decoding apparatus 100 may determine that the shape of the coding unit is a non-square shape.

The size of the coding unit may include various sizes such as 4×4, 8×4, 4×8, 8×8, 16×4, 16×8, . . . , and 256×256. The size of the coding unit may be classified according to the length of a long side, the length of a short side, or the area of the coding unit. The image decoding apparatus 100 may apply the same splitting rule to coding units belonging to the same group. For example, the image decoding apparatus 100 may classify coding units whose long sides have the same length as coding units having the same size. Also, the image decoding apparatus 100 may apply the same splitting rule to coding units whose long sides have the same length.

The ratio between the width and the height of the coding unit may include 1:2, 2:1, 1:4, 4:1, 1:8, 8:1, 1:16, or 16:1. Also, the direction of the coding unit may include a horizontal direction and a vertical direction. The horizontal direction may indicate a case where the length of the width of the coding unit is greater than the length of the height of the coding unit. The vertical direction may indicate a case where the length of the width of the coding unit is less than the length of the height of the coding unit.

The image decoding apparatus 100 may adaptively determine the splitting rule based on the size of the coding unit. The image decoding apparatus 100 may differently determine an allowable split shape mode based on the size of the coding unit. For example, the image decoding apparatus 100 may determine whether splitting is allowed based on the size of the coding unit. The image decoding apparatus 100 may determine a split direction according to the size of the coding unit. The image decoding apparatus 100 may determine an allowable split type according to the size of the coding unit.

Determining the splitting rule based on the size of the coding unit may be the splitting rule that is previously determined between the image encoding apparatus 150 and the image decoding apparatus 100. Also, the image decoding apparatus 100 may determine the splitting rule, based on the information obtained from the bitstream.

The image decoding apparatus 100 may adaptively determine the splitting rule based on a location of the coding unit. The image decoding apparatus 100 may adaptively determine the splitting rule based on the location of the coding unit in the image.

Also, the image decoding apparatus 100 may determine the splitting rule so that coding units generated using different split paths do not have the same block shape. However, the present disclosure is not limited thereto, and the coding units generated using different split paths may have the same block shape. The coding units generated using different split paths may have different decoding processing orders. A decoding processing order has been described with reference to FIG. 12, and thus a detailed explanation thereof will not be provided here.

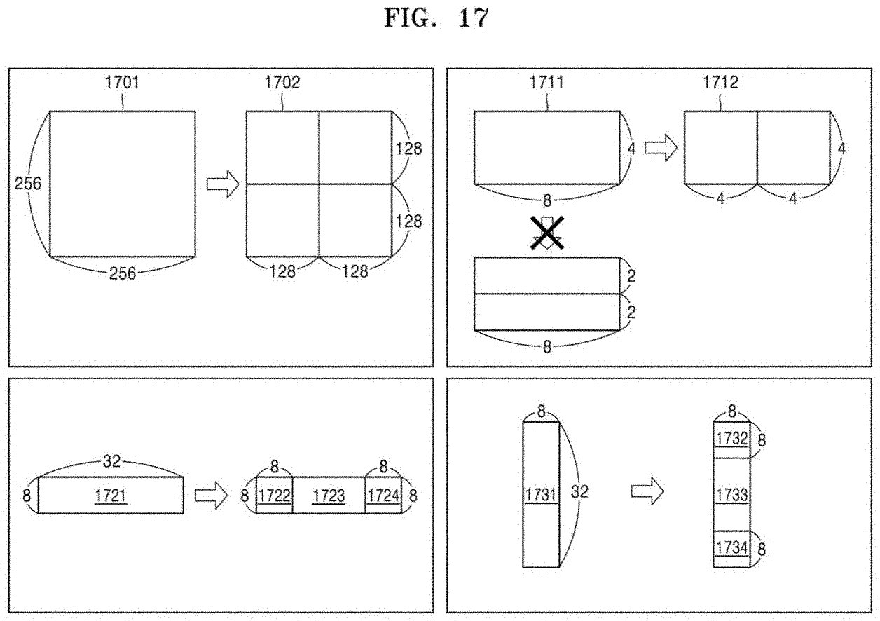

Also, the image decoding apparatus 100 may adaptively determine a splitting rule based on information about a split shape mode of an encoded frame (or slice), and information about a split shape mode of a neighboring block adjacent to a current block. A method of determining a splitting rule, and adaptively inverse-binarizing a bin string for a split shape mode based on the splitting rule or binarizing the split shape mode will be described in detail with reference to FIGS. 17 through 25.

FIG. 17 is a diagram for describing a method of determining a splitting rule according to a size of a coding unit according to an embodiment of the present disclosure.

According to an embodiment of the present disclosure, the image decoding apparatus 100 may allow a size of an allowable coding unit to range from a maximum M×N to a minimum P×Q. The image decoding apparatus 100 and the image encoding apparatus 150 may previously determine a minimum size or a maximum size of a coding unit. M, N, P, and Q may be positive integers. M and N may be the same value or different values. P and Q may be the same value or different values. M×N may include one of 256×256, 128×128 and 64×64. Also, P×Q may include 4×4.

According to an embodiment of the present disclosure, the image decoding apparatus 100 may obtain the maximum size or the minimum size of the coding unit from a bitstream. The image decoding apparatus 100 may obtain from the bitstream the maximum size or the minimum size of the coding unit based on a pre-determined minimum length of at least one side. The image decoding apparatus 100 and the image encoding apparatus 150 may determine that the pre-determined minimum length of the coding unit is K. A new minimum size of the coding unit may be P×Q. A new maximum size of the coding unit may be M×N. In order to determine P, the image decoding apparatus 100 may receive log 2(A) from the bitstream. A value of log 2(A) may be the same as log 2(P)−log 2(K). The image decoding apparatus 100 may obtain P by using Equation 1.

P=2\hat{ }(log 2(A)+log 2(K)) [Equation 1]

The image decoding apparatus 100 may determine Q, M, and N in the same manner.

According to an embodiment of the present disclosure, the image decoding apparatus 100 may obtain the new maximum size M×N of the coding unit based on the new minimum size of the coding unit. For example, when the image decoding apparatus 100 obtains P that is a length of one side of the new minimum size of the coding unit by using Equation 1, the image decoding apparatus 100 may obtain M that is a length of one side of the maximum size of the coding unit by using Equation 2.

M=2\hat{ }(log 2(B)+log 2(P)) [Equation 2]

log 2(B) that is a value obtained by the image decoding apparatus 100 from the bitstream is the same as log 2(M)−log(P). According to an embodiment of the present disclosure, the image decoding apparatus 100 may split a largest coding unit into a coding unit of a first size. The image decoding apparatus 100 may obtain the coding unit of the first size by splitting the largest coding unit. For example, when a current coding unit is the largest coding unit, the image decoding apparatus 100 may obtain the coding unit of the first size by quad splitting the largest coding unit without a bin string corresponding to a split shape mode. In more detail, when a size of a current coding unit 1701 is 256×256 and 256×256 is a maximum size of a coding unit, the image decoding apparatus 100 may quad split the current coding unit 1701 into coding units 1702 having a size of 128×128 without a bin string.

The image decoding apparatus 100 may split the coding unit of the first size into a plurality of coding units based on a splitting rule and a bin string corresponding to the split shape mode. For example, the image decoding apparatus 100 may split the coding units 1702 having a size of 128×128 obtained by quad splitting a coding unit having a size of 256×256 into a plurality of coding units based on the splitting rule and the bin string corresponding to the split shape mode.

Also, according to an embodiment of the present disclosure, when a size of a current coding unit is the same as the minimum size of the coding unit, the image decoding apparatus 100 may no longer split the current coding unit.

Also, according to an embodiment of the present disclosure, the image decoding apparatus 100 may determine a split direction of the coding unit, based on a size of the current coding unit. For example, when a length of a short side of the current coding unit is the same as a minimum length of one side of the coding unit, the image decoding apparatus 100 may split the current coding unit in a direction in which a length of a long side of the current coding unit is split. For example, the minimum length of one side of the coding unit may be 4. The image decoding apparatus 100 may obtain coding units 1712 having a size of 4×4 by binary splitting a coding unit 1711 having a size of 8×4 in a vertical direction. When a coding unit having a size of 8×4 is binary split in a horizontal direction, a length of a height of the coding unit is 2, and thus the image decoding apparatus 100 may not allow horizontal splitting.

Also, according to an embodiment of the present disclosure, when a non-square coding unit is tri-split, the image decoding apparatus 100 may perform tri-splitting only in a direction in which a long side of the coding unit is split. When a square coding unit is tri-split, the image decoding apparatus 100 may perform tri-splitting in one direction of a horizontal direction and a vertical direction. For example, the image decoding apparatus 100 may determine that a coding unit 1721 having a size of 32×8 is to be tri-split. Because the coding unit 1721 having a size of 32×8 is a coding unit whose width is long, the image decoding apparatus 100 may determine that the coding unit 1721 is to be split in a vertical direction. The image decoding apparatus 100 may obtain coding units 1722 and 1724 having a size of 8×8 and a coding unit 1723 having a size of 16×8 by performing tri-splitting in a vertical direction.

Also, the image decoding apparatus 100 may determine that a coding unit having a size of 8×32 is to be tri-split. Because a coding unit 1731 having a size of 8×32 is a coding unit whose height is long, the image decoding apparatus 100 may determine that the coding unit 1731 is to be split in a horizontal direction. The image decoding apparatus 100 may obtain coding units 1732 and 1734 having a size of 8×8 and a coding unit 1733 having a size of 8×16 by performing tri-splitting in a horizontal direction.

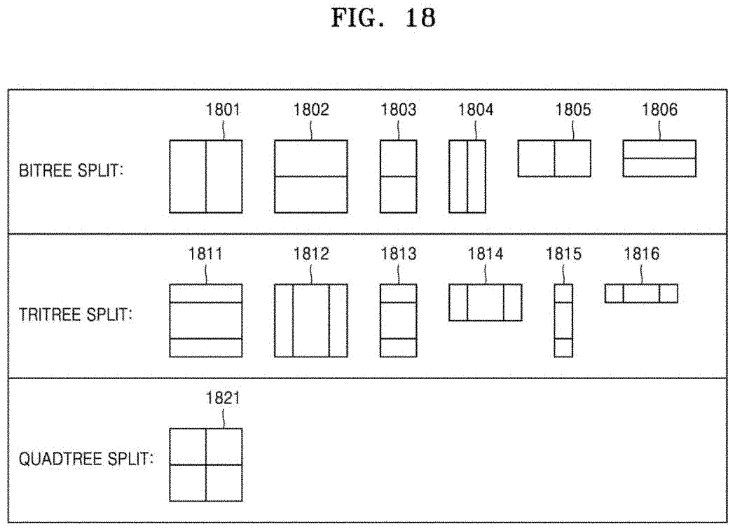

FIG. 18 is a diagram for describing a split shape mode according to an embodiment of the present disclosure.

A coding unit may be hierarchically split into coding units based on information about a split shape mode. The information about the split shape mode may include at least one of information about whether splitting is performed, split direction information, and split type information. A split type may include at least one of binary splitting, tri-splitting, and quad splitting.

The image decoding apparatus 100 may binary split a coding unit. When the coding unit is binary split, it means that one of a width and a height of the coding unit is split to be 1:1. A coding unit 1801 having a width-to-height ratio of 1:1, a coding unit 1804 having a width-to-height ratio of 1:2, a coding unit 1805 having a width-to-height ratio of 2:1, a coding unit having a width-to-height ratio of 1:4, or a coding unit having a width-to-height ratio of 4:1 may be halved in a vertical direction. A coding unit 1802 having a width-to-height ratio of 1:1, a coding unit 1803 having a width-to-height ratio of 1:2, a coding unit 1806 having a width-to-height ratio of 2:1, a coding unit having a width-to-height ratio of 1:4, or a coding unit having a width-to-height ratio of 4:1 may be halved in a horizontal direction.

The image decoding apparatus 100 may tri-split a coding unit. When the coding unit is tri-split, it may mean that a width or a height of the coding unit is split to be 1:2:1. However, the present disclosure is not limited thereto, and when the coding unit is tri-split, it may mean that a width or a height of the coding unit is split to be 1:1:2 or 2:1:1. A coding unit 1811 having a width-to-height ratio of 1:1, a coding unit 1813 having a width-to-height ratio of 1:2, a coding unit 1815 having a width-to-height ratio of 1:4, or a coding unit having a width-to-height ratio of 1:8 may be tri-split in a horizontal direction. Also, a coding unit 1812 having a width-to-height ratio of 1:1, a coding unit 1814 having a width-to-height ratio of 2:1, a coding unit 1816 having a width-to-height ratio of 4:1, or a coding unit having a width-to-height ratio of 8:1 may be tri-split in a vertical direction.

The image decoding apparatus 100 may quad split a coding unit. When the coding unit is quad split, it may mean that a width and a height of the coding unit are halved. At least one of a coding unit 1821 having a width-to-height ratio of 1:1, a coding unit having a width-to-height ratio of 1:2, a coding unit having a width-to-height ratio of 2:1, a coding unit having a width-to-height ratio of 1:4, a coding unit having a width-to-height ratio of 4:1, a coding unit having a width-to-height ratio of 1:8, or a coding unit having a width-to-height ratio of 8:1 may be quad split.

The image decoding apparatus 100 and the image encoding apparatus 150 may determine to use some split types from among a plurality of split types. That is, the image decoding apparatus 100 and the image encoding apparatus 150 may determine an allowable split type to be used for image decoding and image encoding. The allowable split type may be pre-determined between the image decoding apparatus 100 and the image encoding apparatus 150. However, the present disclosure is not limited thereto, and the image decoding apparatus 100 may determine the allowable split type based on information obtained from a bitstream. For example, the image decoding apparatus 100 may use all of binary splitting, tri-splitting, and quad splitting. Also, the image decoding apparatus 100 may use binary splitting or tri-splitting. Also, the image decoding apparatus 100 may use binary splitting or quad splitting.

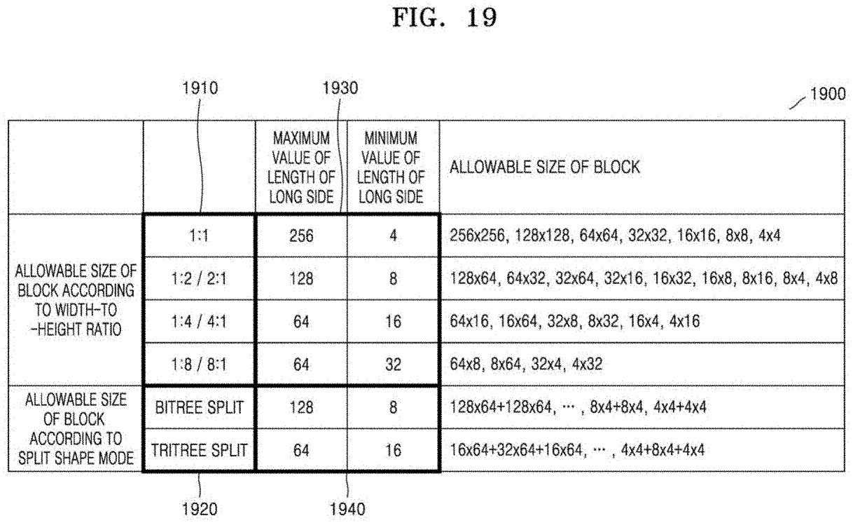

A method for determining a splitting rule will be described in more detail with reference to FIG. 19.

FIG. 19 is a diagram for describing a method of determining a splitting rule according to an embodiment of the present disclosure.

FIG. 19 is a table showing a part of a splitting rule allowed by the image decoding apparatus 100, according to an embodiment of the present disclosure. The image decoding apparatus 100 may determine an allowable width-to-height ratio of a coding unit. The image decoding apparatus 100 and the image encoding apparatus 150 may pre-determine the allowable width-to-height ratio of the coding unit. For example, the image decoding apparatus 100 may obtain the pre-determined allowable width-to-height ratio of the coding unit, without information received from a bitstream. Referring to a cell 1910, the image decoding apparatus 100 may determine ratios of 1:1, 1:2, 2:1, 1:4, 4:1, 1:8, and 8:1 as allowable ratios.

The image decoding apparatus 100 may obtain the allowable width-to-height ratio based on the information obtained from the bitstream. The allowable ratio may be 1:2\hat{ }N or 2\hat{ }N:1. Here, N may be a positive integer including 0. For example, the image decoding apparatus 100 may receive a flag from the bitstream and may determine whether to use each of the ratios of 1:1, 1:2, 2:1, 1:4, 4:1, 1:8, 8:1, 1:16, and 16:1. For example, the image decoding apparatus 100 may determine whether to use the ratio of 1:1 based on a flag indicating whether to use the 1:1 width-to height ratio of the coding unit.

The image decoding apparatus 100 may determine at least one allowable width-to-height ratio based on a received index or bin string. For example, the image decoding apparatus 100 may group width-to-height ratios of coding units. A first group may include the ratio of 1:1. A second group may include the ratios of 1:1, 1:2, and 2:1. A third group may include the ratios of 1:1, 1:2, 2:1, 1:4, and 4:1. When the received index or bin string indicates the third group, the image decoding apparatus 100 may determine the ratios of 1:1, 1:2, 2:1, 1:4, and 4:1 as allowable ratios. Referring to the cell 1910, the image decoding apparatus 100 may determine the ratios of 1:1, 1:2, 2:1, 1:4, 4:1, 1:8, and 8:1 as allowable ratios.

The image decoding apparatus 100 may determine an allowable first range of a length of a long side of the coding unit, according to the width-to-height ratio of the coding unit. The first range may include a maximum value and a minimum value of the length of the long side of the coding unit.

The image decoding apparatus 100 and the image encoding apparatus 150 may pre-determine the allowable first range of the length of the long side of the coding unit, according to the width-to-height ratio of the coding unit. The image decoding apparatus 100 may obtain the allowable first range of the length of the long side of the coding unit, according to the pre-determined width-to-height ratio of the coding unit, without the information received from the bitstream. The allowable first range of the length of the long side of the coding unit according to the width-to-height ratio of the coding unit may be the same as in a cell 1930.

The image decoding apparatus 100 may obtain the allowable first range of the length of the long side of the coding unit, according to the width-to-height ratio of the coding unit based on the information obtained from the bitstream. The image decoding apparatus 100 may determine the allowable first range of the length of the long side of the coding unit according to the width-to-height ratio of the coding unit such as in the cell 1930, based on the information obtained from the bitstream.

The information obtained from the bitstream may have an arrangement format. For example, the image decoding apparatus 100 may receive {{6, 0}, {5, 1}, {4, 2}, {0, 0}}. The image decoding apparatus 100 may obtain the allowable first range of the length of the long side of the coding unit according to the width-to-height ratio as in the cell 1930 based on the received {{6, 0}, {5, 1}, {4, 2}, {0, 0. {6, 0} may indicate a first range of a long side of a coding unit having a ratio of 1:1. {5, 1} may indicate a first range of a long side of a coding unit having a ratio of 1:2 or 2:1. {4, 2} may indicate a first range of a long side of a coding unit having a ratio of 1:4 or 4:1. {0, 0} may indicate a first range of a long side of a coding unit having a ratio of 1:8 or 8:1.

The image decoding apparatus 100 may obtain the allowable first range of the length of the long side from the arrangement based on Equation 1. For example, {6, 0} may indicate the first range of the long side of the coding unit having the ratio of 1:1. Here, ‘6’ may be information about a maximum value of the long side of the coding unit having the ratio of 1:1. Also, ‘0’ may be information about a minimum value of the long side of the coding unit having the ratio of 1:1. The image decoding apparatus 100 may calculate 2\hat{ }(6+log 2(4)) based on Equation 1, and may determine 256 as a maximum value of the long side of the coding unit. A pre-determined minimum size K of the coding unit may be 4. Also, the image decoding apparatus 100 may calculate 2\hat{ }(0+log 2(4)) based on Equation 1, and may determine 4 as a minimum value of the long side of the coding unit.

The image decoding apparatus 100 may determine the allowable width-to-height ratio of the coding unit based on at least one of Equation 1, the maximum length of the long side of the coding unit, and the minimum length of the long side of a coding unit. The image decoding apparatus 100 may obtain a first range of the length of the long side based on the information obtained from the bitstream. The first range of the length of the long side of the coding unit may include the maximum length of the long side of the coding unit or the minimum length of the long side of the coding unit. The image decoding apparatus 100 may obtain a range of a length of a short side based on the width-to-height ratio and the range of the length of the long side. When a maximum value or a minimum value of the length of the short side is less than the pre-determined minimum size K of the coding unit, the image decoding apparatus 100 may determine that the width-to-height ratio is not allowed. For example, when {0, 0} indicates a ratio of a long side of a coding unit having a ratio of 1:8 or 8:1, the image decoding apparatus 100 may calculate 2\hat{ }(0+log 2(4)) based on Equation 1, and may determine 4 as a maximum value of a long side of the coding unit. However, when a length of a long side of a coding unit having a ratio of 1:8 or 8:1 is 4, a length of a short side has to be 0.5. Because 0.5 is less than 4 that is the pre-determined minimum size of the coding unit, the image decoding apparatus 100 may determine that a ratio of 1:8 or 8:1 is not allowed.

The image decoding apparatus 100 may determine whether information about a predetermined split shape mode is allowed based on a splitting rule. For example, the image decoding apparatus 100 may determine whether a first coding unit is splittable based on information about a first split shape mode. When the image decoding apparatus 100 splits the first coding unit according to the information about the first split shape mode, a second coding unit may be obtained. When the second coding unit does not satisfy at least one of ‘an allowable width-to-height ratio of a coding unit’ and ‘an allowable range of a length of a long side of a coding unit according to a ratio’, the image decoding apparatus 100 may not allow the first split shape mode. In contrast, when the second coding unit satisfies ‘the allowable width-to-height ratio of the coding unit’ and ‘the allowable range of the length of the long side of the coding unit according to the ratio’, the image decoding apparatus 100 may allow the first split shape mode.

The image decoding apparatus 100 may determine an allowable split shape mode of a coding unit. The image decoding apparatus 100 and the image encoding apparatus 150 may pre-determine the allowing split shape mode of the coding unit. The image decoding apparatus 100 may obtain the pre-determined allowable split shape mode of the coding unit, without information received from a bitstream. Referring to a cell 1920, the image decoding apparatus 100 may determine binary splitting and tri-splitting as allowable split shape modes. However, the present disclosure is not limited thereto, and the image decoding apparatus 100 may determine quad splitting as an allowable split shape mode.

The image decoding apparatus 100 may obtain the allowable split shape mode of the coding unit from the bitstream. The image decoding apparatus 100 may determine whether to use each split shape mode by receiving a flag from the bitstream. Also, the image decoding apparatus 100 may determine the allowable split shape mode by receiving an index or a bin string. For example, referring to the cell 1920, the image decoding apparatus 100 may allow binary splitting and tri-splitting. However, the present disclosure is not limited thereto, and the image decoding apparatus 100 may determine quad splitting as an allowable split shape mode.

The image decoding apparatus 100 may determine an allowable second range of the length of the long side of the coding unit, according to the split shape mode of the coding unit. The image decoding apparatus 100 and the image encoding apparatus 150 may pre-determine the allowable second range of the length of the long side of the coding unit. The image decoding apparatus 100 may obtain the allowable second range of the length of the long side of the coding unit, according to the pre-determined split shape mode of the coding unit, without the information received from the bitstream. The allowable second range of the length of the long side of the coding unit according to the split shape mode of the coding unit may be the same as in a cell 1940.

The image decoding apparatus 100 may obtain the allowable second range of the length of the long side of the coding unit, according to the split shape mode of the coding unit based on the information obtained from the bitstream. The information obtained from the bitstream may have an arrangement format. For example, the image decoding apparatus 100 may receive {{5, 1}, {4, 2}}. The image decoding apparatus may obtain the allowable second range of the length of the long side of the coding unit, according to the split shape mode as in the cell 1940, based on the received {{5, 1}, {4, 2}}. {5, 1} may indicate a second range of a long side of a coding unit that is binary splittable. {4, 2} may indicate a second range of a coding unit that is tri-splittable.

The image decoding apparatus 100 may obtain the allowable second range of the length of the long side from the arrangement based on Equation 1. For example, {5, 1} may indicate the second range of the long side of the coding unit that is binary splittable. Here, ‘5’ may be information about a maximum value of the long side of the coding unit that is binary splittable. Also, ‘1’ may be information about a minimum value of the long side of the coding unit that is binary splittable. The image decoding apparatus 100 may calculate 2\hat{ }(5+log 2(4)) based on Equation 1, and may determine 128 as a maximum value of the long side of the coding unit. The pre-determined minimum size K of the coding unit may be 4. Also, the image decoding apparatus 100 may calculate 2\hat{ }(1+log 2(4)) based on Equation 1, and may determine 8 as a minimum value of the long side of the coding unit.

The image decoding apparatus 100 may change at least one of a splitting rule based on the information obtained from the bitstream. The image decoding apparatus 100 may determine that the splitting rule is entirely changed, the splitting rule is partially changed, or the splitting rule is not changed based on the information obtained from the bitstream. When the bitstream indicates that the splitting rule is partially changed, the image decoding apparatus 100 may obtain information about a ‘splitting rule to be changed’ and ‘content of the splitting rule’ based on the information obtained from the bitstream. For example, the ‘splitting rule to be changed’ may be a maximum value of a length of a long side of a coding unit that is binary splittable. Also, the ‘content of the splitting rule’ may be ‘4’. The image decoding apparatus 100 may determine that the maximum value of the length of the long side of the coding unit that is binary splittable is 64 based on Equation 1.

The image decoding apparatus 100 may determine whether to allow information about a predetermined split shape mode based on the splitting rule. For example, the image decoding apparatus 100 may determine that a length of a long side of a current coding unit does not satisfy an allowable range of a length of a long side of a coding unit according to a first split shape mode. The image decoding apparatus 100 may determine that information about the first split shape mode is not allowed for the current coding unit. In contrast, the image decoding apparatus 100 may determine that the length of the long side of the current coding unit satisfies the allowable range of the length of the long side of the coding unit according the first split shape mode. The image decoding apparatus 100 may determine that information about the first split shape mode is allowed for the current coding unit.

Various embodiments of a splitting rule will now be described with reference to FIG. 19.

According to an embodiment of the present disclosure, when a size of a coding unit is less than a predetermined size, the image decoding apparatus 100 may not allow tri-splitting. For example, referring to a cell 1940, when a length of a long side of a current coding unit is less than 16, the image decoding apparatus 100 may not allow tri-splitting for the current coding unit.

Also, according to an embodiment of the present disclosure, the image decoding apparatus 100 may determine a splitting rule so that a coding unit having a long side whose length ranges from maximum M to a minimum N is binary splittable. M and N are positive integers. For example, the image decoding apparatus 100 may determine that a maximum length of a long side that is binary splittable is 128. Also, the image decoding apparatus 100 may determine that a minimum length of the long side that is binary splittable is 8. That is, the image decoding apparatus 100 may allow binary splitting for blocks having sizes of 128×128, 128×64, 64×128, . . . 64×64, 64×32, 32×64, 8×4, and 4×8.

Also, according to an embodiment of the present disclosure, the image decoding apparatus 100 may determine a splitting rule so that a coding unit having a long side whose length ranges from maximum 128 to minimum 8 is binary splittable. Also, the image decoding apparatus 100 may determine a splitting rule so that coding units having ratios of 1:1, 1:2, and 2:1 are splittable. In this case, the image decoding apparatus 100 may allow binary splitting for coding units having sizes of 128×128 128×64, 64×128, 64×64, 64×32, 32×64, 32×32, . . . , 16×8, 8×16, and 8×8.

Also, according to an embodiment of the present disclosure, the image decoding apparatus 100 may determine a splitting rule so that a coding unit having a long side whose length ranges from maximum 128 to minimum 8 is binary splittable. Also, the image decoding apparatus 100 may determine a splitting rule so that coding units having sizes of 1:1, 1:2, 2:1, 1:4, and 4:1 are splittable. In this case, the image decoding apparatus 100 may allow binary splitting for coding units having sizes of 128×128, 128×64, 128×32, 32×128, 64×128, . . . , 16×16, 16×4, 4×16, and 8×8.

Also, according to an embodiment of the present disclosure, the image decoding apparatus 100 may determine a splitting rule so that tri-splitting may be used only when a length of a long side of a coding unit is less than M. M is a positive integer. For example, the image decoding apparatus 100 may determine that tri-splitting is used only when a length of a long side of a coding unit is less than 32.

Also, according to an embodiment of the present disclosure, the image decoding apparatus 100 may determine a splitting rule so that tri-splitting is used only when a length of a long side of a coding unit is equal to or less than M and equal to or greater than N. Here, M and N are positive integers. For example, referring to the cell 1940, the image decoding apparatus 100 may determine that tri-splitting is used only when a length of a long side of a coding unit is less than 64 and greater than 16.

Also, according to an embodiment of the present disclosure, the image decoding apparatus 100 may determine a splitting rule so that only when a length of one side of a current coding unit is equal to or less than M and equal to or greater than N, the current coding unit is splittable into a coding unit having a ratio of 1:4 or 4:1. M and N are positive integers.

Also, according to an embodiment of the present disclosure, the image decoding apparatus 100 may determine a splitting rule so that only when a length of one side of a current coding unit is equal to or less than M and equal to or greater than N, the current coding unit is splittable into a coding unit having a ratio of 1:2 or 2:1. M and N are positive integers.

Also, according to an embodiment of the present disclosure, the image decoding apparatus 100 may determine that quad splitting is used. The image decoding apparatus 100 may allow quad splitting for a coding unit having a long side whose length ranges from M to N. Here, M and N are positive integers. For example, the image decoding apparatus 100 may allow quad splitting for a coding unit having a long side whose length ranges from 128 to 8. The image decoding apparatus 100 and the image encoding apparatus 150 may use M and N that are pre-determined. However, the present disclosure is not limited thereto. The image decoding apparatus 100 may determine M and N based on information obtained from a bitstream.

Also, according to an embodiment of the present disclosure, the image decoding apparatus 100 may determine that binary splitting is to be used. The image decoding apparatus 100 may allow binary splitting for a coding unit having a long side whose length ranges from M to N. Here, M and N are positive integers. For example, referring to the cells 1920 and 1940, the image decoding apparatus 100 may allow binary splitting for a coding unit having a long side whose length ranges from 128 to 8. The image decoding apparatus 100 and the image encoding apparatus 150 may use M and N that are pre-determined. However, the present disclosure is not limited thereto. The image decoding apparatus 100 may determine M and N based on information obtained from a bitstream.

Also, according to an embodiment of the present disclosure, the image decoding apparatus 100 may determine that tri-splitting is to be used. The image decoding apparatus 100 may allow tri-splitting for a coding unit having a long side whose length ranges from M to N. Here, M and N are positive integers. For example, referring to the cell 1920 and the cell 1940, the image decoding apparatus 100 may allow tri-splitting for a coding unit having a long side whose length ranges from 64 to 16. The image decoding apparatus 100 and the image encoding apparatus 150 may use M and N that are pre-determined. However, the present disclosure is not limited thereto. The image decoding apparatus 100 may determine M and N based on information obtained from a bitstream.

Also, according to an embodiment of the present disclosure, the image decoding apparatus 100 may determine that a square coding unit is to be used. The image decoding apparatus 100 may allow a square coding unit having a long side whose length ranges from M to N. Here, M and N are positive integers. For example, the image decoding apparatus 100 may allow a square coding unit having a long side whose length ranges from 128 to 4. The image decoding apparatus 100 and the image encoding apparatus 150 may use M and N that are pre-determined. However, the present disclosure is not limited thereto. The image decoding apparatus 100 may determine M and N based on information obtained from a bitstream.

Also, according to an embodiment of the present disclosure, the image decoding apparatus 100 may determine that a coding unit having a width-to-height ratio of 1:2 or 2:1 is to be used. The image decoding apparatus 100 may allow a coding unit having a long side whose length ranges from M to N and having a ratio of 1:2 or 2:1. Here, M and N are positive integers. For example, referring to the cell 1910 and the cell 1930, the image decoding apparatus 100 may allow a coding unit having a long side whose length ranges from 128 to 8 and having a ratio of 1:2 or 2:1. That is, allowable sizes of coding units may be 128×64, 64×128, 64×32, 32×64, 32×16, 16×32, 16×8, 8×16, 8×4, and 4×8. The image decoding apparatus 100 and the image encoding apparatus 150 may use M and N that are pre-determined. However, the present disclosure is not limited thereto. The image decoding apparatus 100 may determine M and N based on information obtained from a bitstream.

Also, according to an embodiment of the present disclosure, the image decoding apparatus 100 may determine that a coding unit having a width-to-height ratio of 1:4 or 4:1 is to be used. The image decoding apparatus 100 may allow a coding unit having a long side whose length ranges from M to N and having a ratio of 1:4 or 4:1. Here, M and N are positive integers. For example, referring to the cell 1910 and the cell 1930, the image decoding apparatus 100 may allow a coding unit having a long side whose length ranges from 64 to 16 and having a ratio of 1:4 or 4:1. That is, allowable sizes of coding units may be 64×16, 16×64, 32×8, 8×32, 16×4, and 4×16. The image decoding apparatus 100 and the image encoding apparatus 150 may use M and N that are pre-determined. However, the present disclosure is not limited thereto. The image decoding apparatus 100 may determine M and N based on information obtained from a bitstream.

Also, according to an embodiment of the present disclosure, the image decoding apparatus 100 may determine that a coding unit having a width-to-height ratio of 1:8, 8:1, 1:16, or 16:1 is to be used. The image decoding apparatus 100 may allow a coding unit having a long side whose length ranges from M to N and having a ratio of 1:8, 8:1, 1:16, or 16:1.

The image decoding apparatus 100 may define a complexity level of an image. The complexity level of the image may be the amount of bit resources needed to display the image. That is, when the complexity level of the image is high, it may mean that the amount of bit resources needed to display the image is large. Also, when the complexity level is low, it may mean that the amount of bit resources needed to display the image is small.

The image decoding apparatus 100 may adaptively determine a splitting rule based on the complexity level of the image. That is, the splitting rule may be determined according to the complexity level of the image. The image decoding apparatus 100 may determine an allowable split shape mode based on the complexity level of the image. The image decoding apparatus 100 may divide the complexity level of the image into N complexity levels. The image decoding apparatus 100 may independently allocate an allowable split shape mode to each of the N complexity levels of the image. The allocated allowable split shape modes may be the same or different from one another. The image decoding apparatus 100 may receive information about the complexity level of the image from a bitstream. The image decoding apparatus 100 may determine the allowable split shape mode based on the received complexity level of the image.

For example, when the information received from the bitstream indicates a first complexity level, the image decoding apparatus 100 may allow quad splitting. When the information received from the bitstream indicates a second complexity level, the image decoding apparatus 100 may allow quad splitting and binary splitting. When the information received from the bitstream indicates a third complexity level, the image decoding apparatus 100 may allow quad splitting, binary splitting, and tri-splitting. The image decoding apparatus 100 and the image encoding apparatus 150 may pre-determine the allowable split shape mode according to the complexity level of the image. However, the present disclosure is not limited thereto, and the image decoding apparatus 100 may obtain the allowable split shape mode according to the complexity level of the image from the bitstream.

The image decoding apparatus 100 may determine allowable block shape information based on the complexity level of the image. The image decoding apparatus 100 may divide the complexity level of the image into N complexity levels. The image decoding apparatus 100 may allocate the allowable block shape information to each of the N complexity levels of the image. The image decoding apparatus 100 may receive information about the complexity level of the image from a bitstream. The image decoding apparatus 100 may determine the allowable block shape information based on the received complexity level of the image.

For example, when the information received from the bitstream indicates a first complexity level, the image decoding apparatus 100 may allow a square coding unit. When the information received from the bitstream indicates a second complexity level, the image decoding apparatus 100 may allow a coding unit having a width-to-height ratio of 1:1, 1:2, or 2:1. When the information received from the bitstream indicates a third complexity level, the image decoding apparatus 100 may allow a coding unit having a width-to-height ratio of 1:1, 1:2, 2:1, 1:4, or 4:1. The image decoding apparatus 100 and the image encoding apparatus 150 may pre-determine the allowable block shape information according to the complexity level of the image. However, the present disclosure is not limited thereto, and the image decoding apparatus 100 may obtain the allowable block shape information according to the complexity level of the image from the bitstream.

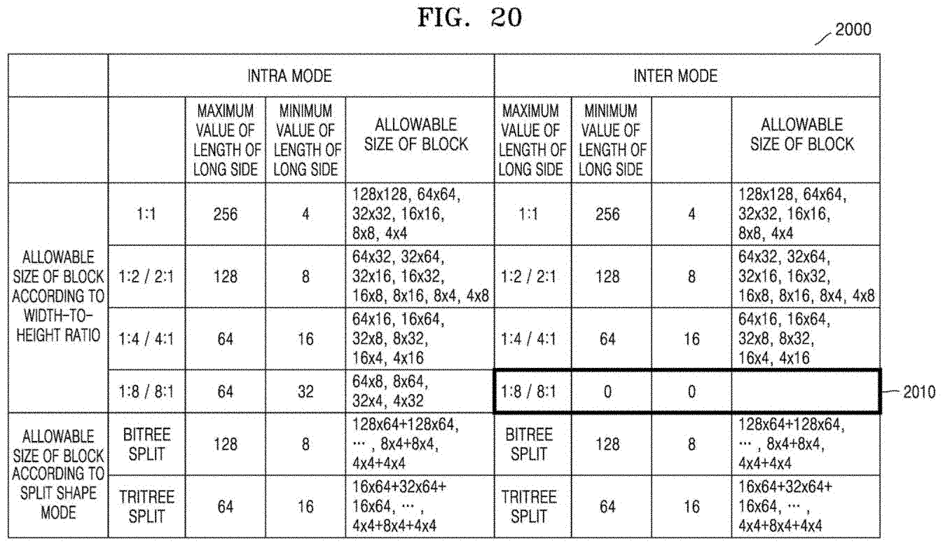

FIG. 20 is a diagram for describing a method of determining a splitting rule according to an embodiment of the present disclosure.

The image decoding apparatus 100 may determine a splitting rule based on a prediction mode. The prediction mode may include an intra mode and an inter mode. The image decoding apparatus 100 and the image encoding apparatus 150 may use the splitting rule according to the prediction mode that is pre-determined. However, the present disclosure is not limited thereto. The image decoding apparatus 100 may obtain the splitting rule according to the prediction mode from a bitstream.

Referring to a table 2000, the image decoding apparatus 100 may not allow a coding unit having a width-to-height ratio of 1:8 or 8:1 in an inter mode. Referring to a cell 2010, when a width-to-height ratio is 1:8 or 8:1, the image decoding apparatus 100 may set a maximum length and a minimum length of an allowable long side of a coding unit may be set to 0. That is, the image decoding apparatus 100 may not allow a coding unit having a width-to-height ratio of 1:8 or 8:1.

Although not shown in the table 2000, even in an intra mode, the image decoding apparatus 100 may not allow a coding unit having a width-to-height ratio of 1:8 or 8:1.

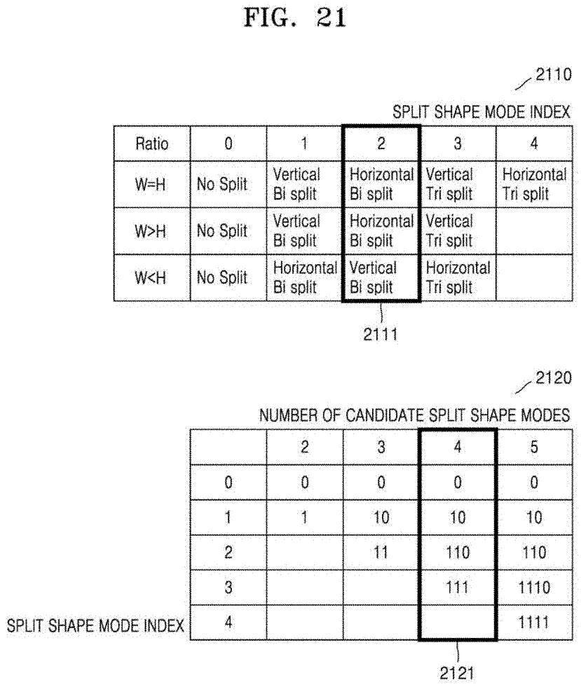

FIG. 21 is a table for describing a method of transmitting/receiving information about a split shape mode of a coding unit according to an embodiment of the present disclosure.

The image decoding apparatus 100 may receive a bitstream from the image encoding apparatus 150. The image decoding apparatus 100 may obtain a bin string corresponding to a split shape mode from the bitstream. The image decoding apparatus 100 may obtain the split shape mode based on the bin string. The image decoding apparatus 100 may split a current coding unit based on the split shape mode.

The image decoding apparatus 100 may obtain candidate split shape modes applicable to the current coding unit based on a splitting rule. The image decoding apparatus 100 may obtain the candidate split shape modes applicable to the current coding unit, with reference to the table 1900 of FIG. 19 or the table 2000 of FIG. 20.

For example, the current coding unit may have a size of 64×32. Referring to FIG. 19, because a length of a long side of the current coding unit is 64, the image decoding apparatus 100 may use binary splitting and tri-splitting. The image decoding apparatus 100 may determine a case where the current coding unit is not split as a first candidate split shape mode. The image decoding apparatus 100 may determine a case where the current coding unit is horizontally binary split as a second candidate split shape mode. The image decoding apparatus 100 may determine a case where the current coding unit is vertically binary split as a third candidate split shape mode. Also, the image decoding apparatus 100 may determine a case where the current coding unit is vertically tri-split as a fourth candidate split shape mode. Also, the image decoding apparatus 100 may determine a case where the current coding unit is horizontally tri-split as a fifth candidate split shape mode.

The image decoding apparatus 100 may exclude a split shape mode that is not allowable in the splitting rule from the candidate split shape modes. According to an embodiment of the present disclosure, the splitting rule may be determined so that only a long side of a coding unit is tri-split. Accordingly, the fifth candidate split shape mode in which a coding unit having a size of 64×32 is horizontally tri-split may be excluded from the candidate split shape modes.

Also, when a coding unit is split according to a split shape mode and a coding unit having a block shape that is not allowable in the splitting rule is derived, the image decoding apparatus 100 may exclude the split shape mode from the candidate split shape modes. For example, the current coding unit may have a size of 64×16. When the current coding unit is horizontally tri-split, coding units split from the current coding unit may have sizes of 64×8 and 64×4. In this case, the size of 64×4 has a ratio of 16:1. Because the splitting rule according to the table 1900 of FIG. 19 does not allow 1:16 or 16:1, the image decoding apparatus 100 may exclude a mode in which horizontal tri-splitting is performed from the candidate split shape modes.

The image decoding apparatus 100 may obtain a split shape mode of the current coding unit based on at least one of the candidate split shape modes, a bin string corresponding to the split shape mode, and block shape information of the current coding unit. In more detail, the image decoding apparatus 100 may obtain a split shape mode index indicating the split shape mode of the current coding unit based on the number of candidate split shape modes and the bin string corresponding to the split shape mode. The image decoding apparatus 100 may obtain the split shape mode of the current coding unit based on the split shape mode index and the block shape information of the current coding unit.

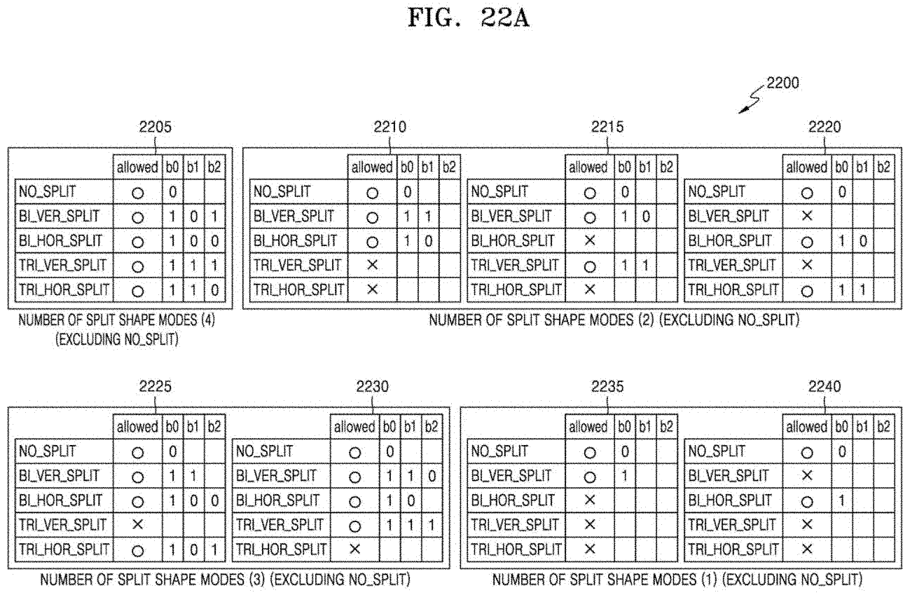

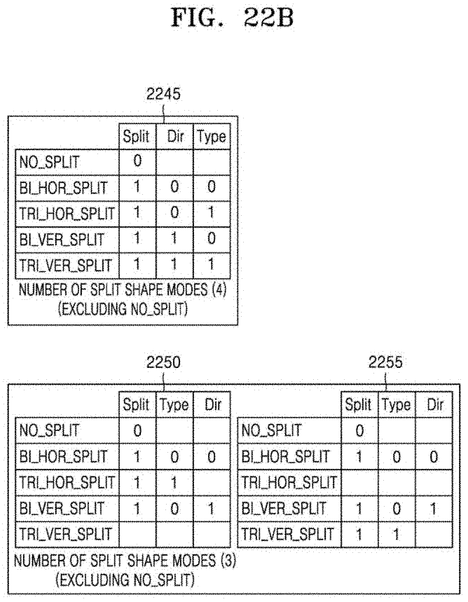

A process, performed by the image decoding apparatus 100, of obtaining the split shape mode index is as follows. The image decoding apparatus 100 may obtain the number of candidate split shape modes. Also, the image decoding apparatus 100 may obtain the bin string corresponding to the split shape mode from a bitstream. Also, the image decoding apparatus 100 may determine the split shape mode index of the current coding unit based on a table (or an arrangement). The table may include a value of the bin string (or the split shape mode itself) according to the split shape mode index and the number of candidate split shape modes. A process, performed by the image decoding apparatus 100, of determining the split shape mode index (or the split shape mode index itself) of the current coding unit based on the table will be described in detail with reference to FIGS. 22A and 22B.

For example, the image decoding apparatus 100 may obtain “110” as the bin string corresponding to the split shape mode from a bitstream. The image decoding apparatus 100 may obtain the split shape mode index from the bin string based on a table 2120. As described above, the image decoding apparatus 100 may determine that the current coding unit may have four candidate split shape modes, that is, the first candidate split shape mode through the fourth candidate split shape mode. Accordingly, the image decoding apparatus 100 may refer to a column 2121 in which the number of candidate split shape modes is ‘4’. The image decoding apparatus 100 may obtain the split shape mode index ‘2’ based on the bin string ‘110’.

The image decoding apparatus 100 may obtain the split shape mode based on at least one of the split shape mode index and the block shape information of the coding unit. The image decoding apparatus 100 may obtain the block shape information of the current coding unit. The image decoding apparatus 100 may obtain the split shape mode based on the obtained block shape information of the current coding unit. The image decoding apparatus 100 may obtain the split shape mode based on a table (or an arrangement). The table may include the split shape mode according to the split shape mode index and the block shape information of the coding unit.

For example, when the split shape mode index is ‘2’, the image decoding apparatus 100 may refer to a cell 2111 of a table 2110. The image decoding apparatus 100 may determine that the current coding unit has a size of 64×32. Because a width of the current coding unit is greater than a height, the image decoding apparatus 100 may refer to a row showing ‘w>h’. The image decoding apparatus 100 may obtain horizontal binary splitting as the split shape mode.

The image decoding apparatus 100 may split the current coding unit based on the split shape mode. For example, when the current coding unit has a size of 64×32 and the split shape mode is horizontal binary splitting, the current coding unit may be split into two coding unit each having a size of 64×16.

Referring to the table 2120, the image decoding apparatus 100 and the image encoding apparatus 150 may adaptively binarize the split shape mode based on the splitting rule, and may inverse-binarize the bin string for the split shape mode. The image decoding apparatus 100 and the image encoding apparatus 150 may determine the number of bins for the split shape mode based on the splitting rule. For example, when the number of candidate split shape modes is 5, the image decoding apparatus 100 and the image encoding apparatus 150 may binarize the split shape mode by using 4 bins, and may inverse-binarize the bin string for the split shape mode, to obtain the split shape mode. However, when the number of candidate split shape modes is 4, the image decoding apparatus 100 and the image encoding apparatus 150 may binarize the split shape mode by using 3 bins, and may inverse-binarize the bin string for the split shape mode, to obtain the split shape mode. The image decoding apparatus 100 and the image encoding apparatus 150 may binarize the split shape mode, excepting a split shape mode and a block shape that are not allowable according to the splitting rule, and may inverse-binarize the bin string for the split shape mode to obtain the split shape mode, thereby reducing the number of signaled bits and improving the efficiency of encoding/decoding.

FIGS. 22A and 22B are diagrams for describing a process, performed by the image decoding apparatus 100, of determining a split shape mode index of a current coding unit based on a table, according to various embodiments.

Referring to FIG. 22A, the image decoding apparatus 100 may pre-determine tables 2200 indicating a correspondence relationship between a bin string and an allowable split shape mode based on the number of various allowable split shape modes and types of the allowable split shape modes. The image decoding apparatus 100 may determine one of the pre-determined tables 2200 based on the number of allowable split shape modes and the type of the allowable split shape modes.

For example, when split shape modes excluding NO_SPLIT are 4 split shape modes (BI_VER SPLIT, BI_HOR_SPLIT, TRI_VER_SPLIT, TRI_HOR_SPLIT), the image decoding apparatus 100 may determine a table 2205 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 101, the image decoding apparatus 100 may determine that the split shape mode of the current block is BI_VER_SPLIT. In this manner, in the table 2205, the image decoding apparatus 100 may determine a split shape mode corresponding to the bin string for the split shape mode of the current block as the split shape mode of the current block. In the table 2205, b0 may be a bin indicating whether splitting is performed, b1 may be a bin indicating a split type, and b2 may be a bin indicating a split direction. However, the present disclosure is not limited thereto, and a second bin may indicate a split direction, and a third bin may indicate a split type.

For example, referring to FIG. 22B, when split shape modes excluding NO_SPLIT are 4 split shape modes (BI_VER SPLIT, BI_HOR_SPLIT, TRI_VER_SPLIT, and TRI_HOR_SPLIT), the image decoding apparatus 100 may determine a table 2245. When a bin string for a split shape mode of a current block obtained from a bitstream is 0, the image decoding apparatus 100 may determine that the block shape mode of the current block is NO_SPLIT.

When the bin string for the split shape mode of the current block obtained from the bitstream is 101, the image decoding apparatus 100 may determine that the split shape mode of the current block is TRI_HOR_SPLIT. In this manner, in the table 2205, the image decoding apparatus 100 may determine a split shape mode corresponding to the bin string for the split shape mode of the current block as the split shape mode of the current block.

Referring back to FIG. 22A, for example, split shape modes excluding NO_SPLIT are 2 split shape modes (BI_VER_SPLIT and BI_HOR_SPLIT), the image decoding apparatus 100 may determine a table 2210 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 11, the image decoding apparatus 100 may determine that the split shape mode of the current block is BI_VER_SPLIT. In this manner, in the table 2210, the image decoding apparatus 100 may determine a split shape mode corresponding to the bin string for the split shape mode of the current block as the split shape mode of the current block. In the table 2210, b0 may be a bin indicating whether splitting is performed, and b1 may be a bin indicating a split direction. That is, because split shapes of allowable split shape modes excluding NO_SPLIT are the same, a bin indicating the split shapes may not exist.

For example, when split shape modes excluding NO_SPLIT are 2 split shape modes (BI_VER_SPLIT and TRI_VER_SPLIT), the image decoding apparatus 100 may determine a table 2215 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 10, the image decoding apparatus 100 may determine that the split shape mode of the current block is BI_VER_SPLIT. In this manner, in the table 2215, the image decoding apparatus 100 may determine a split shape mode corresponding to the bin string for the split shape mode of the current block as the split shape mode of the current block. In the table 2215, b0 may be a bin indicating whether splitting is performed, and b1 may be a bin indicating a split shape. That is, because split directions of allowable split shape modes excluding NO_SPLIT are the same, a bin indicating the split directions may not exist.

For example, when split shape modes excluding NO_SPLIT are 2 split shape modes (BI_HOR_SPLIT and TRI_HOR_SPLIT), the image decoding apparatus 100 may determine a table 2220 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 10, the image decoding apparatus 100 may determine that the split shape mode of the current block is BI_HOR_SPLIT. In this manner, the image decoding apparatus 100 may determine a split shape mode corresponding to the bin string for the split shape mode of the current block as the split shape mode of the current block. In the table 2220, b0 may be a bin indicating whether splitting is performed, and b1 may be a bin indicating a split shape. That is, because split directions of allowable split shape modes excluding NO_SPLIT are the same, a bin indicating the split shape directions may not exist.

For example, when split shape modes excluding NO_SPLIT are 3 split shape modes (BI_VER_SPLIT, BI_HOR_SPLIT, and TRI_HOR_SPLIT), the image decoding apparatus 100 may determine a table 2225 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 11, the image decoding apparatus 100 may determine that the split shape mode of the current block is BI_VER_SPLIT. When BI_VER_SPLIT is allowable and TRI_VER_SPLIT is not allowable, if a bin b1 indicating a split direction indicates a vertical direction, the image decoding apparatus 100 may determine that the split shape mode of the current block is BI_VER_SPLIT even without a bin b2 indicating a split shape.

In this manner, in the table 2225, the image decoding apparatus 100 may determine a split shape mode corresponding to the bin string for the split shape mode of the current block as the split shape mode of the current block. In the table 2225, b0 may be a bin indicating whether splitting is performed, b1 may be a bin indicating a split direction, and b2 may be a bin indicating a split shape.

However, the present disclosure is not limited to the table 2225, and a second bin may be a bin indicating a split shape and a third bin may be a bin indicating a split direction. Because TRI_VER_SPLIT is allowable and TRI_HOR_SPLIT is not allowable, when a bin b1 indicating a split shape indicates tri-splitting, the image decoding apparatus 100 may determine that the split shape mode of the current block is TRI_VER_SPLIT even without a bin b2 indicating a split direction. That is, a bin string corresponding to an allowable split shape mode may vary according to a location of a bin indicating a split shape or a split direction. Accordingly, referring to FIG. 22B, it will be easily understood by one of ordinary skill in the art that when a location of a bin indicating a split shape or a bin direction is changed, the image decoding apparatus 100 may replace the table 2225 with a table 2250 and may determine a split shape mode index (or a split shape mode itself) of a current coding unit.

Referring back to FIG. 22A, for example, when split shape modes excluding NO_SPLIT are 3 split shape modes (BI_VER_SPLIT, BI_HOR_SPLIT, and TRI_VER_SPLIT), the image decoding apparatus 100 may determine a table 2230 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 10, the image decoding apparatus 100 may determine that the split shape mode of the current block is BI_HOR_SPLIT. When BI_HOR_SPLIT is allowable and TRI_HOR_SPLIT is not allowable, if a bin b1 indicating a split direction indicates a horizontal direction, the image decoding apparatus 100 may determine that the split shape mode of the current block is BI_HOR_SPLIT even without a bin b2 indicating a split shape.

In this manner, in the table 2230, the image decoding apparatus 100 may determine a split shape mode corresponding to the bin string for the split shape mode of the current block as the split shape mode of the current block. In the table 2230, b0 may be a bin indicating whether splitting is performed, b1 may be a bin indicating a split direction, and b2 may be a bin indicating a split shape.

However, the present disclosure is not limited to the table 2230, and a second bin may be a bin indicating a split shape and a third bin may be a bin indicating a split direction.

In this case, because TRI_VER_SPLIT is allowable and TRI_HOR_SPLIT is not allowable, when a bin b1 indicating a split shape indicates tri-splitting, the image decoding apparatus 100 may determine that the split shape mode of the current block is TRI_VER_SPLIT even without a bin b2 indicating a split direction. That is, a bin string corresponding to an allowable split shape mode may vary according to a location of a bin indicating a split shape or a split direction. Accordingly, referring to FIG. 22B, it will be easily understood by one of ordinary skill the art that when a location of a bin indicating a split shape or a split direction is changed, the image decoding apparatus 100 may replace the table 2230 with a table 2255 and may determine a split shape mode index (or a split shape mode itself) of a current coding unit.

Referring back to FIG. 22A, for example, when split shape modes excluding NO_SPLIT are 1 split shape mode (BI_VER_SPLIT), the image decoding apparatus 100 may determine a table 2235 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 1, the image decoding apparatus 100 may determine that the split shape mode of the current block is BI_VER_SPLIT. That is, the image decoding apparatus 100 may determine one of allowable split shape modes even by using only a bin b0 indicating a split direction. That is, because a split shape mode in which a current coding unit is split is only one even when bins b1 and b2 indicating a split shape or a split direction do not exist, when a bin indicating whether splitting is performed indicates that the current coding unit is split, a split shape or a split direction may be specified, and thus the image decoding apparatus 100 may obtain the split shape mode.

For example, when split shape modes excluding NO_SPLIT are 1 split shape mode (BI_HOR_SPLIT), the image decoding apparatus 100 may determine a table 2240 from among the tables 2200. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is 1, the image decoding apparatus 100 may determine that the split shape mode of the current block is BI_HOR_SPLIT. As described above, the image decoding apparatus 100 may determine one of allowable split shape modes even by using only a bin b0 indicating a split direction. That is, because a split shape mode in which a current coding unit is split is only one even when bins b1 and b2 indicating a split shape or a split direction do not exist, when a bin indicating whether splitting is performed indicates that the current coding unit is split, a split shape or a split direction may be specified, and thus the image decoding apparatus 100 may obtain the split shape mode.

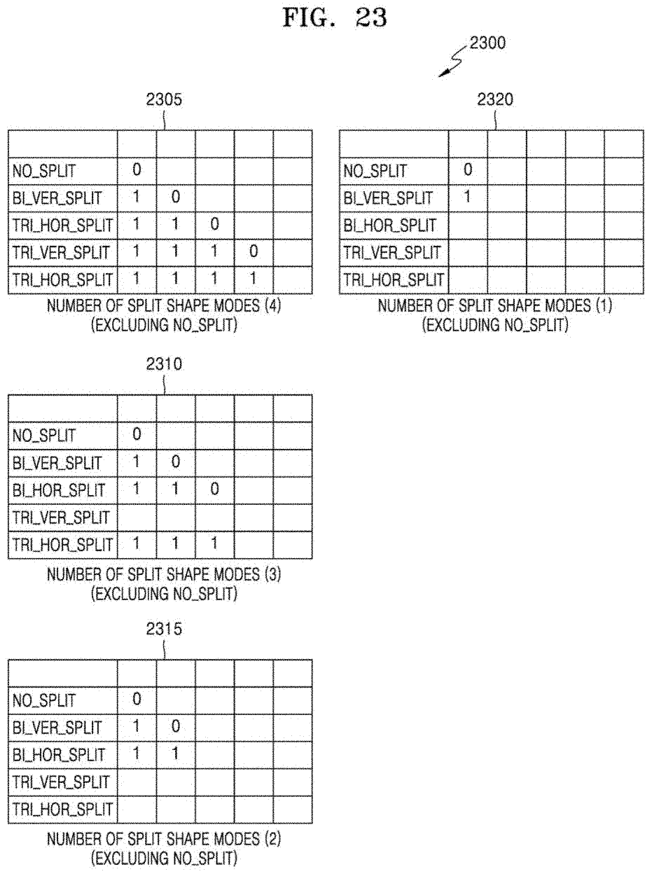

FIG. 23 is a diagram for describing a process, performed by the image decoding apparatus 100, of determining a split shape mode index of a current coding unit based on a table, according to an embodiment.

Referring to FIG. 23, the image decoding apparatus 100 may pre-determine tables 2300 indicating a correspondence relationship between an allowable split shape mode and a bin string based on the number of various allowable split shape modes and types of the allowable split shape modes. In this case, a correspondence relationship between a bin string and an index value of an allowable split shape mode based on a priority of types of allowable split shape modes may be determined based on a unary binarization method.

The image decoding apparatus 100 may determine one of the pre-determined tables 2300 based on the number of allowable split shape modes and types of the allowable split shape modes.

For example, when split shape modes excluding NO_SPLIT are 4 split shape modes (BI_VER SPLIT, BI_HOR_SPLIT, TRI_VER_SPLIT, and TRI_HOR_SPLIT), the image decoding apparatus 100 may determine a table 2305 from among the tables 2300. When a bin string for a split shape mode of a current block obtained from a bitstream is 0, the image decoding apparatus 100 may determine that the split shape mode of the current block is NO_SPLIT.

When the bin string of the split shape mode of the current block obtained from the bitstream is “1111”, the image decoding apparatus 100 may determine that TRI_HOR_SPLIT located at a fifth position from among allowable split shape modes is the block shape mode of the current block.

For example, when split shape modes excluding NO_SPLIT are 3 split shape modes (BI_VER SPLIT, BI_HOR_SPLIT, and TRI_HOR_SPLIT), the image decoding apparatus 100 may determine a table 2310 from among the tables 2300. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is “111”, the image decoding apparatus 100 may determine that TRI_HOR_SPLIT located at a fourth position from among allowable split shape modes is the split shape mode of the current block.

For example, when split shape modes including NO_SPLIT are 2 split shape modes (BI_VER_SPLIT and BI_HOR_SPLIT), the image decoding apparatus 100 may determine a table 2315 from among the tables 2300. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is “11”, the image decoding apparatus 100 may determine that BI_HOR_SPLIT located at a third position from among allowable split shape modes is the split shape mode of the current block.

For example, when split shape modes excluding NO_SPLIT is 1 split shape mode (BI_VER_SPLIT), the image decoding apparatus 100 may determine a table 2320 from among the tables 2300. When a bin string for a split shape mode of a current block obtained from a bitstream is 0, the image decoding apparatus 100 may determine that the split shape mode of the current block is NO_SPLIT.

When the bin string for the split shape mode of the current block obtained from the bitstream is “1”, the image decoding apparatus 100 may determine that SPLIT_BI_VER located at a second position from among allowable split shape modes is the split shape mode of the current block.

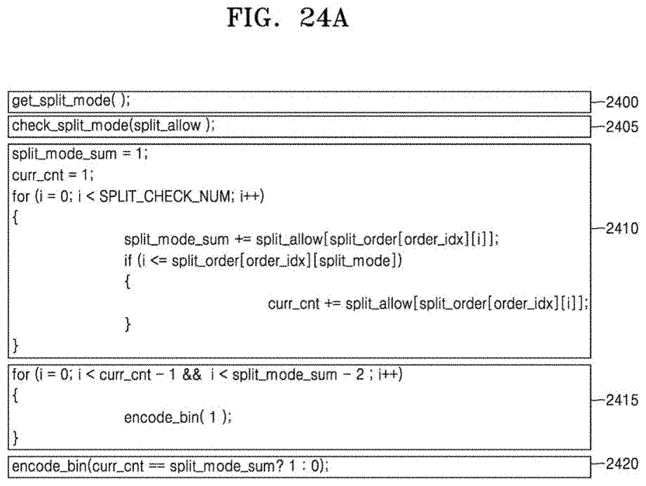

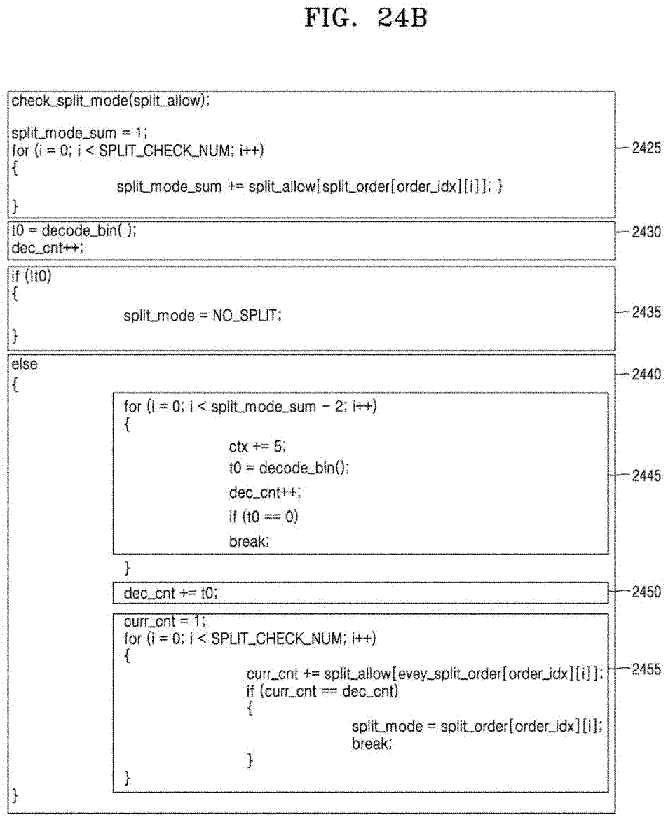

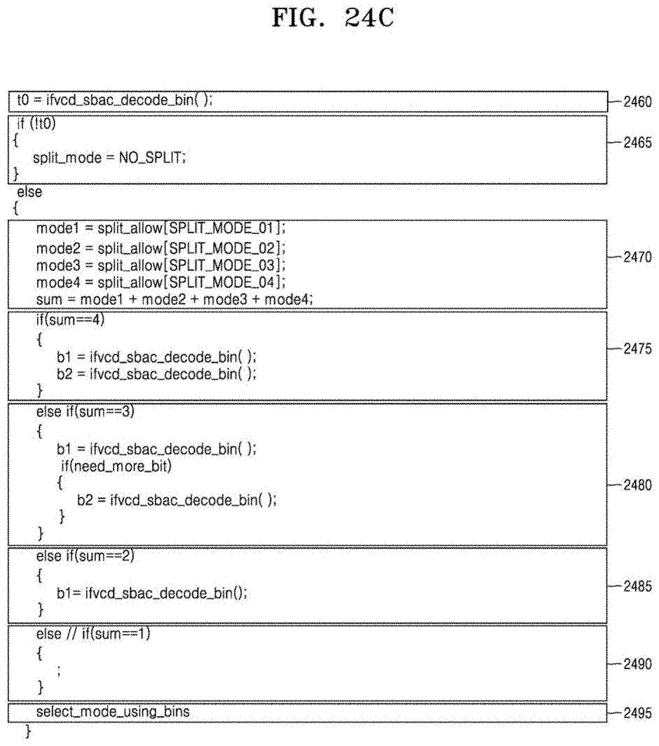

FIG. 24A is a diagram illustrating a pseudocode for performing a binarization method according to an allowable split shape mode according to an embodiment.

Referring to FIG. 24A, according to a first portion 2400, the image encoding apparatus 150 may check a split shape mode of a current block (get_split_mode( ).

According to a second portion 2405, the image encoding apparatus 150 may check allowable split shape modes from among all split shape modes (check_split_mode(split_allow)).

According to a third portion 2410, the image encoding apparatus 150 may check an order number (curr_cnt) the checked split shape mode of the current block from among all split shape modes (split_mode_sum) allowable in the current block.

According to a fourth portion 2415, the image encoding apparatus 150 may encode bins containing 1s, the number of which corresponds to a value obtained by subtracting 1 from the order number of the split shape mode of the current block.

According to a fifth portion 2420, when the split shape mode of the current block is a last mode (curre_cnt==split_mode_sum) from among all allowable split shape modes, the image encoding apparatus 150 may encode bins containing 1s the number of which corresponds to a value obtained by subtracting 2 from a last order number of all allowable split shape modes in the fourth portion 2415, and may lastly encode a bin containing 1.

According to the fifth portion 2420, when the split shape mode of the current block is not a last mode from among all allowable split shape modes, the image encoding apparatus 150 may encode bins containing 1s the number of which corresponds to a value obtained by subtracting 1 from the order number of the split shape mode of the current block in the fourth portion 2415, and may lastly encode a bin containing 0.

For example, when split shape modes allowable for a current block are 5 split shape modes that are NO_SPLIT, BI_HOR_SPLIT, BI_VER_SPLIT, TRI_HOR_SPLIT, and TRI_VER_SPLIT, a split shape mode of the current block is BI_VER_SPLIT, and an order of the split shape modes allowable for the current block is NO_SPLIT->BI_HOR_SPLIT->BI_VER SPLIT->TRI_HOR_SPLIT->TRI_VER_SPLIT, because BI_VER_SPLIT is a third split shape mode from among the 5 allowable split shape modes, the image encoding apparatus 150 may encode a bin string “110” for the split shape mode of the current block.

For example, when split shape modes allowable for a current block are 3 split shape modes that are NO_SPLIT, BI_HOR_SPLIT, and BI_VER_SPLIT, a split shape mode of the current block is BI_VER_SPLIT, and an order of the split shape modes allowable for the current block is NO_SPLIT->BI_HOR_SPLIT->BI_VER_SPLIT, because BI_VER_SPLIT is a third split shape mode from among the 3 allowable split shape modes, the image encoding apparatus 150 may encode a bin string “11” for the split shape mode of the current block.

FIG. 24B is a diagram illustrating a pseudocode for performing an inverse-binarization method according to an allowable split shape mode according to an embodiment.

Referring to FIG. 24B, according to a first portion 2425, the image decoding apparatus 100 may check the number (split_mode_sum) of split shape modes allowable for a current block.

According to a second portion 2430, the image decoding apparatus 100 checks a first bin t0 generated through binary arithmetic decoding, and increases a decoded bin count (dec_cnt++).

According to a third portion 2435, when the first bin t0 is 0, the image decoding apparatus 100 may determine that a split shape mode of the current block is NO_SPLIT.

According to a fourth portion 2440, when the first bin t0 is 1, the image decoding apparatus 100 may check a value of bins generated by arithmetic decoding the bins the number of which corresponds to a value obtained by subtracting 2 from the allowable split shape modes.

According to a fourth portion 2440 and a fifth portion 2445, the image decoding apparatus 100 may binary arithmetic decode one bin, may increase a decoded bin count, and, when the bin t0 is 0, may no longer binary arithmetic decode the bin.

According to the fourth portion 2440 through a sixth portion 2450, when a last checked bit is 1, the image decoding apparatus 100 may increase a decoded bin count by 1.

According to the fourth portion 2440 through a seventh portion 2455, the image decoding apparatus 100 may determine the split shape mode of the current block according to a priority of the allowable split shape modes based on a decoded bin count.

For example, when split shape modes allowable for a current block are 5 split shape modes (NO_SPLIT, BI_HOR_SPLIT, BI_VER_SPLIT, TRI_HOR_SPLIT, and TRI_VER_SPLIT) and an order of split modes allowable for the current block is NO_SPLIT->BI_HOR_SPLIT->BI_VER_SPLIT,

if a bin string input to the image decoding apparatus 100 is “110”, the image decoding apparatus 100 may increase a count of a first bin by 1, may increase a count of a second bin by 1, and may increase a count of a last bin by 1; because the last bin is 0, the image decoding apparatus may end checking; and because the last bin is 0, the image decoding apparatus 100 may no longer increase a count and may determine that BI_VER_SPLIT that is a third mode from among the allowable split shape modes is a split shape mode of the current block based on a count value of 3.

For example, when split shape modes allowable for a current block are 3 split shape modes (NO_SPLIT, BI_HOR_SPLIT, and BI_VER_SPLIT) and an order of split modes allowable for the current block is NO_SPLIT->BI_HOR_SPLIT->BI_VER_SPLIT,

if a bin string input to the image decoding apparatus 100 is “11”,

The image decoding apparatus 100 may increase a count of a first bin by 1 and may increase a count of a second bin by 1; because checking is performed in the fifth portion 2445 on bins containing 1s the number of which corresponds to a value obtained by subtracting 2 from the allowable split shape modes, the image decoding apparatus 100 may end the checking; and because a last bin is 1, the image decoding apparatus 100 may increase a count by 1 in the sixth portion 2450 and may determine that BI_VER_SPLIT that is a third mode from among the allowable split shape modes as a split shape mode of the current block based on a count value of 3.

FIG. 24C is a diagram illustrating a pseudocode for performing an inverse-binarization method according to an allowable split shape mode according to another embodiment.

Referring to FIG. 24C, according to a first portion 2460, the image decoding apparatus 100 checks a first bin t0 generated by binary arithmetic decoding a bin.

According to a second portion 2465, when a value of the first bin is 0, the image decoding apparatus 100 may determine that a split shape mode (split_mode) of a current block is NO_SPLIT.

According to a third portion 2470, the image decoding apparatus 100 may check whether split shape modes excluding NO_SPLIT are allowable and may check the number (sum) of split shape modes allowable for the current block.

According to a fourth portion 2475, when modes allowable for the current block excluding NO_SPLIT are 4 modes, the image decoding apparatus 100 may check a second bin b1 and a third bin b3 generated through binary arithmetic decoding. In this case, the second bin may be a bin indicating a split direction, and the third bin may indicate a split shape. However, the present disclosure is not limited thereto, and the second bin may be a bin indicating a split shape, and the third bin may be a bin indicating a split direction.

According to a fifth portion 2480, when the modes allowable for the current block excluding NO_SPLIT are 3 modes, the image decoding apparatus 100 may obtain b1 by binary arithmetic decoding a second bit and may check a value of b1. When a split shape mode of a current block may not be defined only by using the second bin, the image decoding apparatus 100 may obtain b2 by additionally binary arithmetic decoding a third bit and may check a value of b2. The second bin may be a bin indicating a split direction, and the third bin may indicate a split shape. However, the present disclosure is not limited thereto, and the second bin may be a bin indicating a split shape and the third bin may be a bin indicating a split direction.

For example, when a second bin (split_dir) is a bin indicating a split direction, the image decoding apparatus 100 may check a third bin (split_typ) generated through binary arithmetic decoding when necessary. The third bin may indicate a split shape.

When split shape modes having the same direction and different shapes are not allowable, the image decoding apparatus 100 may no longer decode a bin and may determine an allowable shape (split_typ).

For example, when SPLIT_BI_HOR or SPLIT_TRI_HOR is not allowable, if the second bin (split_dir) is 1 (i.e., indicates a vertical direction), the image decoding apparatus 100 may check the third bin (split_typ) generated through binary arithmetic decoding.

If the bin (split_dir) is 1 (i.e., indicates a horizontal direction), because one of SPLIT_BI_HOR and SPLIT_TRI_HOR that is a split shape mode indicating the same horizontal direction is not allowable, an allowable split shape may be determined according to what is an unallowable split shape mode.

Likewise, when SPLIT_BI_VER or SPLIT_TRI_VER is not allowable, if the bin (split_dir) is 0 (i.e., indicates a horizontal direction), the third bin (split_typ) generated through binary arithmetic decoding be checked.

If the bin (split_dir) is 1 (i.e., indicates a vertical direction), because one of SPLIT_BI_VER and SPLIT_TRI_VER that is a split shape mode indicating the same vertical direction is not allowable, an allowable split shape may be determined according to what is an unallowable split shape mode.

According to a sixth portion 2485, when modes allowable for a current block excluding NO_SPLIT are 2 modes, the image decoding apparatus 100 may obtain a bin b1 by performing binary arithmetic decoding and may check a value of the bin b1. The bin b1 may be a bin indicating a split direction or a split shape.

For example, when both SPLIT_BI_HOR and SPLIT_TRI_HOR are allowable split shape modes, or both SPLIT_BI_VER and SPLIT_TRI_VER are allowable split shape modes,

because two allowable modes are distinguishable by using split shapes, an allowable split direction may be determined according to what is an unallowable split shape mode.

The image decoding apparatus 100 may check a second bin (split_type) generated through binary arithmetic decoding.

When modes allowable for a current block excluding NO_SPLIT are 2 modes, if SPLIT_BI_HOR or SPLIT_TRI_HOR is an unallowable split shape mode and SPLIT_BI_VER or SPLIT_TRI_VER is an unallowable split shape mode, the image decoding apparatus 100 may check a second bin (split_dir) generated through binary arithmetic decoding.

If both SPLIT_TRI_HOR and SPLIT_TRI_VER are unallowable split shape modes, only SPLIT_BI_HOR and SPLIT_BI_VER may remain and split_type may be 0 (i.e., a split shape indicates binary splitting).

If both SPLIT_BI_HOR and SPLIT_TRI_VER are allowable split shape modes, split_type may be determined according to a split direction.

If both SPLIT_BI_VER and SPLIT_TRI_HOR are allowable split shape modes, split_type may be determined according to a split direction.

According to a seventh portion 2490, when modes allowable for a current block excluding NO_SPLIT are 1 mode, the image decoding apparatus 100 may determine a split shape mode of the current block without additionally obtaining a bin.

For example, when one of SPLIT_BI_VER and SPLIT_TRI_VER is allowable, a split direction (split_dir) may be determined to be 1 (i.e., indicates a vertical direction), and otherwise, the split direction (split_dir) may be determined to be 0 (i.e., indicates a horizontal direction.

When one of SPLIT_TRI_HOR and SPLIT_TRI_VER is allowable, a split type (split_typ) may be determined to be 1 (i.e., indicates tri-splitting), and otherwise, the split type (split_typ) may be determined to be 0 (i.e., indicates binary splitting).

According to an eighth portion 2495, the image decoding apparatus 100 may determine a split direction and a split shape based on the obtained one or more bins b0, b1, and b2, and may determine a split shape mode of the current block based on the determined split direction and split shape.

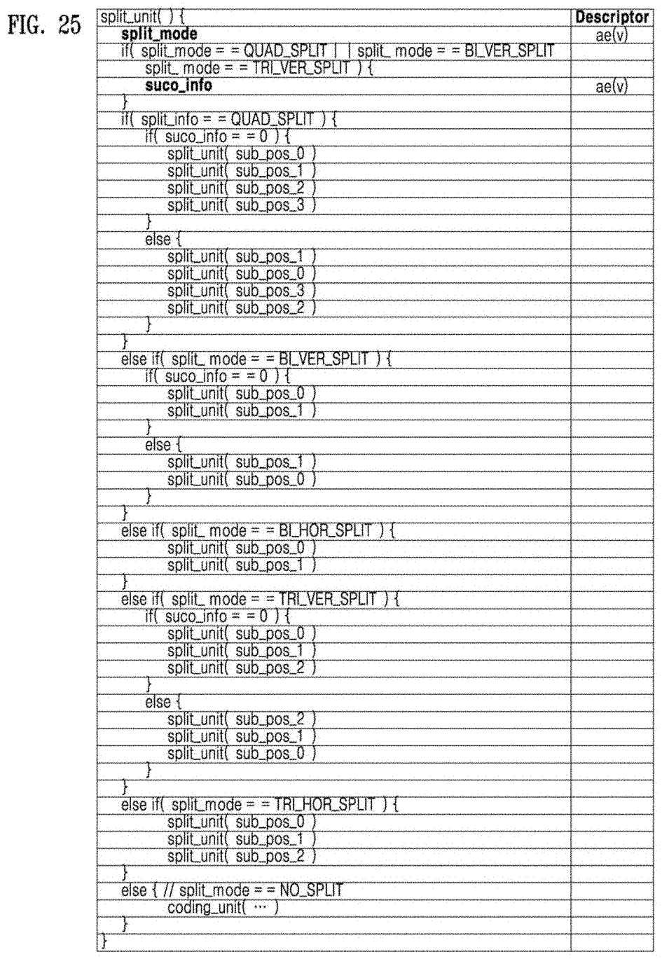

FIG. 25 is a diagram for describing a method of indicating splitting of a current coding unit.

split_unit( ) may denote a syntax for splitting a current coding unit. Information about a split shape mode (split_mode) may include at least one of information indicating whether splitting is performed, split direction information, and split type information. The information indicating whether splitting is performed indicates whether the current coding unit is to be split. The split direction information indicates that splitting is performed in one of a horizontal direction and a vertical direction.

The split type information indicates that splitting is performed in one of binary splitting, tri-splitting, and quad splitting. The binary splitting means that one of a height and a width of a coding unit is split to ½. The tri-splitting means that one of a height and a width of a coding unit is split to be 1:2:1. Also, the quad splitting means that a height and a width of a coding unit are split to ½.

Although it is described that the information about the split shape mode (split_mode) includes the information indicating whether splitting is performed, the split direction information, and the split type information for convenience of explanation, the present disclosure is not limited thereto. The information about the split shape mode may be expressed by combining the information indicating whether splitting is performed, the split direction information, and the split type information. For example, the information about the split shape mode (split_mode) may indicate that a current coding unit is not split (NO_SPLIT). Also, the information about the split shape mode (split_mode) may indicate quad splitting (QUAD_SPLIT). Also, the information about the split shape mode (split_mode) may indicate binary vertical splitting (BI_VER_SPLIT). Also, the information about the split shape mode (split_mode) may indicate binary vertical splitting (BI_VER_SPLIT). Also, the information about the split shape mode (split_mode) may indicate binary horizontal splitting (BI_HOR_SPLIT). Also, the information about the split shape mode (split_mode) may indicate tri-vertical splitting (TRI_VER_SPLIT). Also, the information about the split shape mode (split_mode) may indicate tri-horizontal splitting (TRI_HOR_SPLIT).

The image decoding apparatus 100 may obtain a split shape mode based on a bin string. The image decoding apparatus 100 may determine whether a coding unit is split, a split direction, and a split type, based on the bin string.

The bin string represents a syntax element by using only a bin containing ‘0’ or ‘1’. The bin string may include one or more bits. The image decoding apparatus 100 may determine the number of bits of the bin string based on the number of allowable split shape modes from a current coding unit. For example, the image decoding apparatus 100 may determine a mode in which the current coding unit is split according a specific split direction and a split shape, and a mode in which the current coding unit is not split. That is, the number of allowable split shape modes from the current coding unit may be 2. The image decoding apparatus 100 may determine information about a split shape mode of a coding unit based on a bin string for a split shape mode including one bit. The one bit may indicate whether splitting is performed. The bit may indicate that splitting is not performed (NO_SPLIT). When the bit indicates that splitting is performed, the image decoding apparatus 100 may determine a split direction or a split type based on an allowable split shape mode of the current coding unit.

Also, when the number of allowable split shape modes from the current coding unit is 3, the image decoding apparatus 100 may obtain a split shape mode of a coding unit based on a bin string including 2 bits. A first bit of the bin string may indicate whether splitting is performed. A second bit of the bin string may indicate a split type or a split direction. The image decoding apparatus 100 may determine a split direction or a split type based on an allowable split shape mode of the current coding unit.

Also, when the number of allowable split shape modes from the current coding unit is 4 or 5, the image decoding apparatus 100 may split a coding unit based on a bin string including 3 bits. A first bit of the bin string may indicate whether splitting is performed. A second bit of the bin string may indicate a split type or a split direction. A third bit of the bin string may indicate a split direction or a split type. The image decoding apparatus 100 may determine a split direction or a split type based on an allowable split shape mode of the current coding unit.

The image decoding apparatus 100 may obtain information about a split shape mode from a bitstream, but the present disclosure is not limited thereto. The image decoding apparatus 100 may determine the information about the split shape mode based on a splitting rule that is pre-promised with the image encoding apparatus 150. The image decoding apparatus 100 may determine the information about the split shape mode that is pre-promised based on a size of the current coding unit. For example, the image decoding apparatus 100 may determine that information about a split shape mode for a coding unit having a maximum size is quad splitting (QUAD_SPLIT). Also, the image decoding apparatus 100 may determine that information about a split shape mode for a coding unit having a minimum size is not splitting (NO_SPLIT).

According to an adaptive inverse-binarization method of a split shape mode or an inverse-binarization method of a bin string for the split shape mode, when types of split shape modes for a current block are different, although the numbers of allowable split shape modes are the same, a split shape mode corresponding to a bin string may vary.

Various embodiments have been described. It will be understood by one of ordinary skill in the art that various changes in form and details may be made therein without departing from the spirit and scope of the present disclosure. The disclosed embodiments should be considered in descriptive sense only and not for purposes of limitation. Therefore, the scope of the invention is defined not by the detailed description of the invention but by the appended claims, and all differences within the scope will be construed as being included in the present invention.

Meanwhile, the embodiments of the present disclosure may be implemented as a computer-executable program, and may be executed by a general-purpose digital computer that operates the program using a computer-readable recording medium. Examples of the computer-readable recording medium may include magnetic storage media (e.g., read-only memories (ROMs), floppy disks, or hard disks) and optical reading media (e.g., compact disk read-only memories (CD-ROMs) or digital versatile disks (DVDs)).

1. An image decoding method comprising:
determining allowable split shape modes from among a plurality of split shape modes, based on at least one of a size and a shape of a current block and an allowable size of a block;
obtaining information about a split shape mode of the current block from a bitstream;
generating a bin string for the split shape mode of the current block comprising at least one bin by binary arithmetic decoding the information about the split shape mode of the current block;
obtaining the split shape mode of the current block by performing inverse-binarization on the bin string for the split shape mode of the current block, based on the allowable split shape modes; and
determining whether the current block is to be split, based on the obtained split shape mode of the current block,
wherein the information about the split shape mode comprises information about whether the block is split, a split direction of the block, and a split type of the block,
wherein the allowable size of the block is determined based on a minimum size and a maximum size of the block allowable for decoding.

2. The image decoding method of claim 1, wherein the information about the split type indicates at least one of binary splitting, tri-splitting, and quad splitting.

3. The image decoding method of claim 1, wherein the obtaining of the split shape mode of the current block by performing the inverse-binarization on the bin string for the split shape mode of the current block, based on the allowable split shape modes, comprises:
determining a bin string corresponding to the allowable split shape modes; and
obtaining the split shape mode of the current block by performing inverse-binarization on the bin string for the split shape mode of the current block, based on the bin string corresponding to the allowable split shape modes.

4. The image decoding method of claim 3, wherein the determining of the bin string corresponding to the allowable split shape modes comprises determining the bin string corresponding to the allowable split shape modes from one of tables indicating correspondence relationships between bin strings and allowable split shape modes.

5. The image decoding method of claim 3, wherein the determining of the bin string corresponding to the allowable split shape modes comprises determining the bin string corresponding to the allowable split shape modes, based on a predetermined binarization method,
wherein the predetermined binarization method is a unary binarization method,
wherein the bin string corresponding to the allowable split shape modes is determined according to a maximum number of the allowable split shape modes and a priority of the allowable split shape modes.

6. The image decoding method of claim 6, wherein the at least one bin included in the bin string comprises one of at least one bin indicating whether the block is split, at least one bin indicating the split direction of the block, and at least one bin indicating the split type of the block.

7. The image decoding method of claim 6, wherein, when at least one remaining second split shape mode that is different, in one of a split direction of a block and a split type of the block, from a first split shape mode from among the allowable split shape modes is not an allowable split shape mode, it is determined that a part of at least one bin for one of the split direction of the block and the split type of the block is not included in the bin string.

8. The image decoding method of claim 3, wherein the determining of the bin string corresponding to the allowable split shape modes comprises determining a bin string allocated to the allowable split shape modes, based on a maximum number of the allowable split shape modes and types of the allowable split shape modes.

9. The image decoding method of claim 1, further comprising:
when it is determined that the current block is split, splitting the current block into a plurality of blocks, based on the information about the split direction and the split type of the block;
determining an allowable first split shape mode from among the plurality of split shape modes, based on at least one of a size and a shape of one block from among the plurality of blocks and an allowable size of the block;
obtaining information about a split shape mode of the one block from among the plurality of blocks from the bitstream;
generating a bin string for the split shape mode of the one block from among the plurality of blocks comprising at least one bin by binary arithmetic decoding the information about the split shape mode of the one block from among the plurality of blocks;
obtaining the split shape mode of the one block from among the plurality of blocks by performing inverse-binarization on the bin string for the one block from among the plurality of blocks, based on the allowable first split shape mode; and
determining whether the one block from among the plurality of blocks is split, based on the obtained split shape mode of the one block from among the plurality of blocks.

10. The image decoding method of claim 1, wherein the determining of whether the current block is to be split, based on the obtained split shape mode of the current block comprises, when it is determined that the current block is not split, based on the obtained split shape mode of the current block, performing decoding based on the current block.

11. An image decoding apparatus comprising:
a binary arithmetic decoder configured to obtain information about a split shape mode of a current block from a bitstream, and generate a bin string for the split shape mode of the current block comprising at least one bin by binary arithmetic decoding the information about the split shape mode of the current block;
an inverse-binarizer configured to determine allowable split shape modes from among a plurality of split shape modes, based on at least one of a size and a shape of the current block and an allowable size of a block, generate the bin strong for the split shape mode of the current block comprising at least one bin by binary arithmetic decoding the information about the split shape mode of the current block, and obtain the split shape mode of the current block by performing inverse-binarization on the bin string for the split shape mode of the current block, based on the allowable split shape modes; and
a decoder configured to determine whether the current block is to be split, based on the obtained split shape mode of the current block,
wherein the information about the split shape mode comprises information about whether the block is split, a split direction of the block, and a split type of the block,
wherein the allowable size of the block is determined based on a minimum size and a maximum size of the block allowable for decoding.

12. An image encoding method comprising:
determining allowable split shape modes from among a plurality of split shape modes, based on at least one of a size and a shape of a current block and an allowable size of a block;
determining the split shape mode of the current block;
generating a bin string for the split shape mode of the current block by performing binarization on the split shape mode of the current block, based on the allowable split shape modes;
generating information about the split shape mode of the current block by binary arithmetic encoding the bin string for the split shape mode of the current block; and
generating a bitstream comprising the information about the split shape mode of the current block,
wherein the information about the split shape mode comprises information about whether the block is split, a split direction of the block, and a split type of the block,
wherein the allowable size of the block is determined based on a minimum size and a maximum size of the block allowable for encoding.

13. The image encoding method of claim 12, wherein the generating of the bin string for the split shape mode of the current block by performing binarization on the split shape mode of the current block, based on the allowable split shape modes, comprises:
determining a bin string corresponding to the allowable split shape modes according to a predetermined binarization method; and
generating the bin string for the information about the split shape mode of the current block based on the bin string corresponding to the allowable split shape modes,
wherein the binarization method is a unary binarization method,
wherein the bin string corresponding to the allowable split shape modes is determined according to a maximum number of the allowable split shape modes and a priority of the allowable split shape modes.

14. The image encoding method of claim 12, wherein at least one bin in the bin string is one of at least one bin indicating whether the block is split, at least one bin indicating the split direction of the block, and at least one bin indicating the split type of the block.

15. A computer-readable recording medium having recorded thereon a program for performing the image decoding method of claim 1.
